(19) United States
(12) Patent Application Publication
(10) Pub. No.: US 2024/0349364 A1
(43) Pub. Date: Oct. 17, 2024

(54) Channel Symmetry for Communication System

(71) Applicant: Ofinno, LLC, Reston, VA (US)

(72) Inventors: Weihua Qiao, Herndon, VA (US); Taehun Kim, Fairfax, VA (US); Esmael Hejazi Dinan, McLean, VA (US); Hua Zhou, Vienna, VA (US); Kyungmin Park, Vienna, VA (US); SungDuck Chun, Fairfax, VA (US); Peyman Talebi Fard, Vienna, VA (US)

(73) Assignee: Ofinno, LLC, Reston, VA (US)

(21) Appl. No.: 18/755,230

(22) Filed: Jun. 26, 2024

Related U.S. Application Data
(63) Continuation of application No. PCT/US2022/053934, filed on Dec. 23, 2022.
(60) Provisional application No. 63/323,621, filed on Mar. 25, 2022.
(60) Provisional application No. 63/294,684, filed on Dec. 29, 2021.

(51) Int. Cl. H04W 76/10; H04W 72/231; H04W 76/20

(52) U.S. Cl. CPC H04W 76/10; H04W 72/231; H04W 76/20

(57) ABSTRACT

A wireless device sends, to a network function, a message comprising a parameter indicating a request for symmetric communication channels for an application of the wireless device. The wireless device receives an acceptance of the request for the symmetric communication channels.

### CROSS-REFERENCE TO RELATED APPLICATIONS

This application is a continuation of International Application No. PCT/US2022/053934, filed Dec. 23, 2022, which claims the benefit of U.S. Provisional Application No. 63/323,621, filed Mar. 25, 2022, and U.S. Provisional Application No. 63/294,684, filed Dec. 29, 2021, all of which are hereby incorporated by reference in their entireties.

### BRIEF DESCRIPTION OF THE DRAWINGS

Examples of several of the various embodiments of the present disclosure are described herein with reference to the drawings.

FIG. 1A and FIG. 1B illustrate example communication networks including an access network and a core network.

FIG. 2A, FIG. 2B, FIG. 2C, and FIG. 2D illustrate various examples of a framework for a service-based architecture within a core network.

FIG. 3 illustrates an example communication network including core network functions.

FIG. 4A and FIG. 4B illustrate example of core network architecture with multiple user plane functions and untrusted access.

FIG. 5 illustrates an example of a core network architecture for a roaming scenario.

FIG. 6 illustrates an example of network slicing.

FIG. 7A, FIG. 7B, and FIG. 7C illustrate a user plane protocol stack, a control plane protocol stack, and services provided between protocol layers of the user plane protocol stack.

FIG. 8 illustrates an example of a quality of service model for data exchange.

FIG. 9A, FIG. 9B, FIG. 9C, and FIG. 9D illustrate example states and state transitions of a wireless device.

FIG. 10 illustrates an example of a registration procedure for a wireless device.

FIG. 11 illustrates an example of a service request procedure for a wireless device.

FIG. 12 illustrates an example of a protocol data unit session establishment procedure for a wireless device.

FIG. 13 illustrates examples of components of the elements in a communications network.

FIG. 14A, FIG. 14B, FIG. 14C, and FIG. 14D illustrate various examples of physical core network deployments, each having one or more network functions or portions thereof.

FIG. 15 illustrates an example of RRC connection establishment procedure for a wireless device.

FIG. 16 illustrates an example of a power system/smart energy system.

FIG. 17 illustrates an example of line current differential protection by two protection relays deployed in two substations.

FIG. 18A and FIG. 18B are example diagrams illustrating problems of existing technologies.

FIG. 19 is an example call flow as per an aspect of an embodiment of the present disclosure.

FIG. 20 is an example diagram depicting a RRCSetupRequest message as per an aspect of an embodiment of the present disclosure.

FIG. 21 is an example diagram depicting the procedures of a wireless device as per an aspect of an embodiment of the present disclosure.

FIG. 22 is an example diagram depicting the procedures of a base station as per an aspect of an embodiment of the present disclosure.

FIG. 23 is an example call flow as per an aspect of an embodiment of the present disclosure.

FIG. 24 is an example call flow as per an aspect of an embodiment of the present disclosure.

FIG. 25 is an example diagram depicting a SIB1 message as per an aspect of an embodiment of the present disclosure.

FIG. 26 is an example call flow as per an aspect of an embodiment of the present disclosure.

FIG. 27 is an example call flow as per an aspect of an embodiment of the present disclosure.

FIG. 28 is an example diagram depicting a PDU session establishment request message as per an aspect of an embodiment of the present disclosure.

FIG. 29 is an example diagram depicting the procedures of a SMF as per an aspect of an embodiment of the present disclosure.

FIG. 30 is an example call flow as per an aspect of an embodiment of the present disclosure.

FIG. 31 is an example call flow as per an aspect of an embodiment of the present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have one or more specific capabilities. When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases refer to a single instance of a particular element, but should not be interpreted to exclude other instances of that element. For example, a bicycle with two wheels may be described as having “a wheel”. Any term that ends with the suffix “(s)” is to be interpreted as “at least one” and/or “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described.

The phrases “based on”, “in response to”, “depending on”, “employing”, “using”, and similar phrases indicate the presence and/or influence of a particular factor and/or condition on an event and/or action, but do not exclude unenumerated factors and/or conditions from also being present and/or influencing the event and/or action. For example, if action X is performed “based on” condition Y, this is to be interpreted as the action being performed “based at least on” condition Y. For example, if the performance of action X is performed when conditions Y and Z are both satisfied, then the performing of action X may be described as being “based on Y”.

The term “configured” may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, a parameter may comprise one or more information objects, and an information object may comprise one or more other objects. For example, if parameter J comprises parameter K, and parameter K comprises parameter L, and parameter L comprises parameter M, then J comprises L, and J comprises M. A parameter may be referred to as a field or information element. In an example embodiment, when one or more messages comprise a plurality of parameters, it implies that a parameter in the plurality of parameters is in at least one of the one or more messages, but does not have to be in each of the one or more messages.

This disclosure may refer to possible combinations of enumerated elements. For the sake of brevity and legibility, the present disclosure does not explicitly recite each and every permutation that may be obtained by choosing from a set of optional features. The present disclosure is to be interpreted as explicitly disclosing all such permutations. For example, the seven possible combinations of enumerated elements A, B, C consist of: (1) “A”; (2) “B”; (3) “C”; (4) “A and B”; (5) “A and C”; (6) “B and C”; and (7) “A, B, and C”. For the sake of brevity and legibility, these seven possible combinations may be described using any of the following interchangeable formulations: “at least one of A, B, and C”; “at least one of A, B, or C”; “one or more of A, B, and C”; “one or more of A, B, or C”; “A, B, and/or C”. It will be understood that impossible combinations are excluded. For example, “X and/or not-X” should be interpreted as “X or not-X”. It will be further understood that these formulations may describe alternative phrasings of overlapping and/or synonymous concepts, for example, “identifier, identification, and/or ID number”.

This disclosure may refer to sets and/or subsets. As an example, set X may be a set of elements comprising one or more elements. If every element of X is also an element of Y, then X may be referred to as a subset of Y. In this disclosure, only non-empty sets and subsets are considered. For example, if Y consists of the elements Y1, Y2, and Y3, then the possible subsets of Y are {Y1, Y2, Y3}, {Y1, Y2}, {Y1, Y3}, {Y2, Y3}, {Y1}, {Y2}, and {Y3}.

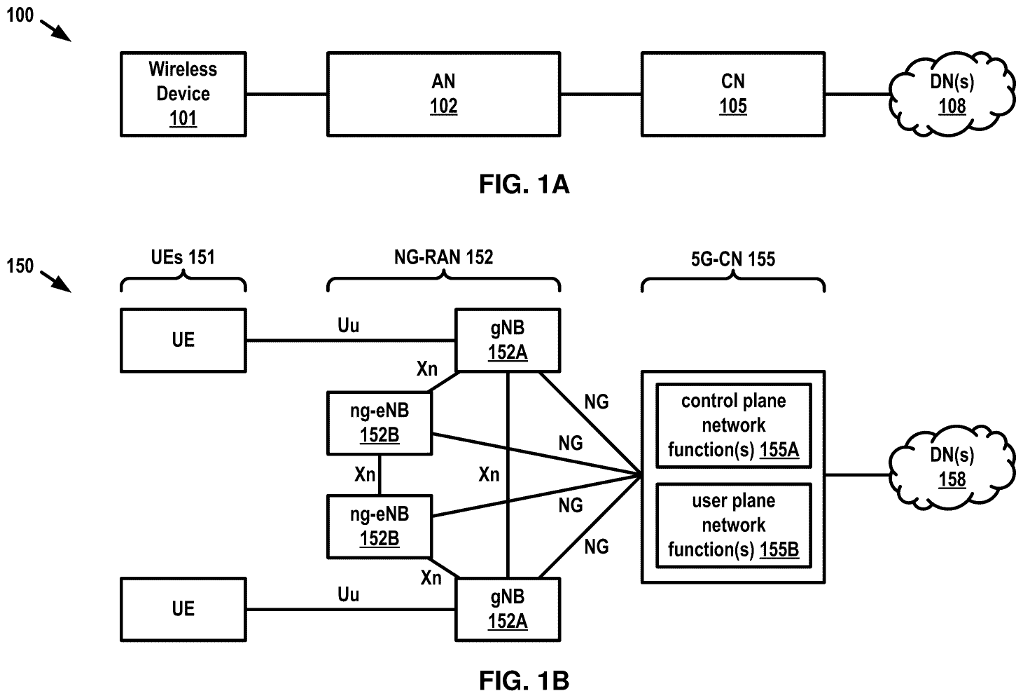

FIG. 1A illustrates an example of a communication network 100 in which embodiments of the present disclosure may be implemented. The communication network 100 may comprise, for example, a public land mobile network (PLMN) run by a network operator. As illustrated in FIG. 1A, the communication network 100 includes a wireless device 101, an access network (AN) 102, a core network (CN) 105, and one or more data network (DNs) 108.

The wireless device 101 may communicate with DNs 108 via AN 102 and CN 105. In the present disclosure, the term wireless device may refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle road side unit (RSU), relay node, automobile, unmanned aerial vehicle, urban air mobility, and/or any combination thereof. The term wireless device encompasses other terminology, including user equipment (UE), user terminal (UT), access terminal (AT), mobile station, handset, wireless transmit and receive unit (WTRU), and/or wireless communication device.

The AN 102 may connect wireless device 101 to CN 105 in any suitable manner. The communication direction from the AN 102 to the wireless device 101 is known as the downlink and the communication direction from the wireless device 101 to AN 102 is known as the uplink. Downlink transmissions may be separated from uplink transmissions using frequency division duplexing (FDD), time-division duplexing (TDD), and/or some combination of the two duplexing techniques. The AN 102 may connect to wireless device 101 through radio communications over an air interface. An access network that at least partially operates over the air interface may be referred to as a radio access network (RAN). The CN 105 may set up one or more end-to-end connection between wireless device 101 and the one or more DNs 108. The CN 105 may authenticate wireless device 101 and provide charging functionality.

In the present disclosure, the term base station may refer to and encompass any element of AN 102 that facilitates communication between wireless device 101 and AN 102. Access networks and base stations have many different names and implementations. The base station may be a terrestrial base station fixed to the earth. The base station may be a mobile base station with a moving coverage area. The base station may be in space, for example, on board a satellite. For example, WiFi and other standards may use the term access point. As another example, the Third-Generation Partnership Project (3GPP) has produced specifications for three generations of mobile networks, each of which uses different terminology. Third Generation (3G) and/or Universal Mobile Telecommunications System (UMTS) standards may use the term Node B. 4G, Long Term Evolution (LTE), and/or Evolved Universal Terrestrial Radio Access (E-UTRA) standards may use the term Evolved Node B (eNB). 5G and/or New Radio (NR) standards may describe AN 102 as a next-generation radio access network (NG-RAN) and may refer to base stations as Next Generation eNB (ng-eNB) and/or Generation Node B (gNB). Future standards (for example, 6G, 7G, 8G) may use new terminology to refer to the elements which implement the methods described in the present disclosure (e.g., wireless devices, base stations, ANs, CNs, and/or components thereof). A base station may be implemented as a repeater or relay node used to extend the coverage area of a donor node. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The AN 102 may include one or more base stations, each having one or more coverage areas. The geographical size and/or extent of a coverage area may be defined in terms of a range at which a receiver of AN 102 can successfully receive transmissions from a transmitter (e.g., wireless device 101) operating within the coverage area (and/or vice-versa). The coverage areas may be referred to as sectors or cells (although in some contexts, the term cell refers to the carrier frequency used in a particular coverage area, rather than the coverage area itself). Base stations with large coverage areas may be referred to as macrocell base stations. Other base stations cover smaller areas, for example, to provide coverage in areas with weak macrocell coverage, or to provide additional coverage in areas with high traffic (sometimes referred to as hotspots). Examples of small cell base stations include, in order of decreasing coverage area, microcell base stations, picocell base stations, and femtocell base stations or home base stations. Together, the coverage areas of the base stations may provide radio coverage to wireless device 101 over a wide geographic area to support wireless device mobility.

A base station may include one or more sets of antennas for communicating with the wireless device 101 over the air interface. Each set of antennas may be separately controlled by the base station. Each set of antennas may have a corresponding coverage area. As an example, a base station may include three sets of antennas to respectively control three coverage areas on three different sides of the base station. The entirety of the base station (and its corresponding antennas) may be deployed at a single location. Alternatively, a controller at a central location may control one or more sets of antennas at one or more distributed locations. The controller may be, for example, a baseband processing unit that is part of a centralized or cloud RAN architecture. The baseband processing unit may be either centralized in a pool of baseband processing units or virtualized. A set of antennas at a distributed location may be referred to as a remote radio head (RRH).

FIG. 1B illustrates another example communication network 150 in which embodiments of the present disclosure may be implemented. The communication network 150 may comprise, for example, a PLMN run by a network operator. As illustrated in FIG. 1B, communication network 150 includes UEs 151, a next generation radio access network (NG-RAN) 152, a 5G core network (5G-CN) 155, and one or more DNs 158. The NG-RAN 152 includes one or more base stations, illustrated as generation node Bs (gNBs) 152A and next generation evolved Node Bs (ng eNBs) 152B. The 5G-CN 155 includes one or more network functions (NFs), including control plane functions 155A and user plane functions 155B. The one or more DNs 158 may comprise public DNs (e.g., the Internet), private DNs, and/or intra-operator DNs. Relative to corresponding components illustrated in FIG. 1A, these components may represent specific implementations and/or terminology.

The base stations of the NG-RAN 152 may be connected to the UEs 151 via Uu interfaces. The base stations of the NG-RAN 152 may be connected to each other via Xn interfaces. The base stations of the NG-RAN 152 may be connected to 5G CN 155 via NG interfaces. The Uu interface may include an air interface. The NG and Xn interfaces may include an air interface, or may consist of direct physical connections and/or indirect connections over an underlying transport network (e.g., an internet protocol (IP) transport network).

Each of the Uu, Xn, and NG interfaces may be associated with a protocol stack. The protocol stacks may include a user plane (UP) and a control plane (CP). Generally, user plane data may include data pertaining to users of the UEs 151, for example, internet content downloaded via a web browser application, sensor data uploaded via a tracking application, or email data communicated to or from an email server. Control plane data, by contrast, may comprise signaling and messages that facilitate packaging and routing of user plane data so that it can be exchanged with the DN(s). The NG interface, for example, may be divided into an NG user plane interface (NG-U) and an NG control plane interface (NG-C). The NG-U interface may provide delivery of user plane data between the base stations and the one or more user plane network functions 155B. The NG-C interface may be used for control signaling between the base stations and the one or more control plane network functions 155A. The NG-C interface may provide, for example, NG interface management, UE context management, UE mobility management, transport of NAS messages, paging, PDU session management, and configuration transfer and/or warning message transmission. In some cases, the NG-C interface may support transmission of user data (for example, a small data transmission for an IoT device).

One or more of the base stations of the NG-RAN 152 may be split into a central unit (CU) and one or more distributed units (DUs). A CU may be coupled to one or more DUs via an F1 interface. The CU may handle one or more upper layers in the protocol stack and the DU may handle one or more lower layers in the protocol stack. For example, the CU may handle RRC, PDCP, and SDAP, and the DU may handle RLC, MAC, and PHY. The one or more DUs may be in geographically diverse locations relative to the CU and/or each other. Accordingly, the CU/DU split architecture may permit increased coverage and/or better coordination.

The gNBs 152A and ng-eNBs 152B may provide different user plane and control plane protocol termination towards the UEs 151. For example, the gNB 154A may provide new radio (NR) protocol terminations over a Uu interface associated with a first protocol stack. The ng-eNBs 152B may provide Evolved UMTS Terrestrial Radio Access (E-UTRA) protocol terminations over a Uu interface associated with a second protocol stack.

The 5G-CN 155 may authenticate UEs 151, set up end-to-end connections between UEs 151 and the one or more DNs 158, and provide charging functionality. The 5G-CN 155 may be based on a service-based architecture, in which the NFs making up the 5G-CN 155 offer services to each other and to other elements of the communication network 150 via interfaces. The 5G-CN 155 may include any number of other NFs and any number of instances of each NF.

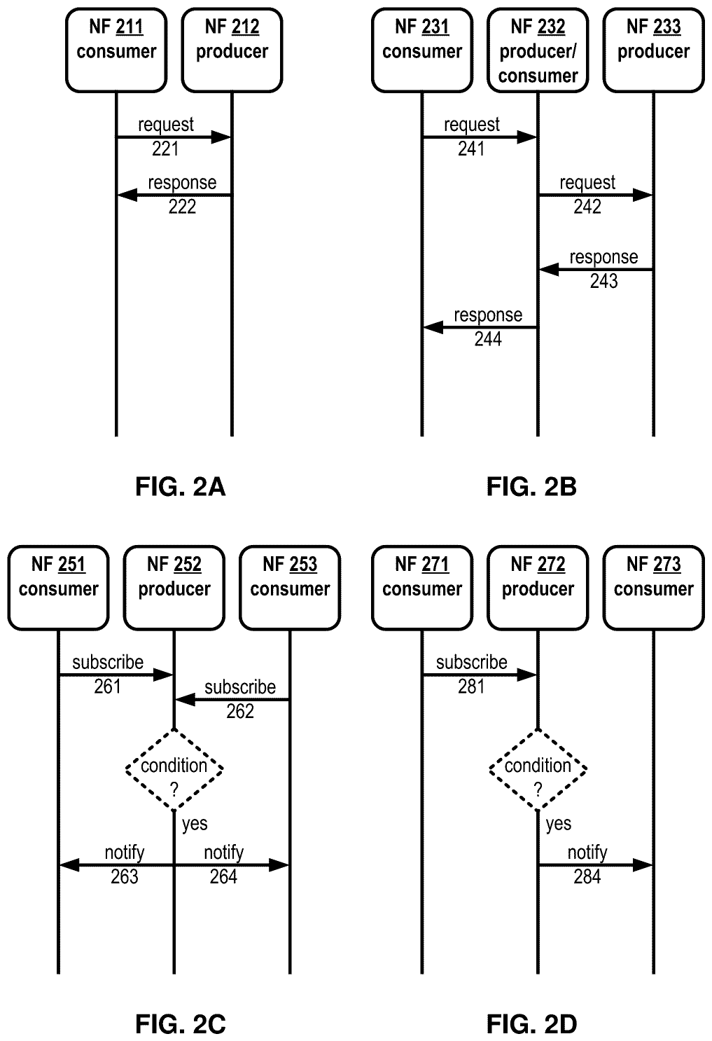

FIG. 2A, FIG. 2B, FIG. 2C, and FIG. 2D illustrate various examples of a framework for a service-based architecture within a core network. In a service-based architecture, a service may be sought by a service consumer and provided by a service producer. Prior to obtaining a particular service, an NF may determine where such as service can be obtained. To discover a service, the NF may communicate with a network repository function (NRF). As an example, an NF that provides one or more services may register with a network repository function (NRF). The NRF may store data relating to the one or more services that the NF is prepared to provide to other NFs in the service-based architecture. A consumer NF may query the NRF to discover a producer NF (for example, by obtaining from the NRF a list of NF instances that provide a particular service).

In the example of FIG. 2A, an NF 211 (a consumer NF in this example) may send a request 221 to an NF 212 (a producer NF). The request 221 may be a request for a particular service and may be sent based on a discovery that NF 212 is a producer of that service. The request 221 may comprise data relating to NF 211 and/or the requested service. The NF 212 may receive request 221, perform one or more actions associated with the requested service (e.g., retrieving data), and provide a response 221. The one or more actions performed by the NF 212 may be based on request data included in the request 221, data stored by NF 212, and/or data retrieved by NF 212. The response 222 may notify NF 211 that the one or more actions have been completed. The response 222 may comprise response data relating to NF 212, the one or more actions, and/or the requested service.

In the example of FIG. 2B, an NF 231 sends a request 241 to an NF 232. In this example, part of the service produced by NF 232 is to send a request 242 to an NF 233. The NF 233 may perform one or more actions and provide a response 243 to NF 232. Based on response 243, NF 232 may send a response 244 to NF 231. It will be understood from FIG. 2B that a single NF may perform the role of producer of services, consumer of services, or both. A particular NF service may include any number of nested NF services produced by one or more other NFs.

FIG. 2C illustrates examples of subscribe-notify interactions between a consumer NF and a producer NF. In FIG. 2C, an NF 251 sends a subscription 261 to an NF 252. An NF 253 sends a subscription 262 to the NF 252. Two NFs are shown in FIG. 2C for illustrative purposes (to demonstrate that the NF 252 may provide multiple subscription services to different NFs), but it will be understood that a subscribe-notify interaction only requires one subscriber. The NFs 251, 253 may be independent from one another. For example, the NFs 251, 253 may independently discover NF 252 and/or independently determine to subscribe to the service offered by NF 252. In response to receipt of a subscription, the NF 252 may provide a notification to the subscribing NF. For example, NF 252 may send a notification 263 to NF 251 based on subscription 261 and may send a notification 264 to NF 253 based on subscription 262.

As shown in the example illustration of FIG. 2C, the sending of the notifications 263, 264 may be based on a determination that a condition has occurred. For example, the notifications 263, 264 may be based on a determination that a particular event has occurred, a determination that a particular condition is outstanding, and/or a determination that a duration of time associated with the subscription has elapsed (for example, a period associated with a subscription for periodic notifications). As shown in the example illustration of FIG. 2C, NF 252 may send notifications 263, 264 to NFs 251, 253 simultaneously and/or in response to the same condition. However, it will be understood that the NF 252 may provide notifications at different times and/or in response to different notification conditions. In an example, the NF 251 may request a notification when a certain parameter, as measured by the NF 252, exceeds a first threshold, and the NF 252 may request a notification when the parameter exceeds a second threshold different from the first threshold. In an example, a parameter of interest and/or a corresponding threshold may be indicated in the subscriptions 261, 262.

FIG. 2D illustrates another example of a subscribe-notify interaction. In FIG. 2D, an NF 271 sends a subscription 281 to an NF 272. In response to receipt of subscription 281 and/or a determination that a notification condition has occurred, NF 272 may send a notification 284. The notification 284 may be sent to an NF 273. Unlike the example in FIG. 2C (in which a notification is sent to the subscribing NF), FIG. 2D demonstrates that a subscription and its corresponding notification may be associated with different NFs. For example, NF 271 may subscribe to the service provided by NF 272 on behalf of NF 273.

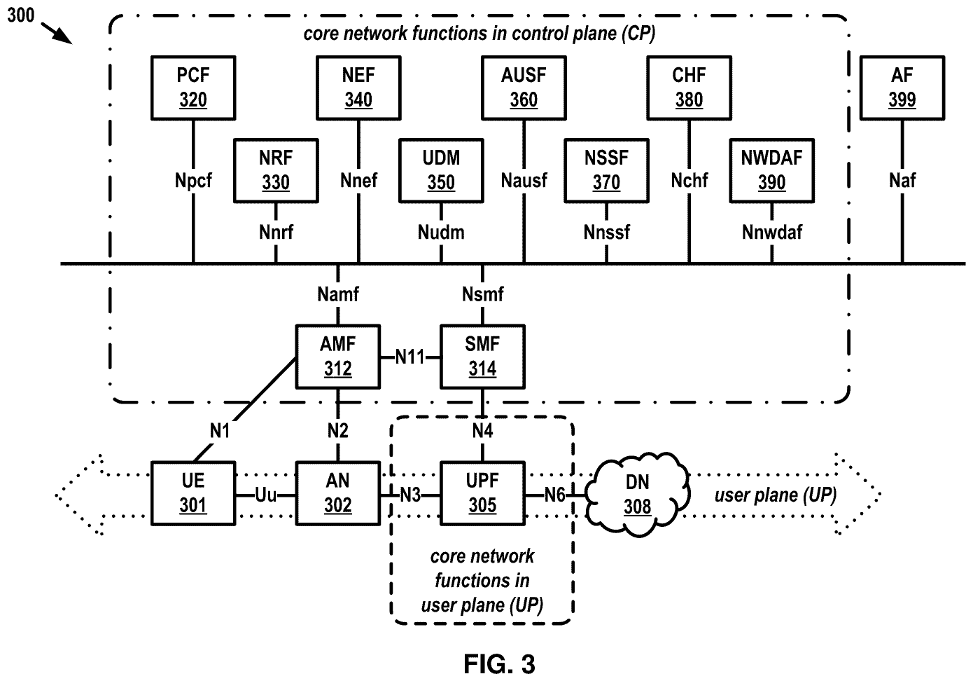

FIG. 3 illustrates another example communication network 300 in which embodiments of the present disclosure may be implemented. Communication network 300 includes a user equipment (UE) 301, an access network (AN) 302, and a data network (DN) 308. The remaining elements depicted in FIG. 3 may be included in and/or associated with a core network. Each element of the core network may be referred to as a network function (NF).

The NFs depicted in FIG. 3 include a user plane function (UPF) 305, an access and mobility management function (AMF) 312, a session management function (SMF) 314, a policy control function (PCF) 320, a network repository function (NRF) 330, a network exposure function (NEF) 340, a unified data management (UDM) 350, an authentication server function (AUSF) 360, a network slice selection function (NSSF) 370, a charging function (CHF) 380, a network data analytics function (NWDAF) 390, and an application function (AF) 399. The UPF 305 may be a user-plane core network function, whereas the NFs 312, 314, and 320-390 may be control-plane core network functions. Although not shown in the example of FIG. 3, the core network may include additional instances of any of the NFs depicted and/or one or more different NF types that provide different services. Other examples of NF type include a gateway mobile location center (GMLC), a location management function (LMF), an operations, administration, and maintenance function (OAM), a public warning system (PWS), a short message service function (SMSF), a unified data repository (UDR), and an unstructured data storage function (UDSF).

Each element depicted in FIG. 3 has an interface with at least one other element. The interface may be a logical connection rather than, for example, a direct physical connection. Any interface may be identified using a reference point representation and/or a service-based representation. In a reference point representation, the letter ‘N’ is followed by a numeral, indicating an interface between two specific elements. For example, as shown in FIG. 3, AN 302 and UPF 305 interface via ‘N3’, whereas UPF 305 and DN 308 interface via ‘N6’. By contrast, in a service-based representation, the letter ‘N’ is followed by letters. The letters identify an NF that provides services to the core network. For example, PCF 320 may provide services via interface ‘Npcf’. The PCF 320 may provide services to any NF in the core network via ‘Npcf’. Accordingly, a service-based representation may correspond to a bundle of reference point representations. For example, the Npcf interface between PCF 320 and the core network generally may correspond to an N7 interface between PCF 320 and SMF 314, an N30 interface between PCF 320 and NEF 340, etc.

The UPF 305 may serve as a gateway for user plane traffic between AN 302 and DN 308. The UE 301 may connect to UPF 305 via a Uu interface and an N3 interface (also described as NG-U interface). The UPF 305 may connect to DN 308 via an N6 interface. The UPF 305 may connect to one or more other UPFs (not shown) via an N9 interface. The UE 301 may be configured to receive services through a protocol data unit (PDU) session, which is a logical connection between UE 301 and DN 308. The UPF 305 (or a plurality of UPFs if desired) may be selected by SMF 314 to handle a particular PDU session between UE 301 and DN 308. The SMF 314 may control the functions of UPF 305 with respect to the PDU session. The SMF 314 may connect to UPF 305 via an N4 interface. The UPF 305 may handle any number of PDU sessions associated with any number of UEs (via any number of ANs). For purposes of handling the one or more PDU sessions, UPF 305 may be controlled by any number of SMFs via any number of corresponding N4 interfaces.

The AMF 312 depicted in FIG. 3 may control UE access to the core network. The UE 301 may register with the network via AMF 312. It may be necessary for UE 301 to register prior to establishing a PDU session. The AMF 312 may manage a registration area of UE 301, enabling the network to track the physical location of UE 301 within the network. For a UE in connected mode, AMF 312 may manage UE mobility, for example, handovers from one AN or portion thereof to another. For a UE in idle mode, AMF 312 may perform registration updates and/or page the UE to transition the UE to connected mode.

The AMF 312 may receive, from UE 301, non-access stratum (NAS) messages transmitted in accordance with NAS protocol. NAS messages relate to communications between UE 301 and the core network. Although NAS messages may be relayed to AMF 312 via AN 302, they may be described as communications via the N1 interface. NAS messages may facilitate UE registration and mobility management, for example, by authenticating, identifying, configuring, and/or managing a connection of UE 301. NAS messages may support session management procedures for maintaining user plane connectivity and quality of service (QoS) of a session between UE 301 and DN 309. If the NAS message involves session management, AMF 312 may send the NAS message to SMF 314. NAS messages may be used to transport messages between UE 301 and other components of the core network (e.g., core network components other than AMF 312 and SMF 314). The AMF 312 may act on a particular NAS message itself, or alternatively, forward the NAS message to an appropriate core network function (e.g., SMF 314, etc.)

The SMF 314 depicted in FIG. 3 may establish, modify, and/or release a PDU session based on messaging received UE 301. The SMF 314 may allocate, manage, and/or assign an IP address to UE 301, for example, upon establishment of a PDU session. There may be multiple SMFs in the network, each of which may be associated with a respective group of wireless devices, base stations, and/or UPFs. A UE with multiple PDU sessions may be associated with a different SMF for each PDU session. As noted above, SMF 314 may select one or more UPFs to handle a PDU session and may control the handling of the PDU session by the selected UPF by providing rules for packet handling (PDR, FAR, QER, etc.). Rules relating to QoS and/or charging for a particular PDU session may be obtained from PCF 320 and provided to UPF 305.

The PCF 320 may provide, to other NFs, services relating to policy rules. The PCF 320 may use subscription data and information about network conditions to determine policy rules and then provide the policy rules to a particular NF which may be responsible for enforcement of those rules. Policy rules may relate to policy control for access and mobility, and may be enforced by the AMF. Policy rules may relate to session management, and may be enforced by the SMF 314. Policy rules may be, for example, network-specific, wireless device-specific, session-specific, or data flow-specific.

The NRF 330 may provide service discovery. The NRF 330 may belong to a particular PLMN. The NRF 330 may maintain NF profiles relating to other NFs in the communication network 300. The NF profile may include, for example, an address, PLMN, and/or type of the NF, a slice identifier, a list of the one or more services provided by the NF, and the authorization required to access the services.

The NEF 340 depicted in FIG. 3 may provide an interface to external domains, permitting external domains to selectively access the control plane of the communication network 300. The external domain may comprise, for example, third-party network functions, application functions, etc. The NEF 340 may act as a proxy between external elements and network functions such as AMF 312, SMF 314, PCF 320, UDM 350, etc. As an example, NEF 340 may determine a location or reachability status of UE 301 based on reports from AMF 312, and provide status information to an external element. As an example, an external element may provide, via NEF 340, information that facilitates the setting of parameters for establishment of a PDU session. The NEF 340 may determine which data and capabilities of the control plane are exposed to the external domain. The NEF 340 may provide secure exposure that authenticates and/or authorizes an external entity to which data or capabilities of the communication network 300 are exposed. The NEF 340 may selectively control the exposure such that the internal architecture of the core network is hidden from the external domain.

The UDM 350 may provide data storage for other NFs. The UDM 350 may permit a consolidated view of network information that may be used to ensure that the most relevant information can be made available to different NFs from a single resource. The UDM 350 may store and/or retrieve information from a unified data repository (UDR). For example, UDM 350 may obtain user subscription data relating to UE 301 from the UDR.

The AUSF 360 may support mutual authentication of UE 301 by the core network and authentication of the core network by UE 301. The AUSF 360 may perform key agreement procedures and provide keying material that can be used to improve security.

The NSSF 370 may select one or more network slices to be used by the UE 301. The NSSF 370 may select a slice based on slice selection information. For example, the NSSF 370 may receive Single Network Slice Selection Assistance Information (S-NSSAI) and map the S-NSSAI to a network slice instance identifier (NSI).

The CHF 380 may control billing-related tasks associated with UE 301. For example, UPF 305 may report traffic usage associated with UE 301 to SMF 314. The SMF 314 may collect usage data from UPF 305 and one or more other UPFs. The usage data may indicate how much data is exchanged, what DN the data is exchanged with, a network slice associated with the data, or any other information that may influence billing. The SMF 314 may share the collected usage data with the CHF. The CHF may use the collected usage data to perform billing-related tasks associated with UE 301. The CHF may, depending on the billing status of UE 301, instruct SMF 314 to limit or influence access of UE 301 and/or to provide billing-related notifications to UE 301.

The NWDAF 390 may collect and analyze data from other network functions and offer data analysis services to other network functions. As an example, NWDAF 390 may collect data relating to a load level for a particular network slice instance from UPF 305, AMF 312, and/or SMF 314. Based on the collected data, NWDAF 390 may provide load level data to the PCF 320 and/or NSSF 370, and/or notify the PC 220 and/or NSSF 370 if load level for a slice reaches and/or exceeds a load level threshold.

The AF 399 may be outside the core network, but may interact with the core network to provide information relating to the QoS requirements or traffic routing preferences associated with a particular application. The AF 399 may access the core network based on the exposure constraints imposed by the NEF 340. However, an operator of the core network may consider the AF 399 to be a trusted domain that can access the network directly.

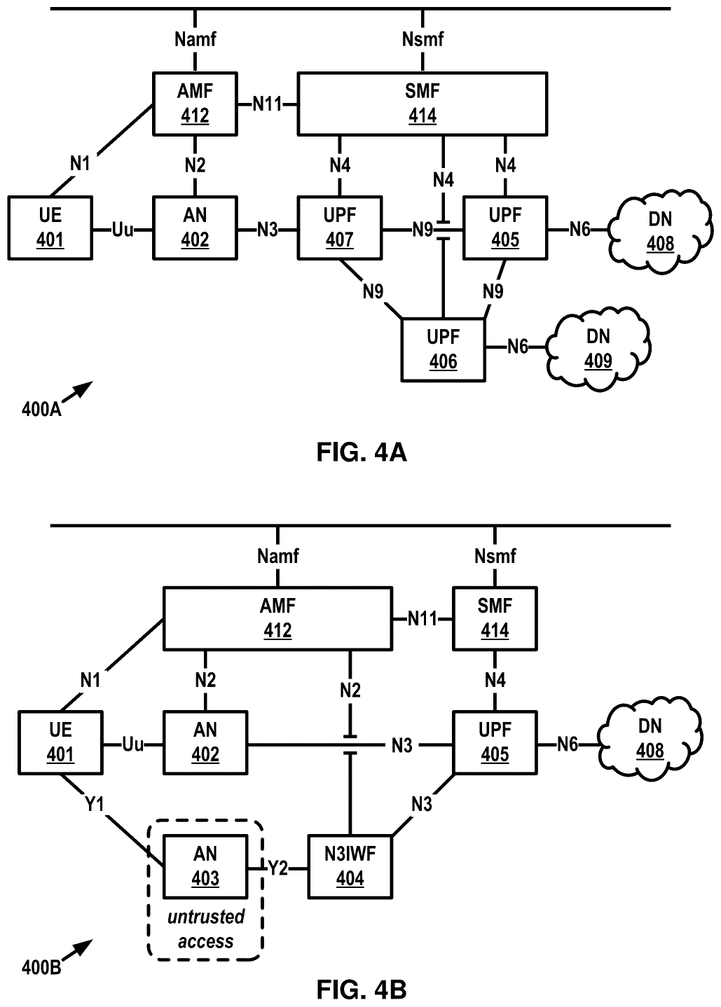

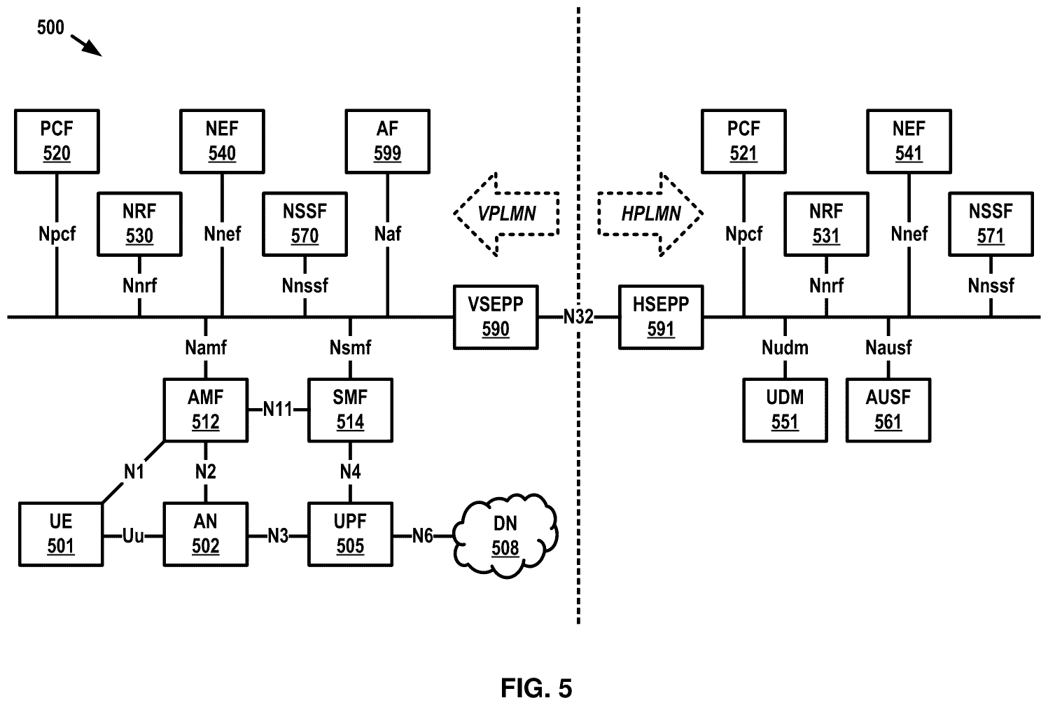

FIGS. 4A, 4B, and 5 illustrate other examples of core network architectures that are analogous in some respects to the core network architecture 300 depicted in FIG. 3. For conciseness, some of the core network elements depicted in FIG. 3 are omitted. Many of the elements depicted in FIGS. 4A, 4B, and 5 are analogous in some respects to elements depicted in FIG. 3. For conciseness, some of the details relating to their functions or operation are omitted.

FIG. 4A illustrates an example of a core network architecture 400A comprising an arrangement of multiple UPFs. Core network architecture 400A includes a UE 401, an AN 402, an AMF 412, and an SMF 414. Unlike previous examples of core network architectures described above, FIG. 4A depicts multiple UPFs, including a UPF 405, a UPF 406, and a UPF 407, and multiple DNs, including a DN 408 and a DN 409. Each of the multiple UPFs 405, 406, 407 may communicate with the SMF 414 via an N4 interface. The DNs 408, 409 communicate with the UPFs 405, 406, respectively, via N6 interfaces. As shown in FIG. 4A, the multiple UPFs 405, 406, 407 may communicate with one another via N9 interfaces.

The UPFs 405, 406, 407 may perform traffic detection, in which the UPFs identify and/or classify packets. Packet identification may be performed based on packet detection rules (PDR) provided by the SMF 414. A PDR may include packet detection information comprising one or more of: a source interface, a UE IP address, core network (CN) tunnel information (e.g., a CN address of an N3/N9 tunnel corresponding to a PDU session), a network instance identifier, a quality of service flow identifier (QFI), a filter set (for example, an IP packet filter set or an ethernet packet filter set), and/or an application identifier.

In addition to indicating how a particular packet is to be detected, a PDR may further indicate rules for handling the packet upon detection thereof. The rules may include, for example, forwarding action rules (FARs), multi-access rules (MARs), usage reporting rules (URRs), QoS enforcement rules (QERs), etc. For example, the PDR may comprise one or more FAR identifiers, MAR identifiers, URR identifiers, and/or QER identifiers. These identifiers may indicate the rules that are prescribed for the handling of a particular detected packet.

The UPF 405 may perform traffic forwarding in accordance with a FAR. For example, the FAR may indicate that a packet associated with a particular PDR is to be forwarded, duplicated, dropped, and/or buffered. The FAR may indicate a destination interface, for example, “access” for downlink or “core” for uplink. If a packet is to be buffered, the FAR may indicate a buffering action rule (BAR). As an example, UPF 405 may perform data buffering of a certain number downlink packets if a PDU session is deactivated.

The UPF 405 may perform QoS enforcement in accordance with a QER. For example, the QER may indicate a guaranteed bitrate that is authorized and/or a maximum bitrate to be enforced for a packet associated with a particular PDR. The QER may indicate that a particular guaranteed and/or maximum bitrate may be for uplink packets and/or downlink packets. The UPF 405 may mark packets belonging to a particular QoS flow with a corresponding QFI. The marking may enable a recipient of the packet to determine a QoS of the packet.

The UPF 405 may provide usage reports to the SMF 414 in accordance with a URR. The URR may indicate one or more triggering conditions for generation and reporting of the usage report, for example, immediate reporting, periodic reporting, a threshold for incoming uplink traffic, or any other suitable triggering condition. The URR may indicate a method for measuring usage of network resources, for example, data volume, duration, and/or event.

As noted above, the DNs 408, 409 may comprise public DNs (e.g., the Internet), private DNs (e.g., private, internal corporate-owned DNs), and/or intra-operator DNs. Each DN may provide an operator service and/or a third-party service. The service provided by a DN may be the Internet, an IP multimedia subsystem (IMS), an augmented or virtual reality network, an edge computing or mobile edge computing (MEC) network, etc. Each DN may be identified using a data network name (DNN). The UE 401 may be configured to establish a first logical connection with DN 408 (a first PDU session), a second logical connection with DN 409 (a second PDU session), or both simultaneously (first and second PDU sessions).

Each PDU session may be associated with at least one UPF configured to operate as a PDU session anchor (PSA, or “anchor”). The anchor may be a UPF that provides an N6 interface with a DN.

In the example of FIG. 4A, UPF 405 may be the anchor for the first PDU session between UE 401 and DN 408, whereas the UPF 406 may be the anchor for the second PDU session between UE 401 and DN 409. The core network may use the anchor to provide service continuity of a particular PDU session (for example, IP address continuity) as UE 401 moves from one access network to another. For example, suppose that UE 401 establishes a PDU session using a data path to the DN 408 using an access network other than AN 402. The data path may include UPF 405 acting as anchor. Suppose further that the UE 401 later moves into the coverage area of the AN 402. In such a scenario, SMF 414 may select a new UPF (UPF 407) to bridge the gap between the newly-entered access network (AN 402) and the anchor UPF (UPF 405). The continuity of the PDU session may be preserved as any number of UPFs are added or removed from the data path. When a UPF is added to a data path, as shown in FIG. 4A, it may be described as an intermediate UPF and/or a cascaded UPF.

As noted above, UPF 406 may be the anchor for the second PDU session between UE 401 and DN 409. Although the anchor for the first and second PDU sessions are associated with different UPFs in FIG. 4A, it will be understood that this is merely an example. It will also be understood that multiple PDU sessions with a single DN may correspond to any number of anchors. When there are multiple UPFs, a UPF at the branching point (UPF 407 in FIG. 4) may operate as an uplink classifier (UL-CL). The UL-CL may divert uplink user plane traffic to different UPFs.

The SMF 414 may allocate, manage, and/or assign an IP address to UE 401, for example, upon establishment of a PDU session. The SMF 414 may maintain an internal pool of IP addresses to be assigned. The SMF 414 may, if necessary, assign an IP address provided by a dynamic host configuration protocol (DHCP) server or an authentication, authorization, and accounting (AAA) server. IP address management may be performed in accordance with a session and service continuity (SSC) mode. In SSC mode 1, an IP address of UE 401 may be maintained (and the same anchor UPF may be used) as the wireless device moves within the network. In SSC mode 2, the IP address of UE 401 changes as UE 401 moves within the network (e.g., the old IP address and UPF may be abandoned and a new IP address and anchor UPF may be established). In SSC mode 3, it may be possible to maintain an old IP address (similar to SSC mode 1) temporarily while establishing a new IP address (similar to SSC mode 2), thus combining features of SSC modes 1 and 2. Applications that are sensitive to IP address changes may operate in accordance with SSC mode 1.

UPF selection may be controlled by SMF 414. For example, upon establishment and/or modification of a PDU session between UE 401 and DN 408, SMF 414 may select UPF 405 as the anchor for the PDU session and/or UPF 407 as an intermediate UPF. Criteria for UPF selection include path efficiency and/or speed between AN 402 and DN 408. The reliability, load status, location, slice support and/or other capabilities of candidate UPFs may also be considered.

FIG. 4B illustrates an example of a core network architecture 400B that accommodates untrusted access. Similar to FIG. 4A, UE 401 as depicted in FIG. 4B connects to DN 408 via AN 402 and UPF 405. The AN 402 and UPF 405 constitute trusted (e.g., 3GPP) access to the DN 408. By contrast, UE 401 may also access DN 408 using an untrusted access network, AN 403, and a non-3GPP interworking function (N3IWF) 404.

The AN 403 may be, for example, a wireless land area network (WLAN) operating in accordance with the IEEE 802.11 standard. The UE 401 may connect to AN 403, via an interface Y1, in whatever manner is prescribed for AN 403. The connection to AN 403 may or may not involve authentication. The UE 401 may obtain an IP address from AN 403. The UE 401 may determine to connect to core network 400B and select untrusted access for that purpose. The AN 403 may communicate with N3IWF 404 via a Y2 interface. After selecting untrusted access, the UE 401 may provide N3IWF 404 with sufficient information to select an AMF. The selected AMF may be, for example, the same AMF that is used by UE 401 for 3GPP access (AMF 412 in the present example). The N3IWF 404 may communicate with AMF 412 via an N2 interface. The UPF 405 may be selected and N3IWF 404 may communicate with UPF 405 via an N3 interface. The UPF 405 may be a PDU session anchor (PSA) and may remain the anchor for the PDU session even as UE 401 shifts between trusted access and untrusted access.

FIG. 5 illustrates an example of a core network architecture 500 in which a UE 501 is in a roaming scenario. In a roaming scenario, UE 501 is a subscriber of a first PLMN (a home PLMN, or HPLMN) but attaches to a second PLMN (a visited PLMN, or VPLMN). Core network architecture 500 includes UE 501, an AN 502, a UPF 505, and a DN 508. The AN 502 and UPF 505 may be associated with a VPLMN. The VPLMN may manage the AN 502 and UPF 505 using core network elements associated with the VPLMN, including an AMF 512, an SMF 514, a PCF 520, an NRF 530, an NEF 540, and an NSSF 570. An AF 599 may be adjacent the core network of the VPLMN.

The UE 501 may not be a subscriber of the VPLMN. The AMF 512 may authorize UE 501 to access the network based on, for example, roaming restrictions that apply to UE 501. In order to obtain network services provided by the VPLMN, it may be necessary for the core network of the VPLMN to interact with core network elements of a HPLMN of UE 501, in particular, a PCF 521, an NRF 531, an NEF 541, a UDM 551, and/or an AUSF 561. The VPLMN and HPLMN may communicate using an N32 interface connecting respective security edge protection proxies (SEPPs). In FIG. 5, the respective SEPPs are depicted as a VSEPP 590 and an HSEPP 591.

The VSEPP 590 and the HSEPP 591 communicate via an N32 interface for defined purposes while concealing information about each PLMN from the other. The SEPPs may apply roaming policies based on communications via the N32 interface. The PCF 520 and PCF 521 may communicate via the SEPPs to exchange policy-related signaling. The NRF 530 and NRF 531 may communicate via the SEPPs to enable service discovery of NFs in the respective PLMNs. The VPLMN and HPLMN may independently maintain NEF 540 and NEF 541. The NSSF 570 and NSSF 571 may communicate via the SEPPs to coordinate slice selection for UE 501. The HPLMN may handle all authentication and subscription related signaling. For example, when the UE 501 registers or requests service via the VPLMN, the VPLMN may authenticate UE 501 and/or obtain subscription data of UE 501 by accessing, via the SEPPs, the UDM 551 and AUSF 561 of the HPLMN.

The core network architecture 500 depicted in FIG. 5 may be referred to as a local breakout configuration, in which UE 501 accesses DN 508 using one or more UPFs of the VPLMN (i.e., UPF 505). However, other configurations are possible. For example, in a home-routed configuration (not shown in FIG. 5), UE 501 may access a DN using one or more UPFs of the HPLMN. In the home-routed configuration, an N9 interface may run parallel to the N32 interface, crossing the frontier between the VPLMN and the HPLMN to carry user plane data. One or more SMFs of the respective PLMNs may communicate via the N32 interface to coordinate session management for UE 501. The SMFs may control their respective UPFs on either side of the frontier.

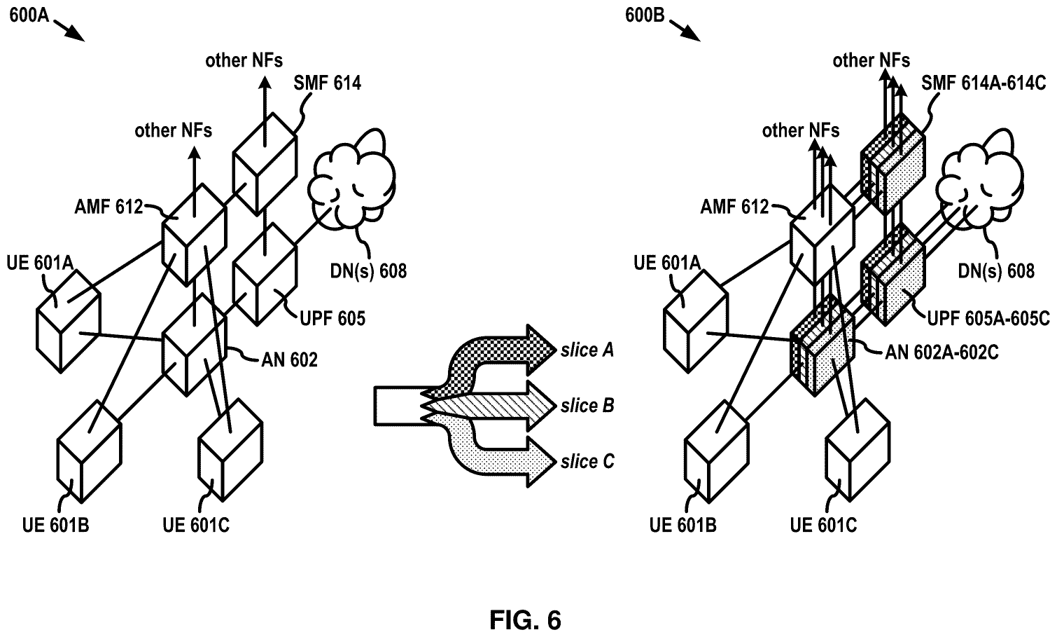

FIG. 6 illustrates an example of network slicing. Network slicing may refer to division of shared infrastructure (e.g., physical infrastructure) into distinct logical networks. These distinct logical networks may be independently controlled, isolated from one another, and/or associated with dedicated resources.

Network architecture 600A illustrates an un-sliced physical network corresponding to a single logical network. The network architecture 600A comprises a user plane wherein UEs 601A, 601B, 601C (collectively, UEs 601) have a physical and logical connection to a DN 608 via an AN 602 and a UPF 605. The network architecture 600A comprises a control plane wherein an AMF 612 and a SMF 614 control various aspects of the user plane.

The network architecture 600A may have a specific set of characteristics (e.g., relating to maximum bit rate, reliability, latency, bandwidth usage, power consumption, etc.). This set of characteristics may be affected by the nature of the network elements themselves (e.g., processing power, availability of free memory, proximity to other network elements, etc.) or the management thereof (e.g., optimized to maximize bit rate or reliability, reduce latency or power bandwidth usage, etc.). The characteristics of network architecture 600A may change over time, for example, by upgrading equipment or by modifying procedures to target a particular characteristic. However, at any given time, network architecture 600A will have a single set of characteristics that may or may not be optimized for a particular use case. For example, UEs 601A, 601B, 601C may have different requirements, but network architecture 600A can only be optimized for one of the three.

Network architecture 600B is an example of a sliced physical network divided into multiple logical networks. In FIG. 6, the physical network is divided into three logical networks, referred to as slice A, slice B, and slice C. For example, UE 601A may be served by AN 602A, UPF 605A, AMF 612, and SMF 614A. UE 601B may be served by AN 602B, UPF 605B, AMF 612, and SMF 614B. UE 601C may be served by AN 602C, UPF 605C, AMF 612, and SMF 614C. Although the respective UEs 601 communicate with different network elements from a logical perspective, these network elements may be deployed by a network operator using the same physical network elements.

Each network slice may be tailored to network services having different sets of characteristics. For example, slice A may correspond to enhanced mobile broadband (eMBB) service. Mobile broadband may refer to internet access by mobile users, commonly associated with smartphones. Slice B may correspond to ultra-reliable low-latency communication (URLLC), which focuses on reliability and speed. Relative to eMBB, URLLC may improve the feasibility of use cases such as autonomous driving and telesurgery. Slice C may correspond to massive machine type communication (mMTC), which focuses on low-power services delivered to a large number of users. For example, slice C may be optimized for a dense network of battery-powered sensors that provide small amounts of data at regular intervals. Many mMTC use cases would be prohibitively expensive if they operated using an eMBB or URLLC network.

If the service requirements for one of the UEs 601 changes, then the network slice serving that UE can be updated to provide better service. Moreover, the set of network characteristics corresponding to eMBB, URLLC, and mMTC may be varied, such that differentiated species of eMBB, URLLC, and mMTC are provided. Alternatively, network operators may provide entirely new services in response to, for example, customer demand.

In FIG. 6, each of the UEs 601 has its own network slice. However, it will be understood that a single slice may serve any number of UEs and a single UE may operate using any number of slices. Moreover, in the example network architecture 600B, the AN 602, UPF 605 and SMF 614 are separated into three separate slices, whereas the AMF 612 is unsliced. However, it will be understood that a network operator may deploy any architecture that selectively utilizes any mix of sliced and unsliced network elements, with different network elements divided into different numbers of slices. Although FIG. 6 only depicts three core network functions, it will be understood that other core network functions may be sliced as well. A PLMN that supports multiple network slices may maintain a separate network repository function (NFR) for each slice, enabling other NFs to discover network services associated with that slice.

Network slice selection may be controlled by an AMF, or alternatively, by a separate network slice selection function (NSSF). For example, a network operator may define and implement distinct network slice instances (NSIs). Each NSI may be associated with single network slice selection assistance information (S-NSSAI). The S-NSSAI may include a particular slice/service type (SST) indicator (indicating eMBB, URLLC, mMTC, etc.). as an example, a particular tracking area may be associated with one or more configured S-NSSAIs. UEs may identify one or more requested and/or subscribed S-NSSAIs (e.g., during registration). The network may indicate to the UE one or more allowed and/or rejected S-NSSAIs.

The S-NSSAI may further include a slice differentiator (SD) to distinguish between different tenants of a particular slice and/or service type. For example, a tenant may be a customer (e.g., vehicle manufacture, service provider, etc.) of a network operator that obtains (for example, purchases) guaranteed network resources and/or specific policies for handling its subscribers. The network operator may configure different slices and/or slice types, and use the SD to determine which tenant is associated with a particular slice.

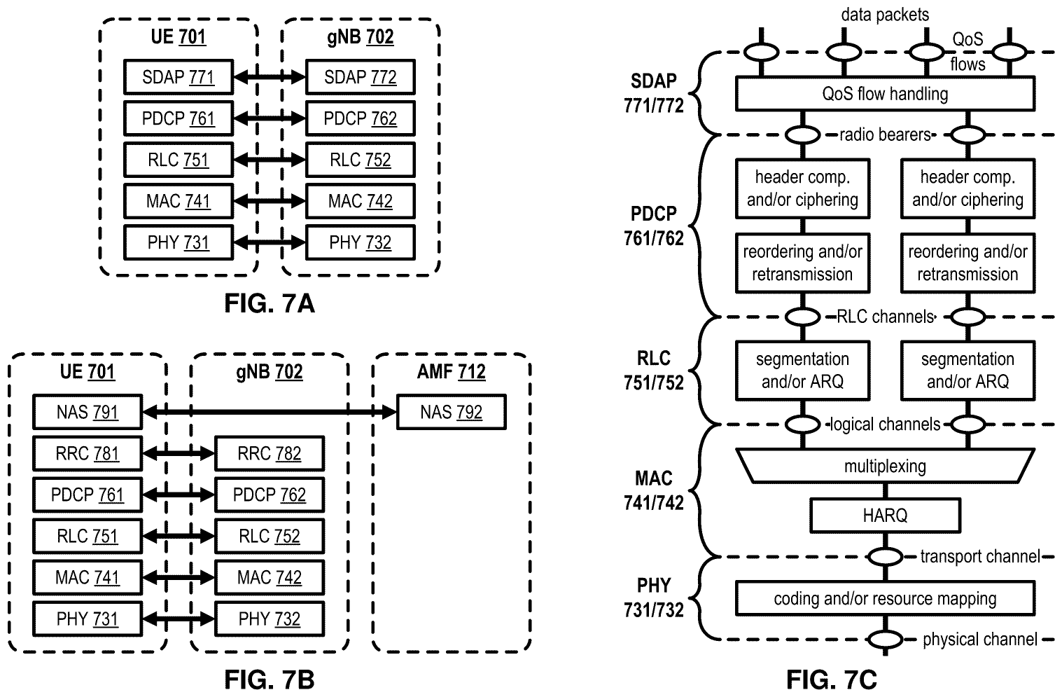

FIG. 7A, FIG. 7B, and FIG. 7C illustrate a user plane (UP) protocol stack, a control plane (CP) protocol stack, and services provided between protocol layers of the UP protocol stack.

The layers may be associated with an open system interconnection (OSI) model of computer networking functionality. In the OSI model, layer 1 may correspond to the bottom layer, with higher layers on top of the bottom layer. Layer 1 may correspond to a physical layer, which is concerned with the physical infrastructure used for transfer of signals (for example, cables, fiber optics, and/or radio frequency transceivers). In New Radio (NR), layer 1 may comprise a physical layer (PHY). Layer 2 may correspond to a data link layer. Layer 2 may be concerned with packaging of data (into, e.g., data frames) for transfer, between nodes of the network, using the physical infrastructure of layer 1. In NR, layer 2 may comprise a media access control layer (MAC), a radio link control layer (RLC), a packet data convergence layer (PDCP), and a service data application protocol layer (SDAP).

Layer 3 may correspond to a network layer. Layer 3 may be concerned with routing of the data which has been packaged in layer 2. Layer 3 may handle prioritization of data and traffic avoidance. In NR, layer 3 may comprise a radio resource control layer (RRC) and a non-access stratum layer (NAS). Layers 4 through 7 may correspond to a transport layer, a session layer, a presentation layer, and an application layer. The application layer interacts with an end user to provide data associated with an application. In an example, an end user implementing the application may generate data associated with the application and initiate sending of that information to a targeted data network (e.g., the Internet, an application server, etc.). Starting at the application layer, each layer in the OSI model may manipulate and/or repackage the information and deliver it to a lower layer. At the lowest layer, the manipulated and/or repackaged information may be exchanged via physical infrastructure (for example, electrically, optically, and/or electromagnetically). As it approaches the targeted data network, the information will be unpackaged and provided to higher and higher layers, until it once again reaches the application layer in a form that is usable by the targeted data network (e.g., the same form in which it was provided by the end user). To respond to the end user, the data network may perform this procedure in reverse.

FIG. 7A illustrates a user plane protocol stack. The user plane protocol stack may be a new radio (NR) protocol stack for a Uu interface between a UE 701 and a gNB 702. In layer 1 of the UP protocol stack, the UE 701 may implement PHY 731 and the gNB 702 may implement PHY 732. In layer 2 of the UP protocol stack, the UE 701 may implement MAC 741, RLC 751, PDCP 761, and SDAP 771. The gNB 702 may implement MAC 742, RLC 752, PDCP 762, and SDAP 772.

FIG. 7B illustrates a control plane protocol stack. The control plane protocol stack may be an NR protocol stack for the Uu interface between the UE 701 and the gNB 702 and/or an N1 interface between the UE 701 and an AMF 712. In layer 1 of the CP protocol stack, the UE 701 may implement PHY 731 and the gNB 702 may implement PHY 732. In layer 2 of the CP protocol stack, the UE 701 may implement MAC 741, RLC 751, PDCP 761, RRC 781, and NAS 791. The gNB 702 may implement MAC 742, RLC 752, PDCP 762, and RRC 782. The AMF 712 may implement NAS 792.

The NAS may be concerned with the non-access stratum, in particular, communication between the UE 701 and the core network (e.g., the AMF 712). Lower layers may be concerned with the access stratum, for example, communication between the UE 701 and the gNB 702. Messages sent between the UE 701 and the core network may be referred to as NAS messages. In an example, a NAS message may be relayed by the gNB 702, but the content of the NAS message (e.g., information elements of the NAS message) may not be visible to the gNB 702.

FIG. 7C illustrates an example of services provided between protocol layers of the NR user plane protocol stack illustrated in FIG. 7A. The UE 701 may receive services through a PDU session, which may be a logical connection between the UE 701 and a data network (DN). The UE 701 and the DN may exchange data packets associated with the PDU session. The PDU session may comprise one or more quality of service (QoS) flows. SDAP 771 and SDAP 772 may perform mapping and/or demapping between the one or more QoS flows of the PDU session and one or more radio bearers (e.g., data radio bearers). The mapping between the QoS flows and the data radio bearers may be determined in the SDAP 772 by the gNB 702, and the UE 701 may be notified of the mapping (e.g., based on control signaling and/or reflective mapping). For reflective mapping, the SDAP 772 of the gNB 220 may mark downlink packets with a QoS flow indicator (QFI) and deliver the downlink packets to the UE 701. The UE 701 may determine the mapping based on the QFI of the downlink packets.

PDCP 761 and PDCP 762 may perform header compression and/or decompression. Header compression may reduce the amount of data transmitted over the physical layer. The PDCP 761 and PDCP 762 may perform ciphering and/or deciphering. Ciphering may reduce unauthorized decoding of data transmitted over the physical layer (e.g., intercepted on an air interface), and protect data integrity (e.g., to ensure control messages originate from intended sources). The PDCP 761 and PDCP 762 may perform retransmissions of undelivered packets, in-sequence delivery and reordering of packets, duplication of packets, and/or identification and removal of duplicate packets. In a dual connectivity scenario, PDCP 761 and PDCP 762 may perform mapping between a split radio bearer and RLC channels.

RLC 751 and RLC 752 may perform segmentation, retransmission through Automatic Repeat Request (ARQ). The RLC 751 and RLC 752 may perform removal of duplicate data units received from MAC 741 and MAC 742, respectively. The RLCs 213 and 223 may provide RLC channels as a service to PDCPs 214 and 224, respectively.

MAC 741 and MAC 742 may perform multiplexing and/or demultiplexing of logical channels. MAC 741 and MAC 742 may map logical channels to transport channels. In an example, UE 701 may, in MAC 741, multiplex data units of one or more logical channels into a transport block. The UE 701 may transmit the transport block to the gNB 702 using PHY 731. The gNB 702 may receive the transport block using PHY 732 and demultiplex data units of the transport blocks back into logical channels. MAC 741 and MAC 742 may perform error correction through Hybrid Automatic Repeat Request (HARQ), logical channel prioritization, and/or padding.

PHY 731 and PHY 732 may perform mapping of transport channels to physical channels. PHY 731 and PHY 732 may perform digital and analog signal processing functions (e.g., coding/decoding and modulation/demodulation) for sending and receiving information (e.g., transmission via an air interface). PHY 731 and PHY 732 may perform multi-antenna mapping.

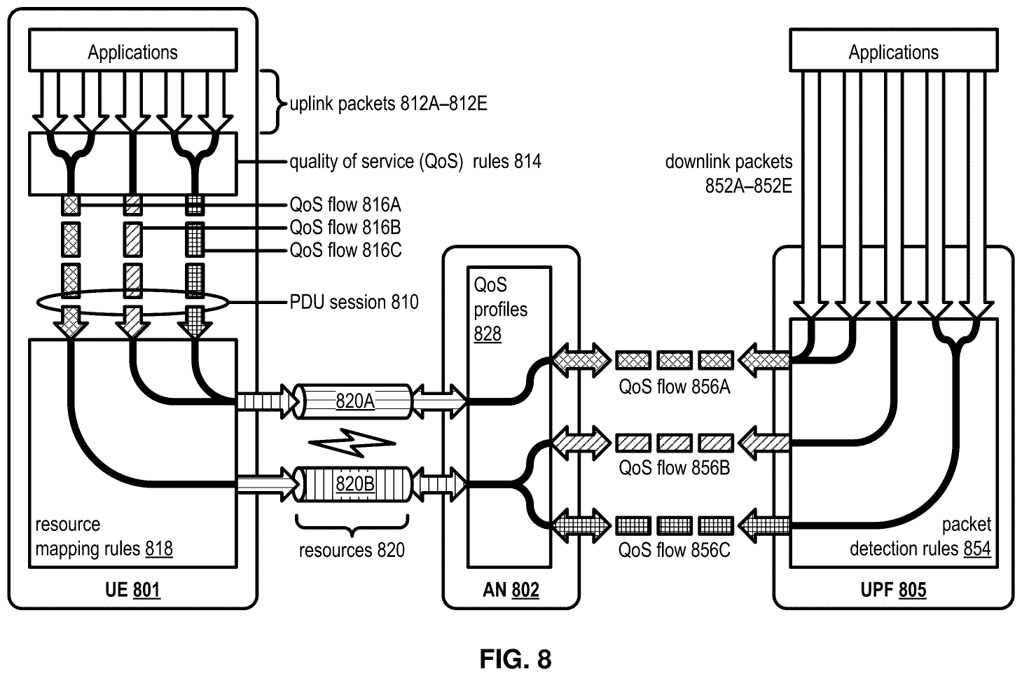

FIG. 8 illustrates an example of a quality of service (QoS) model for differentiated data exchange. In the QoS model of FIG. 8, there are a UE 801, a AN 802, and a UPF 805. The QoS model facilitates prioritization of certain packet or protocol data units (PDUs), also referred to as packets. For example, higher-priority packets may be exchanged faster and/or more reliably than lower-priority packets. The network may devote more resources to exchange of high-QoS packets.

In the example of FIG. 8, a PDU session 810 is established between UE 801 and UPF 805. The PDU session 810 may be a logical connection enabling the UE 801 to exchange data with a particular data network (for example, the Internet). The UE 801 may request establishment of the PDU session 810. At the time that the PDU session 810 is established, the UE 801 may, for example, identify the targeted data network based on its data network name (DNN). The PDU session 810 may be managed, for example, by a session management function (SMF, not shown). In order to facilitate exchange of data associated with the PDU session 810, between the UE 801 and the data network, the SMF may select the UPF 805 (and optionally, one or more other UPFs, not shown).

One or more applications associated with UE 801 may generate uplink packets 812A-812E associated with the PDU session 810. In order to work within the QoS model, UE 801 may apply QoS rules 814 to uplink packets 812A-812E. The QoS rules 814 may be associated with PDU session 810 and may be determined and/or provided to the UE 801 when PDU session 810 is established and/or modified. Based on QoS rules 814, UE 801 may classify uplink packets 812A-812E, map each of the uplink packets 812A-812E to a QoS flow, and/or mark uplink packets 812A-812E with a QoS flow indicator (QFI). As a packet travels through the network, and potentially mixes with other packets from other UEs having potentially different priorities, the QFI indicates how the packet should be handled in accordance with the QoS model. In the present illustration, uplink packets 812A, 812B are mapped to QoS flow 816A, uplink packet 812C is mapped to QoS flow 816B, and the remaining packets are mapped to QoS flow 816C.

The QoS flows may be the finest granularity of QoS differentiation in a PDU session. In the figure, three QoS flows 816A-816C are illustrated. However, it will be understood that there may be any number of QoS flows. Some QoS flows may be associated with a guaranteed bit rate (GBR QoS flows) and others may have bit rates that are not guaranteed (non-GBR QoS flows). QoS flows may also be subject to per-UE and per-session aggregate bit rates. One of the QoS flows may be a default QoS flow. The QoS flows may have different priorities. For example, QoS flow 816A may have a higher priority than QoS flow 816B, which may have a higher priority than QoS flow 816C. Different priorities may be reflected by different QoS flow characteristics. For example, QoS flows may be associated with flow bit rates. A particular QoS flow may be associated with a guaranteed flow bit rate (GFBR) and/or a maximum flow bit rate (MFBR). QoS flows may be associated with specific packet delay budgets (PDBs), packet error rates (PERs), and/or maximum packet loss rates. QoS flows may also be subject to per-UE and per-session aggregate bit rates.

In order to work within the QoS model, UE 801 may apply resource mapping rules 818 to the QoS flows 816A-816C. The air interface between UE 801 and AN 802 may be associated with resources 820. In the present illustration, QoS flow 816A is mapped to resource 820A, whereas QoS flows 816B, 816C are mapped to resource 820B. The resource mapping rules 818 may be provided by the AN 802. In order to meet QoS requirements, the resource mapping rules 818 may designate more resources for relatively high-priority QoS flows. With more resources, a high-priority QoS flow such as QoS flow 816A may be more likely to obtain the high flow bit rate, low packet delay budget, or other characteristic associated with QoS rules 814. The resources 820 may comprise, for example, radio bearers. The radio bearers (e.g., data radio bearers) may be established between the UE 801 and the AN 802. The radio bearers in 5G, between the UE 801 and the AN 802, may be distinct from bearers in LTE, for example, Evolved Packet System (EPS) bearers between a UE and a packet data network gateway (PGW), S1 bearers between an eNB and a serving gateway (SGW), and/or an S5/S8 bearer between an SGW and a PGW.

Once a packet associated with a particular QoS flow is received at AN 802 via resource 820A or resource 820B, AN 802 may separate packets into respective QoS flows 856A-856C based on QoS profiles 828. The QoS profiles 828 may be received from an SMF. Each QoS profile may correspond to a QFI, for example, the QFI marked on the uplink packets 812A-812E. Each QoS profile may include QoS parameters such as 5G QoS identifier (5QI) and an allocation and retention priority (ARP). The QoS profile for non-GBR QoS flows may further include additional QoS parameters such as a reflective QoS attribute (RQA). The QoS profile for GBR QoS flows may further include additional QoS parameters such as a guaranteed flow bit rate (GFBR), a maximum flow bit rate (MFBR), and/or a maximum packet loss rate. The 5QI may be a standardized 5QI which have one-to-one mapping to a standardized combination of 5G QoS characteristics per well-known services. The 5QI may be a dynamically assigned 5QI which the standardized 5QI values are not defined. The 5QI may represent 5G QoS characteristics. The 5QI may comprise a resource type, a default priority level, a packet delay budget (PDB), a packet error rate (PER), a maximum data burst volume, and/or an averaging window. The resource type may indicate a non-GBR QoS flow, a GBR QoS flow or a delay-critical GBR QoS flow. The averaging window may represent a duration over which the GFBR and/or MFBR is calculated. ARP may be a priority level comprising pre-emption capability and a pre-emption vulnerability. Based on the ARP, the AN 802 may apply admission control for the QoS flows in a case of resource limitations.

The AN 802 may select one or more N3 tunnels 850 for transmission of the QoS flows 856A-856C. After the packets are divided into QoS flows 856A-856C, the packet may be sent to UPF 805 (e.g., towards a DN) via the selected one or more N3 tunnels 850. The UPF 805 may verify that the QFIs of the uplink packets 812A-812E are aligned with the QoS rules 814 provided to the UE 801. The UPF 805 may measure and/or count packets and/or provide packet metrics to, for example, a PCF.

The figure also illustrates a process for downlink. In particular, one or more applications may generate downlink packets 852A-852E. The UPF 805 may receive downlink packets 852A-852E from one or more DNs and/or one or more other UPFs. As per the QoS model, UPF 805 may apply packet detection rules (PDRs) 854 to downlink packets 852A-852E. Based on PDRs 854, UPF 805 may map packets 852A-852E into QoS flows. In the present illustration, downlink packets 852A, 852B are mapped to QoS flow 856A, downlink packet 852C is mapped to QoS flow 856B, and the remaining packets are mapped to QoS flow 856C.

The QoS flows 856A-856C may be sent to AN 802. The AN 802 may apply resource mapping rules to the QoS flows 856A-856C. In the present illustration, QoS flow 856A is mapped to resource 820A, whereas QoS flows 856B, 856C are mapped to resource 820B. In order to meet QoS requirements, the resource mapping rules may designate more resources to high-priority QoS flows.

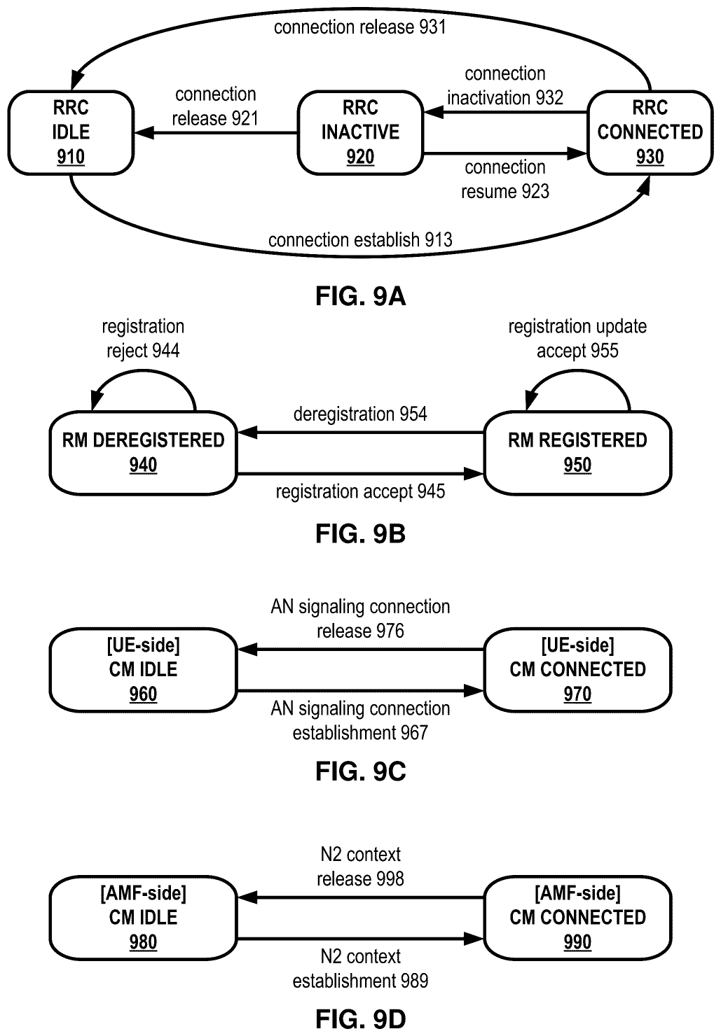

FIGS. 9A-9D illustrate example states and state transitions of a wireless device (e.g., a UE). At any given time, the wireless device may have a radio resource control (RRC) state, a registration management (RM) state, and a connection management (CM) state.

FIG. 9A is an example diagram showing RRC state transitions of a wireless device (e.g., a UE). The UE may be in one of three RRC states: RRC idle 910, (e.g., RRC_IDLE), RRC inactive 920 (e.g., RRC_INACTIVE), or RRC connected 930 (e.g., RRC_CONNECTED). The UE may implement different RAN-related control-plane procedures depending on its RRC state. Other elements of the network, for example, a base station, may track the RRC state of one or more UEs and implement RAN-related control-plane procedures appropriate to the RRC state of each.

In RRC connected 930, it may be possible for the UE to exchange data with the network (for example, the base station). The parameters necessary for exchange of data may be established and known to both the UE and the network. The parameters may be referred to and/or included in an RRC context of the UE (sometimes referred to as a UE context). These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. The base station with which the UE is connected may store the RRC context of the UE.

While in RRC connected 930, mobility of the UE may be managed by the access network, whereas the UE itself may manage mobility while in RRC idle 910 and/or RRC inactive 920. While in RRC connected 930, the UE may manage mobility by measuring signal levels (e.g., reference signal levels) from a serving cell and neighboring cells and reporting these measurements to the base station currently serving the UE. The network may initiate handover based on the reported measurements. The RRC state may transition from RRC connected 930 to RRC idle 910 through a connection release procedure 930 or to RRC inactive 920 through a connection inactivation procedure 932.

In RRC idle 910, an RRC context may not be established for the UE. In RRC idle 910, the UE may not have an RRC connection with a base station. While in RRC idle 910, the UE may be in a sleep state for a majority of the time (e.g., to conserve battery power). The UE may wake up periodically (e.g., once in every discontinuous reception cycle) to monitor for paging messages from the access network. Mobility of the UE may be managed by the UE through a procedure known as cell reselection. The RRC state may transition from RRC idle 910 to RRC connected 930 through a connection establishment procedure 913, which may involve a random access procedure, as discussed in greater detail below.

In RRC inactive 920, the RRC context previously established is maintained in the UE and the base station. This may allow for a fast transition to RRC connected 930 with reduced signaling overhead as compared to the transition from RRC idle 910 to RRC connected 930. The RRC state may transition to RRC connected 930 through a connection resume procedure 923. The RRC state may transition to RRC idle 910 though a connection release procedure 921 that may be the same as or similar to connection release procedure 931.

An RRC state may be associated with a mobility management mechanism. In RRC idle 910 and RRC inactive 920, mobility may be managed by the UE through cell reselection. The purpose of mobility management in RRC idle 910 and/or RRC inactive 920 is to allow the network to be able to notify the UE of an event via a paging message without having to broadcast the paging message over the entire mobile communications network. The mobility management mechanism used in RRC idle 910 and/or RRC inactive 920 may allow the network to track the UE on a cell-group level so that the paging message may be broadcast over the cells of the cell group that the UE currently resides within instead of the entire communication network. Tracking may be based on different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 920 state, the UE may be assigned a RAN notification area. A RAN notification area may comprise one or more cell identities, a list of RAIs, and/or a list of TAIs. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 920.

FIG. 9B is an example diagram showing registration management (RM) state transitions of a wireless device (e.g., a UE). The states are RM deregistered 940, (e.g., RM-DEREGISTERED) and RM registered 950 (e.g., RM-REGISTERED).

In RM deregistered 940, the UE is not registered with the network, and the UE is not reachable by the network. In order to be reachable by the network, the UE must perform an initial registration. As an example, the UE may register with an AMF of the network. If registration is rejected (registration reject 944), then the UE remains in RM deregistered 940. If registration is accepted (registration accept 945), then the UE transitions to RM registered 950. While the UE is RM registered 950, the network may store, keep, and/or maintain a UE context for the UE. The UE context may be referred to as wireless device context. The UE context corresponding to network registration (maintained by the core network) may be different from the RRC context corresponding to RRC state (maintained by an access network, e.g., a base station). The UE context may comprise a UE identifier and a record of various information relating to the UE, for example, UE capability information, policy information for access and mobility management of the UE, lists of allowed or established slices or PDU sessions, and/or a registration area of the UE (i.e., a list of tracking areas covering the geographical area where the wireless device is likely to be found).

While the UE is RM registered 950, the network may store the UE context of the UE, and if necessary use the UE context to reach the UE. Moreover, some services may not be provided by the network unless the UE is registered. The UE may update its UE context while remaining in RM registered 950 (registration update accept 955). For example, if the UE leaves one tracking area and enters another tracking area, the UE may provide a tracking area identifier to the network. The network may deregister the UE, or the UE may deregister itself (deregistration 954). For example, the network may automatically deregister the wireless device if the wireless device is inactive for a certain amount of time. Upon deregistration, the UE may transition to RM deregistered 940.

FIG. 9C is an example diagram showing connection management (CM) state transitions of a wireless device (e.g., a UE), shown from a perspective of the wireless device. The UE may be in CM idle 960 (e.g., CM-IDLE) or CM connected 970 (e.g., CM-CONNECTED).

In CM idle 960, the UE does not have a non access stratum (NAS) signaling connection with the network. As a result, the UE can not communicate with core network functions. The UE may transition to CM connected 970 by establishing an AN signaling connection (AN signaling connection establishment 967). This transition may be initiated by sending an initial NAS message. The initial NAS message may be a registration request (e.g., if the UE is RM deregistered 940) or a service request (e.g., if the UE is RM registered 950). If the UE is RM registered 950, then the UE may initiate the AN signaling connection establishment by sending a service request, or the network may send a page, thereby triggering the UE to send the service request.

In CM connected 970, the UE can communicate with core network functions using NAS signaling. As an example, the UE may exchange NAS signaling with an AMF for registration management purposes, service request procedures, and/or authentication procedures. As another example, the UE may exchange NAS signaling, with an SMF, to establish and/or modify a PDU session. The network may disconnect the UE, or the UE may disconnect itself (AN signaling connection release 976). For example, if the UE transitions to RM deregistered 940, then the UE may also transition to CM idle 960. When the UE transitions to CM idle 960, the network may deactivate a user plane connection of a PDU session of the UE.

FIG. 9D is an example diagram showing CM state transitions of the wireless device (e.g., a UE), shown from a network perspective (e.g., an AMF). The CM state of the UE, as tracked by the AMF, may be in CM idle 980 (e.g., CM-IDLE) or CM connected 990 (e.g., CM-CONNECTED). When the UE transitions from CM idle 980 to CM connected 990, the AMF many establish an N2 context of the UE (N2 context establishment 989). When the UE transitions from CM connected 990 to CM idle 980, the AMF many release the N2 context of the UE (N2 context release 998).

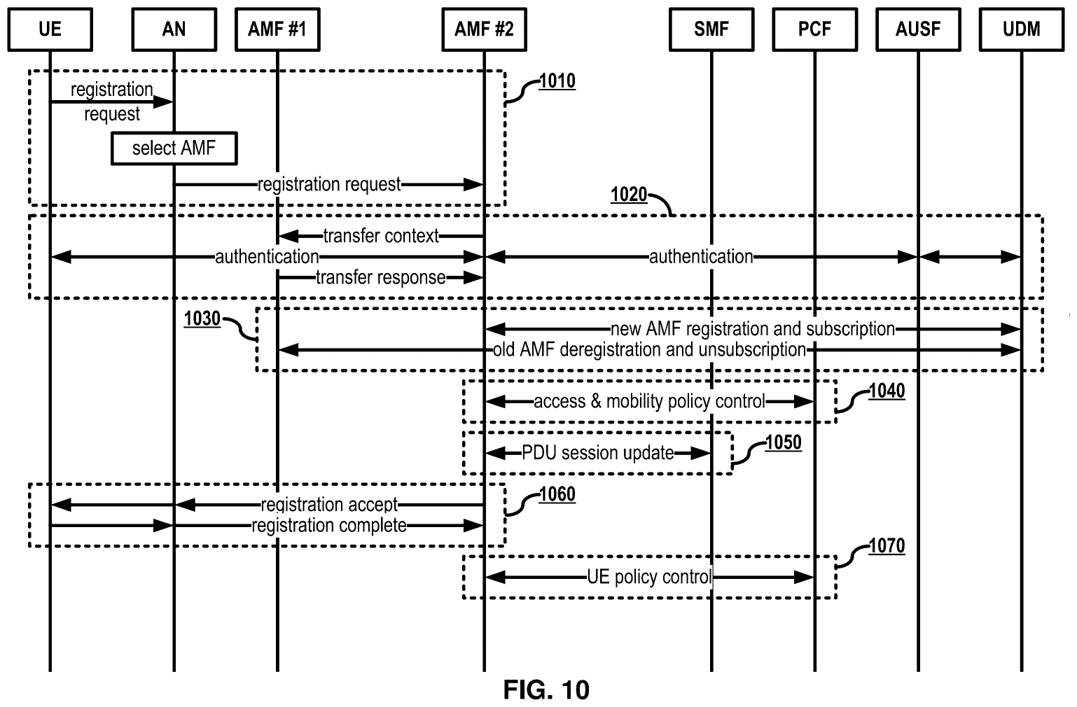

FIGS. 10-12 illustrate example procedures for registering, service request, and PDU session establishment of a UE.

FIG. 10 illustrates an example of a registration procedure for a wireless device (e.g., a UE). Based on the registration procedure, the UE may transition from, for example, RM deregistered 940 to RM registered 950.

Registration may be initiated by a UE for the purposes of obtaining authorization to receive services, enabling mobility tracking, enabling reachability, or other purposes. The UE may perform an initial registration as a first step toward connection to the network (for example, if the UE is powered on, airplane mode is turned off, etc.). Registration may also be performed periodically to keep the network informed of the UE's presence (for example, while in CM-IDLE state), or in response to a change in UE capability or registration area. Deregistration (not shown in FIG. 10) may be performed to stop network access.

At 1010, the UE transmits a registration request to an AN. As an example, the UE may have moved from a coverage area of a previous AMF (illustrated as AMF #1) into a coverage area of a new AMF (illustrated as AMF #2). The registration request may be a NAS message. The registration request may include a UE identifier. The AN may select an AMF for registration of the UE. For example, the AN may select a default AMF. For example, the AN may select an AMF that is already mapped to the UE (e.g., a previous AMF). The NAS registration request may include a network slice identifier and the AN may select an AMF based on the requested slice. After the AMF is selected, the AN may send the registration request to the selected AMF.

At 1020, the AMF that receives the registration request (AMF #2) performs a context transfer. The context may be a UE context, for example, an RRC context for the UE. As an example, AMF #2 may send AMF #1 a message requesting a context of the UE. The message may include the UE identifier. The message may be a Namf_Communication_UEContextTransfer message. AMF #1 may send to AMF #2 a message that includes the requested UE context. This message may be a Namf_Communication_UEContextTransfer message. After the UE context is received, the AMF #2 may coordinate authentication of the UE. After authentication is complete, AMF #2 may send to AMF #1 a message indicating that the UE context transfer is complete. This message may be a Namf_Communication_UEContextTransfer Response message.

Authentication may require participation of the UE, an AUSF, a UDM and/or a UDR (not shown). For example, the AMF may request that the AUSF authenticate the UE. For example, the AUSF may execute authentication of the UE. For example, the AUSF may get authentication data from UDM. For example, the AUSF may send a subscription permanent identifier (SUPI) to the AMF based on the authentication being successful. For example, the AUSF may provide an intermediate key to the AMF. The intermediate key may be used to derive an access-specific security key for the UE, enabling the AMF to perform security context management (SCM). The AUSF may obtain subscription data from the UDM. The subscription data may be based on information obtained from the UDM (and/or the UDR). The subscription data may include subscription identifiers, security credentials, access and mobility related subscription data and/or session related data.

At 1030, the new AMF, AMF #2, registers and/or subscribes with the UDM. AMF #2 may perform registration using a UE context management service of the UDM (Nudm_UECM). AMF #2 may obtain subscription information of the UE using a subscriber data management service of the UDM (Nudm_SDM). AMF #2 may further request that the UDM notify AMF #2 if the subscription information of the UE changes. As the new AMF registers and subscribes, the old AMF, AMF #1, may deregister and unsubscribe. After deregistration, AMF #1 is free of responsibility for mobility management of the UE.

At 1040, AMF #2 retrieves access and mobility (AM) policies from the PCF. As an example, the AMF #2 may provide subscription data of the UE to the PCF. The PCF may determine access and mobility policies for the UE based on the subscription data, network operator data, current network conditions, and/or other suitable information. For example, the owner of a first UE may purchase a higher level of service than the owner of a second UE. The PCF may provide the rules associated with the different levels of service. Based on the subscription data of the respective UEs, the network may apply different policies which facilitate different levels of service.

For example, access and mobility policies may relate to service area restrictions, RAT/frequency selection priority (RFSP, where RAT stands for radio access technology), authorization and prioritization of access type (e.g., LTE versus NR), and/or selection of non-3GPP access (e.g., Access Network Discovery and Selection Policy (ANDSP)). The service area restrictions may comprise a list of tracking areas where the UE is allowed to be served (or forbidden from being served). The access and mobility policies may include a UE route selection policy (URSP)) that influences routing to an established PDU session or a new PDU session. As noted above, different policies may be obtained and/or enforced based on subscription data of the UE, location of the UE (i.e., location of the AN and/or AMF), or other suitable factors.

At 1050, AMF #2 may update a context of a PDU session. For example, if the UE has an existing PDU session, the AMF #2 may coordinate with an SMF to activate a user plane connection associated with the existing PDU session. The SMF may update and/or release a session management context of the PDU session (Nsmf_PDUSession_UpdateSMContext, Nsmf_PDUSession_ReleaseSMContext).

At 1060, AMF #2 sends a registration accept message to the AN, which forwards the registration accept message to the UE. The registration accept message may include a new UE identifier and/or a new configured slice identifier. The UE may transmit a registration complete message to the AN, which forwards the registration complete message to the AMF #2. The registration complete message may acknowledge receipt of the new UE identifier and/or new configured slice identifier.

At 1070, AMF #2 may obtain UE policy control information from the PCF. The PCF may provide an access network discovery and selection policy (ANDSP) to facilitate non-3GPP access. The PCF may provide a UE route selection policy (URSP) to facilitate mapping of particular data traffic to particular PDU session connectivity parameters. As an example, the URSP may indicate that data traffic associated with a particular application should be mapped to a particular SSC mode, network slice, PDU session type, or preferred access type (3GPP or non-3GPP).

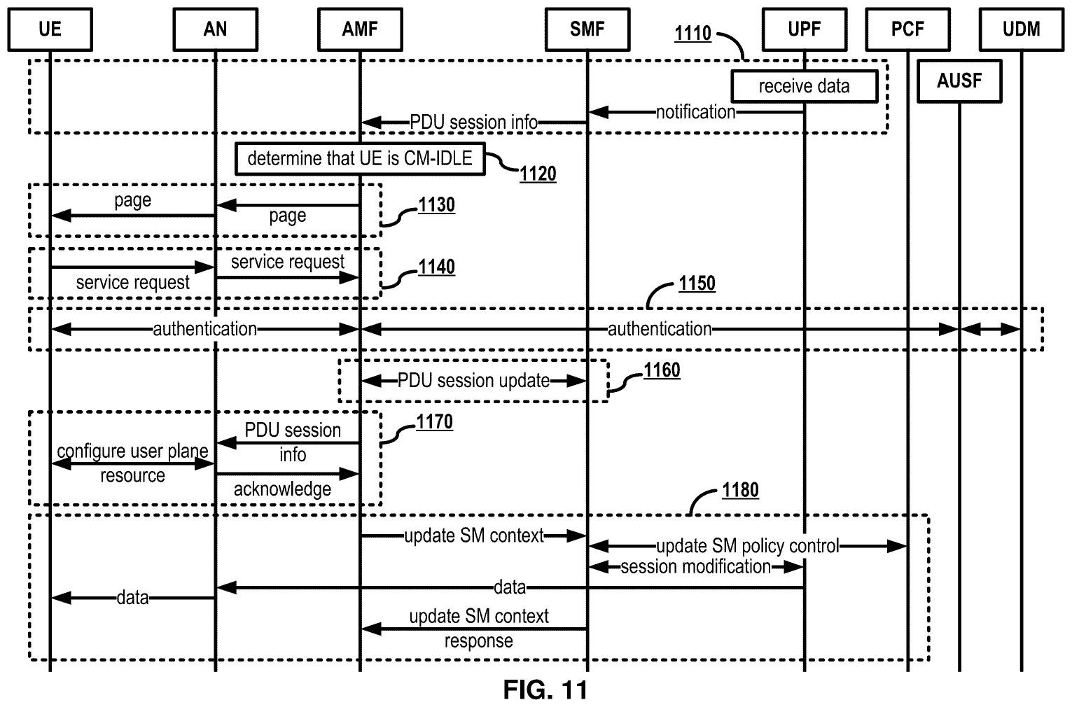

FIG. 11 illustrates an example of a service request procedure for a wireless device (e.g., a UE). The service request procedure depicted in FIG. 11 is a network-triggered service request procedure for a UE in a CM-IDLE state. However, other service request procedures (e.g., a UE-triggered service request procedure) may also be understood by reference to FIG. 11, as will be discussed in greater detail below.

At 1110, a UPF receives data. The data may be downlink data for transmission to a UE. The data may be associated with an existing PDU session between the UE and a DN. The data may be received, for example, from a DN and/or another UPF. The UPF may buffer the received data. In response to the receiving of the data, the UPF may notify an SMF of the received data. The identity of the SMF to be notified may be determined based on the received data. The notification may be, for example, an N4 session report. The notification may indicate that the UPF has received data associated with the UE and/or a particular PDU session associated with the UE. In response to receiving the notification, the SMF may send PDU session information to an AMF. The PDU session information may be sent in an N1N2 message transfer for forwarding to an AN. The PDU session information may include, for example, UPF tunnel endpoint information and/or QoS information.

At 1120, the AMF determines that the UE is in a CM-IDLE state. The determining at 1120 may be in response to the receiving of the PDU session information. Based on the determination that the UE is CM-IDLE, the service request procedure may proceed to 1130 and 1140, as depicted in FIG. 11. However, if the UE is not CM-IDLE (e.g., the UE is CM-CONNECTED), then 1130 and 1140 may be skipped, and the service request procedure may proceed directly to 1150.

At 1130, the AMF pages the UE. The paging at 1130 may be performed based on the UE being CM-IDLE. To perform the paging, the AMF may send a page to the AN. The page may be referred to as a paging or a paging message. The page may be an N2 request message. The AN may be one of a plurality of ANs in a RAN notification area of the UE. The AN may send a page to the UE. The UE may be in a coverage area of the AN and may receive the page.

At 1140, the UE may request service. The UE may transmit a service request to the AMF via the AN. As depicted in FIG. 11, the UE may request service at 1140 in response to receiving the paging at 1130. However, as noted above, this is for the specific case of a network-triggered service request procedure. In some scenarios (for example, if uplink data becomes available at the UE), then the UE may commence a UE-triggered service request procedure. The UE-triggered service request procedure may commence starting at 1140.

At 1150, the network may authenticate the UE. Authentication may require participation of the UE, an AUSF, and/or a UDM, for example, similar to authentication described elsewhere in the present disclosure. In some cases (for example, if the UE has recently been authenticated), the authentication at 1150 may be skipped.

At 1160, the AMF and SMF may perform a PDU session update. As part of the PDU session update, the SMF may provide the AMF with one or more UPF tunnel endpoint identifiers. In some cases (not shown in FIG. 11), it may be necessary for the SMF to coordinate with one or more other SMFs and/or one or more other UPFs to set up a user plane.

At 1170, the AMF may send PDU session information to the AN. The PDU session information may be included in an N2 request message. Based on the PDU session information, the AN may configure a user plane resource for the UE. To configure the user plane resource, the AN may, for example, perform an RRC reconfiguration of the UE. The AN may acknowledge to the AMF that the PDU session information has been received. The AN may notify the AMF that the user plane resource has been configured, and/or provide information relating to the user plane resource configuration.

In the case of a UE-triggered service request procedure, the UE may receive, at 1170, a NAS service accept message from the AMF via the AN. After the user plane resource is configured, the UE may transmit uplink data (for example, the uplink data that caused the UE to trigger the service request procedure).

At 1180, the AMF may update a session management (SM) context of the PDU session. For example, the AMF may notify the SMF (and/or one or more other associated SMFs) that the user plane resource has been configured, and/or provide information relating to the user plane resource configuration. The AMF may provide the SMF (and/or one or more other associated SMFs) with one or more AN tunnel endpoint identifiers of the AN. After the SM context update is complete, the SMF may send an update SM context response message to the AMF.

Based on the update of the session management context, the SMF may update a PCF for purposes of policy control. For example, if a location of the UE has changed, the SMF may notify the PCF of the UE's a new location.

Based on the update of the session management context, the SMF and UPF may perform a session modification. The session modification may be performed using N4 session modification messages. After the session modification is complete, the UPF may transmit downlink data (for example, the downlink data that caused the UPF to trigger the network-triggered service request procedure) to the UE. The transmitting of the downlink data may be based on the one or more AN tunnel endpoint identifiers of the AN.

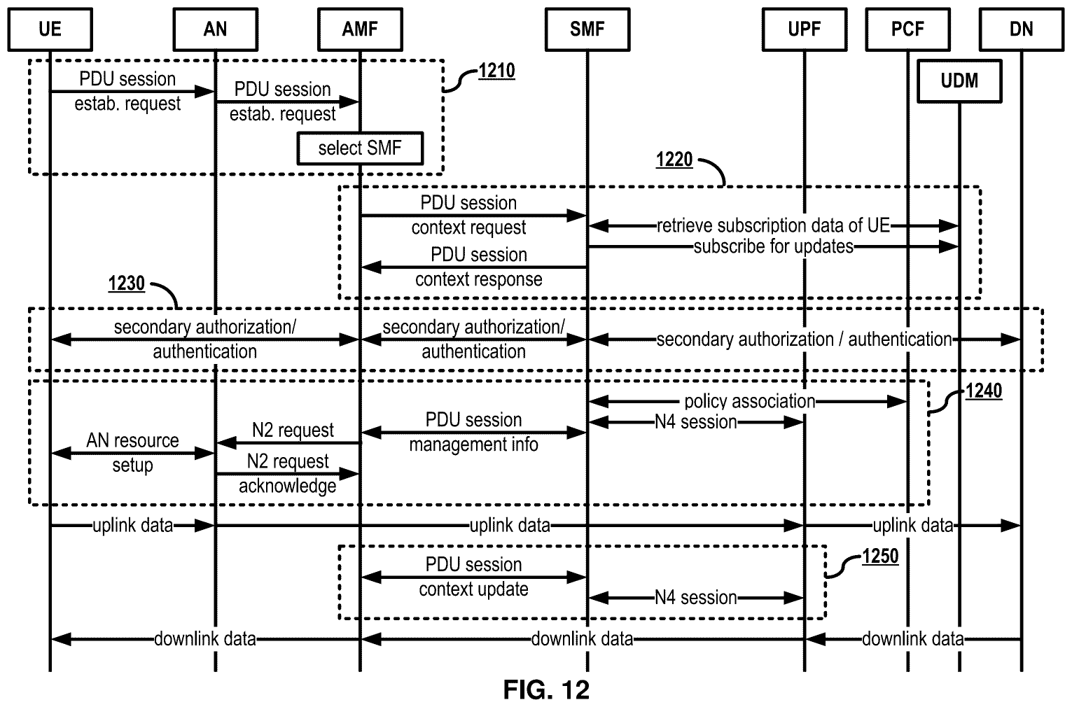

FIG. 12 illustrates an example of a protocol data unit (PDU) session establishment procedure for a wireless device (e.g., a UE). The UE may determine to transmit the PDU session establishment request to create a new PDU session, to hand over an existing PDU session to a 3GPP network, or for any other suitable reason.

At 1210, the UE initiates PDU session establishment. The UE may transmit a PDU session establishment request to an AMF via an AN. The PDU session establishment request may be a NAS message. The PDU session establishment request may indicate: a PDU session ID; a requested PDU session type (new or existing); a requested DN (DNN); a requested network slice (S-NSSAI); a requested SSC mode; and/or any other suitable information. The PDU session ID may be generated by the UE. The PDU session type may be, for example, an Internet Protocol (IP)-based type (e.g., IPv4, IPv6, or dual stack IPv4/IPv6), an Ethernet type, or an unstructured type.

The AMF may select an SMF based on the PDU session establishment request. In some scenarios, the requested PDU session may already be associated with a particular SMF. For example, the AMF may store a UE context of the UE, and the UE context may indicate that the PDU session ID of the requested PDU session is already associated with the particular SMF. In some scenarios, the AMF may select the SMF based on a determination that the SMF is prepared to handle the requested PDU session. For example, the requested PDU session may be associated with a particular DNN and/or S-NSSAI, and the SMF may be selected based on a determination that the SMF can manage a PDU session associated with the particular DNN and/or S-NSSAI.

At 1220, the network manages a context of the PDU session. After selecting the SMF at 1210, the AMF sends a PDU session context request to the SMF. The PDU session context request may include the PDU session establishment request received from the UE at 1210. The PDU session context request may be a Nsmf_PDUSession_CreateSMContext Request and/or a Nsmf_PDUSession_UpdateSMContext Request. The PDU session context request may indicate identifiers of the UE; the requested DN; and/or the requested network slice. Based on the PDU session context request, the SMF may retrieve subscription data from a UDM. The subscription data may be session management subscription data of the UE. The SMF may subscribe for updates to the subscription data, so that the PCF will send new information if the subscription data of the UE changes. After the subscription data of the UE is obtained, the SMF may transmit a PDU session context response to the AMG. The PDU session context response may be a Nsmf_PDUSession_CreateSMContext Response and/or a Nsmf_PDUSession_UpdateSMContext Response. The PDU session context response may include a session management context ID.

At 1230, secondary authorization/authentication may be performed, if necessary. The secondary authorization/authentication may involve the UE, the AMF, the SMF, and the DN. The SMF may access the DN via a Data Network Authentication, Authorization and Accounting (DN AAA) server.

At 1240, the network sets up a data path for uplink data associated with the PDU session. The SMF may select a PCF and establish a session management policy association. Based on the association, the PCF may provide an initial set of policy control and charging rules (PCC rules) for the PDU session. When targeting a particular PDU session, the PCF may indicate, to the SMF, a method for allocating an IP address to the PDU Session, a default charging method for the PDU session, an address of the corresponding charging entity, triggers for requesting new policies, etc. The PCF may also target a service data flow (SDF) comprising one or more PDU sessions. When targeting an SDF, the PCF may indicate, to the SMF, policies for applying QoS requirements, monitoring traffic (e.g., for charging purposes), and/or steering traffic (e.g., by using one or more particular N6 interfaces).

The SMF may determine and/or allocate an IP address for the PDU session. The SMF may select one or more UPFs (a single UPF in the example of FIG. 12) to handle the PDU session. The SMF may send an N4 session message to the selected UPF. The N4 session message may be an N4 Session Establishment Request and/or an N4 Session Modification Request. The N4 session message may include packet detection, enforcement, and reporting rules associated with the PDU session. In response, the UPF may acknowledge by sending an N4 session establishment response and/or an N4 session modification response.

The SMF may send PDU session management information to the AMF. The PDU session management information may be a Namf_Communication_N1N2MessageTransfer message. The PDU session management information may include the PDU session ID. The PDU session management information may be a NAS message. The PDU session management information may include N1 session management information and/or N2 session management information. The N1 session management information may include a PDU session establishment accept message. The PDU session establishment accept message may include tunneling endpoint information of the UPF and quality of service (QoS) information associated with the PDU session.

The AMF may send an N2 request to the AN. The N2 request may include the PDU session establishment accept message. Based on the N2 request, the AN may determine AN resources for the UE. The AN resources may be used by the UE to establish the PDU session, via the AN, with the DN. The AN may determine resources to be used for the PDU session and indicate the determined resources to the UE. The AN may send the PDU session establishment accept message to the UE. For example, the AN may perform an RRC reconfiguration of the UE. After the AN resources are set up, the AN may send an N2 request acknowledge to the AMF. The N2 request acknowledge may include N2 session management information, for example, the PDU session ID and tunneling endpoint information of the AN.

After the data path for uplink data is set up at 1240, the UE may optionally send uplink data associated with the PDU session. As shown in FIG. 12, the uplink data may be sent to a DN associated with the PDU session via the AN and the UPF.

At 1250, the network may update the PDU session context. The AMF may transmit a PDU session context update request to the SMF. The PDU session context update request may be a Nsmf_PDUSession_UpdateSMContext Request. The PDU session context update request may include the N2 session management information received from the AN. The SMF may acknowledge the PDU session context update. The acknowledgement may be a Nsmf_PDUSession_UpdateSMContext Response. The acknowledgement may include a subscription requesting that the SMF be notified of any UE mobility event. Based on the PDU session context update request, the SMF may send an N4 session message to the UPF. The N4 session message may be an N4 Session Modification Request. The N4 session message may include tunneling endpoint information of the AN. The N4 session message may include forwarding rules associated with the PDU session. In response, the UPF may acknowledge by sending an N4 session modification response.

After the UPF receives the tunneling endpoint information of the AN, the UPF may relay downlink data associated with the PDU session. As shown in FIG. 12, the downlink data may be received from a DN associated with the PDU session via the AN and the UPF.

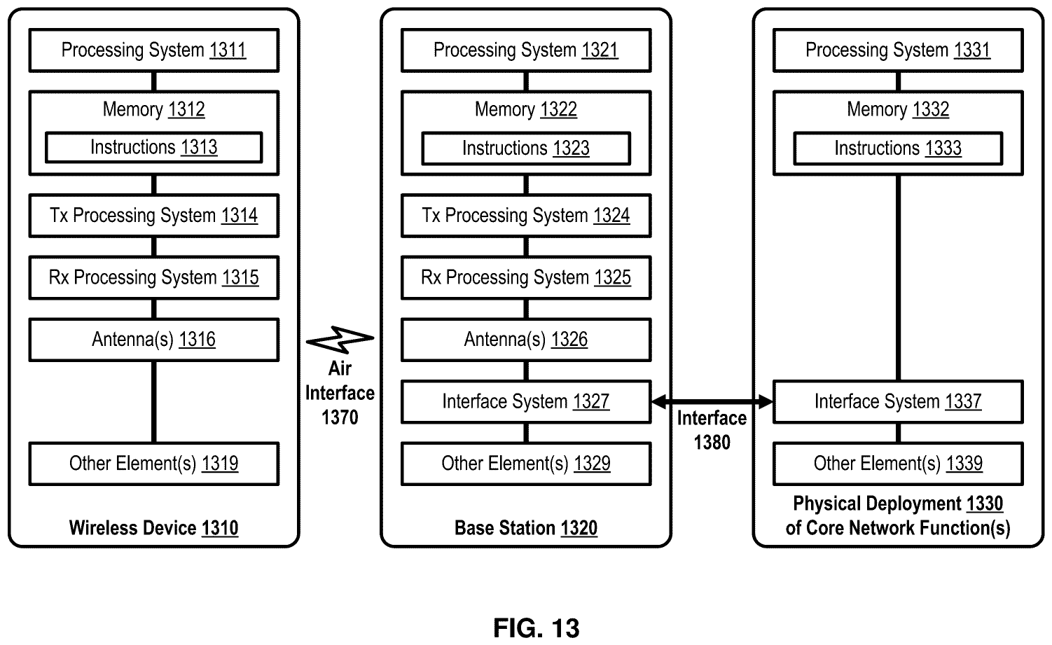

FIG. 13 illustrates examples of components of the elements in a communications network. FIG. 13 includes a wireless device 1310, a base station 1320, and a physical deployment of one or more network functions 1330 (henceforth “deployment 1330”). Any wireless device described in the present disclosure may have similar components and may be implemented in a similar manner as the wireless device 1310. Any other base station described in the present disclosure (or any portion thereof, depending on the architecture of the base station) may have similar components and may be implemented in a similar manner as the base station 1320. Any physical core network deployment in the present disclosure (or any portion thereof, depending on the architecture of the base station) may have similar components and may be implemented in a similar manner as the deployment 1330.

The wireless device 1310 may communicate with base station 1320 over an air interface 1370. The communication direction from wireless device 1310 to base station 1320 over air interface 1370 is known as uplink, and the communication direction from base station 1320 to wireless device 1310 over air interface 1370 is known as downlink. Downlink transmissions may be separated from uplink transmissions using FDD, TDD, and/or some combination of duplexing techniques. FIG. 13 shows a single wireless device 1310 and a single base station 1320, but it will be understood that wireless device 1310 may communicate with any number of base stations or other access network components over air interface 1370, and that base station 1320 may communicate with any number of wireless devices over air interface 1370.

The wireless device 1310 may comprise a processing system 1311 and a memory 1312. The memory 1312 may comprise one or more computer-readable media, for example, one or more non-transitory computer readable media. The memory 1312 may include instructions 1313. The processing system 1311 may process and/or execute instructions 1313. Processing and/or execution of instructions 1313 may cause wireless device 1310 and/or processing system 1311 to perform one or more functions or activities. The memory 1312 may include data (not shown). One of the functions or activities performed by processing system 1311 may be to store data in memory 1312 and/or retrieve previously-stored data from memory 1312. In an example, downlink data received from base station 1320 may be stored in memory 1312, and uplink data for transmission to base station 1320 may be retrieved from memory 1312. As illustrated in FIG. 13, the wireless device 1310 may communicate with base station 1320 using a transmission processing system 1314 and/or a reception processing system 1315. Alternatively, transmission processing system 1314 and reception processing system 1315 may be implemented as a single processing system, or both may be omitted and all processing in the wireless device 1310 may be performed by the processing system 1311. Although not shown in FIG. 13, transmission processing system 1314 and/or reception processing system 1315 may be coupled to a dedicated memory that is analogous to but separate from memory 1312, and comprises instructions that may be processed and/or executed to carry out one or more of their respective functionalities. The wireless device 1310 may comprise one or more antennas 1316 to access air interface 1370.

The wireless device 1310 may comprise one or more other elements 1319. The one or more other elements 1319 may comprise software and/or hardware that provide features and/or functionalities, for example, a speaker, a microphone, a keypad, a display, a touchpad, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, a global positioning sensor (GPS) and/or the like). The wireless device 1310 may receive user input data from and/or provide user output data to the one or more one or more other elements 1319. The one or more other elements 1319 may comprise a power source. The wireless device 1310 may receive power from the power source and may be configured to distribute the power to the other components in wireless device 1310. The power source may comprise one or more sources of power, for example, a battery, a solar cell, a fuel cell, or any combination thereof.

The wireless device 1310 may transmit uplink data to and/or receive downlink data from base station 1320 via air interface 1370. To perform the transmission and/or reception, one or more of the processing system 1311, transmission processing system 1314, and/or reception system 1315 may implement open systems interconnection (OSI) functionality. As an example, transmission processing system 1314 and/or reception system 1315 may perform layer 1 OSI functionality, and processing system 1311 may perform higher layer functionality. The wireless device 1310 may transmit and/or receive data over air interface 1370 using one or more antennas 1316. For scenarios where the one or more antennas 1316 include multiple antennas, the multiple antennas may be used to perform one or more multi-antenna techniques, such as spatial multiplexing (e.g., single-user multiple-input multiple output (MIMO) or multi-user MIMO), transmit/receive diversity, and/or beamforming.

The base station 1320 may comprise a processing system 1321 and a memory 1322. The memory 1322 may comprise one or more computer-readable media, for example, one or more non-transitory computer readable media. The memory 1322 may include instructions 1323. The processing system 1321 may process and/or execute instructions 1323. Processing and/or execution of instructions 1323 may cause base station 1320 and/or processing system 1321 to perform one or more functions or activities. The memory 1322 may include data (not shown). One of the functions or activities performed by processing system 1321 may be to store data in memory 1322 and/or retrieve previously-stored data from memory 1322. The base station 1320 may communicate with wireless device 1310 using a transmission processing system 1324 and a reception processing system 1325. Although not shown in FIG. 13, transmission processing system 1324 and/or reception processing system 1325 may be coupled to a dedicated memory that is analogous to but separate from memory 1322, and comprises instructions that may be processed and/or executed to carry out one or more of their respective functionalities. The wireless device 1320 may comprise one or more antennas 1326 to access air interface 1370.

The base station 1320 may transmit downlink data to and/or receive uplink data from wireless device 1310 via air interface 1370. To perform the transmission and/or reception, one or more of the processing system 1321, transmission processing system 1324, and/or reception system 1325 may implement OSI functionality. As an example, transmission processing system 1324 and/or reception system 1325 may perform layer 1 OSI functionality, and processing system 1321 may perform higher layer functionality. The base station 1320 may transmit and/or receive data over air interface 1370 using one or more antennas 1326. For scenarios where the one or more antennas 1326 include multiple antennas, the multiple antennas may be used to perform one or more multi-antenna techniques, such as spatial multiplexing (e.g., single-user multiple-input multiple output (MIMO) or multi-user MIMO), transmit/receive diversity, and/or beamforming.

The base station 1320 may comprise an interface system 1327. The interface system 1327 may communicate with one or more base stations and/or one or more elements of the core network via an interface 1380. The interface 1380 may be wired and/or wireless and interface system 1327 may include one or more components suitable for communicating via interface 1380. In FIG. 13, interface 1380 connects base station 1320 to a single deployment 1330, but it will be understood that wireless device 1310 may communicate with any number of base stations and/or CN deployments over interface 1380, and that deployment 1330 may communicate with any number of base stations and/or other CN deployments over interface 1380. The base station 1320 may comprise one or more other elements 1329 analogous to one or more of the one or more other elements 1319.

The deployment 1330 may comprise any number of portions of any number of instances of one or more network functions (NFs). The deployment 1330 may comprise a processing system 1331 and a memory 1332. The memory 1332 may comprise one or more computer-readable media, for example, one or more non-transitory computer readable media. The memory 1332 may include instructions 1333. The processing system 1331 may process and/or execute instructions 1333. Processing and/or execution of instructions 1333 may cause the deployment 1330 and/or processing system 1331 to perform one or more functions or activities. The memory 1332 may include data (not shown). One of the functions or activities performed by processing system 1331 may be to store data in memory 1332 and/or retrieve previously-stored data from memory 1332. The deployment 1330 may access the interface 1380 using an interface system 1337. The deployment 1330 may comprise one or more other elements 1339 analogous to one or more of the one or more other elements 1319.

One or more of the systems 1311, 1314, 1315, 1321, 1324, 1325, and/or 1331 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. One or more of the systems 1311, 1314, 1315, 1321, 1324, 1325, and/or 1331 may perform signal coding/processing, data processing, power control, input/output processing, and/or any other functionality that may enable wireless device 1310, base station 1320, and/or deployment 1330 to operate in a mobile communications system.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise computers, microcontrollers, microprocessors, DSPs, ASICs, FPGAs, and complex programmable logic devices (CPLDs). Computers, microcontrollers and microprocessors may be programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

The wireless device 1310, base station 1320, and/or deployment 1330 may implement timers and/or counters. A timer/counter may start at an initial value. As used herein, starting may comprise restarting. Once started, the timer/counter may run. Running of the timer/counter may be associated with an occurrence. When the occurrence occurs, the value of the timer/counter may change (for example, increment or decrement). The occurrence may be, for example, an exogenous event (for example, a reception of a signal, a measurement of a condition, etc.), an endogenous event (for example, a transmission of a signal, a calculation, a comparison, a performance of an action or a decision to so perform, etc.), or any combination thereof. In the case of a timer, the occurrence may be the passage of a particular amount of time. However, it will be understood that a timer may be described and/or implemented as a counter that counts the passage of a particular unit of time. A timer/counter may run in a direction of a final value until it reaches the final value. The reaching of the final value may be referred to as expiration of the timer/counter. The final value may be referred to as a threshold. A timer/counter may be paused, wherein the present value of the timer/counter is held, maintained, and/or carried over, even upon the occurrence of one or more occurrences that would otherwise cause the value of the timer/counter to change. The timer/counter may be un-paused or continued, wherein the value that was held, maintained, and/or carried over begins changing again when the one or more occurrence occur. A timer/counter may be set and/or reset. As used herein, setting may comprise resetting. When the timer/counter sets and/or resets, the value of the timer/counter may be set to the initial value. A timer/counter may be started and/or restarted. As used herein, starting may comprise restarting. In some embodiments, when the timer/counter restarts, the value of the timer/counter may be set to the initial value and the timer/counter may begin to run.

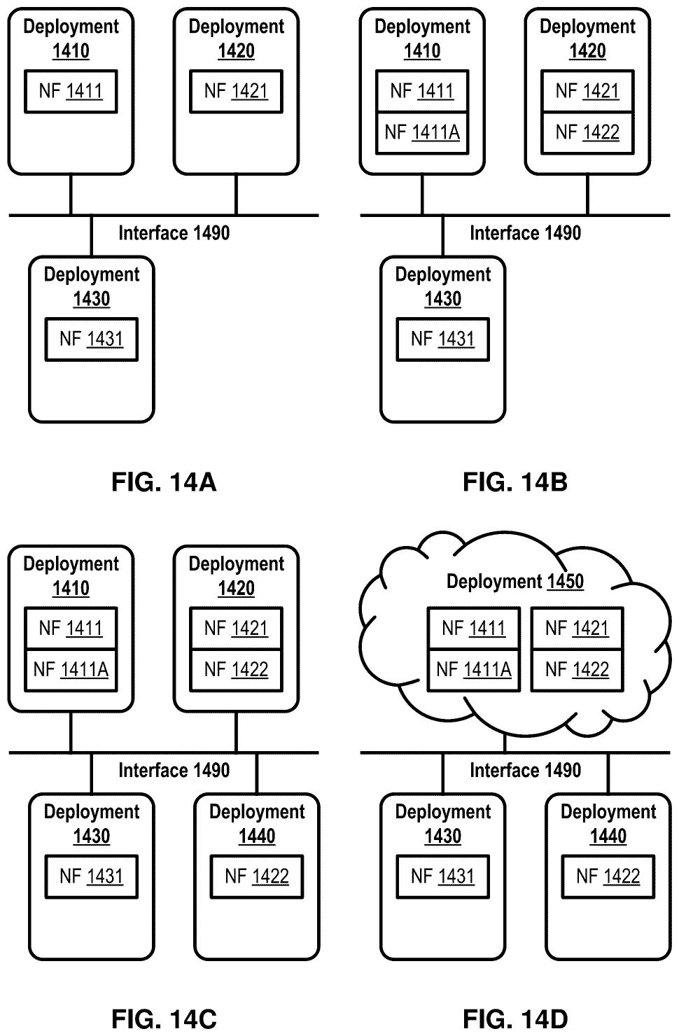

FIGS. 14A, 14B, 14C, and 14D illustrate various example arrangements of physical core network deployments, each having one or more network functions or portions thereof. The core network deployments comprise a deployment 1410, a deployment 1420, a deployment 1430, a deployment 1440, and/or a deployment 1450. Each deployment may be analogous to, for example, the deployment 1330 depicted in FIG. 13. In particular, each deployment may comprise a processing system for performing one or more functions or activities, memory for storing data and/or instructions, and an interface system for communicating with other network elements (for example, other core network deployments). Each deployment may comprise one or more network functions (NFs). The term NF may refer to a particular set of functionalities and/or one or more physical elements configured to perform those functionalities (e.g., a processing system and memory comprising instructions that, when executed by the processing system, cause the processing system to perform the functionalities). For example, in the present disclosure, when a network function is described as performing X, Y, and Z, it will be understood that this refers to the one or more physical elements configured to perform X, Y, and Z, no matter how or where the one or more physical elements are deployed. The term NF may refer to a network node, network element, and/or network device.

As will be discussed in greater detail below, there are many different types of NF and each type of NF may be associated with a different set of functionalities. A plurality of different NFs may be flexibly deployed at different locations (for example, in different physical core network deployments) or in a same location (for example, co-located in a same deployment). A single NF may be flexibly deployed at different locations (implemented using different physical core network deployments) or in a same location. Moreover, physical core network deployments may also implement one or more base stations, application functions (AFs), data networks (DNs), or any portions thereof. NFs may be implemented in many ways, including as network elements on dedicated or shared hardware, as software instances running on dedicated or shared hardware, or as virtualized functions instantiated on a platform (e.g., a cloud-based platform).

FIG. 14A illustrates an example arrangement of core network deployments in which each deployment comprises one network function. A deployment 1410 comprises an NF 1411, a deployment 1420 comprises an NF 1421, and a deployment 1430 comprises an NF 1431. The deployments 1410, 1420, 1430 communicate via an interface 1490. The deployments 1410, 1420, 1430 may have different physical locations with different signal propagation delays relative to other network elements. The diversity of physical locations of deployments 1410, 1420, 1430 may enable provision of services to a wide area with improved speed, coverage, security, and/or efficiency.

FIG. 14B illustrates an example arrangement wherein a single deployment comprises more than one NF. Unlike FIG. 14A, where each NF is deployed in a separate deployment, FIG. 14B illustrates multiple NFs in deployments 1410, 1420. In an example, deployments 1410, 1420 may implement a software-defined network (SDN) and/or a network function virtualization (NFV).

For example, deployment 1410 comprises an additional network function, NF 1411A. The NFs 1411, 1411A may consist of multiple instances of the same NF type, co-located at a same physical location within the same deployment 1410. The NFs 1411, 1411A may be implemented independently from one another (e.g., isolated and/or independently controlled). For example, the NFs 1411, 1411A may be associated with different network slices. A processing system and memory associated with the deployment 1410 may perform all of the functionalities associated with the NF 1411 in addition to all of the functionalities associated with the NF 1411A. In an example, NFs 1411, 1411A may be associated with different PLMNs, but deployment 1410, which implements NFs 1411, 1411A, may be owned and/or operated by a single entity.

Elsewhere in FIG. 14B, deployment 1420 comprises NF 1421 and an additional network function, NF 1422. The NFs 1421, 1422 may be different NF types. Similar to NFs 1411, 1411A, the NFs 1421, 1422 may be co-located within the same deployment 1420, but separately implemented. As an example, a first PLMN may own and/or operate deployment 1420 having NFs 1421, 1422. As another example, the first PLMN may implement NF 1421 and a second PLMN may obtain from the first PLMN (e.g., rent, lease, procure, etc.) at least a portion of the capabilities of deployment 1420 (e.g., processing power, data storage, etc.) in order to implement NF 1422. As yet another example, the deployment may be owned and/or operated by one or more third parties, and the first PLMN and/or second PLMN may procure respective portions of the capabilities of the deployment 1420. When multiple NFs are provided at a single deployment, networks may operate with greater speed, coverage, security, and/or efficiency.

FIG. 14C illustrates an example arrangement of core network deployments in which a single instance of an NF is implemented using a plurality of different deployments. In particular, a single instance of NF 1422 is implemented at deployments 1420, 1440. As an example, the functionality provided by NF 1422 may be implemented as a bundle or sequence of subservices. Each subservice may be implemented independently, for example, at a different deployment. Each subservices may be implemented in a different physical location. By distributing implementation of subservices of a single NF across different physical locations, the mobile communications network may operate with greater speed, coverage, security, and/or efficiency.

FIG. 14D illustrates an example arrangement of core network deployments in which one or more network functions are implemented using a data processing service. In FIG. 14D, NFs 1411, 1411A, 1421, 1422 are included in a deployment 1450 that is implemented as a data processing service. The deployment 1450 may comprise, for example, a cloud network and/or data center. The deployment 1450 may be owned and/or operated by a PLMN or by a non-PLMN third party. The NFs 1411, 1411A, 1421, 1422 that are implemented using the deployment 1450 may belong to the same PLMN or to different PLMNs. The PLMN(s) may obtain (e.g., rent, lease, procure, etc.) at least a portion of the capabilities of the deployment 1450 (e.g., processing power, data storage, etc.). By providing one or more NFs using a data processing service, the mobile communications network may operate with greater speed, coverage, security, and/or efficiency.

As shown in the figures, different network elements (e.g., NFs) may be located in different physical deployments, or co-located in a single physical deployment. It will be understood that in the present disclosure, the sending and receiving of messages among different network elements is not limited to inter-deployment transmission or intra-deployment transmission, unless explicitly indicated.

In an example, a deployment may be a ‘black box’ that is preconfigured with one or more NFs and preconfigured to communicate, in a prescribed manner, with other ‘black box’ deployments (e.g., via the interface 1490). Additionally or alternatively, a deployment may be configured to operate in accordance with open-source instructions (e.g., software) designed to implement NFs and communicate with other deployments in a transparent manner. The deployment may operate in accordance with open RAN (O-RAN) standards.

In an example, a time service my comprise a service that provides time information (e.g., absolute time information, relative time information) to a wireless device. The time service may be provided by and/or via a communication network. The time service may determine and/or obtain time information from one or more time sources. The time service may be, for example, a coordinated universal time (UTC) service.

In an example, traceability may comprise tracing, authentication, verification, confirmation, and/or proof. In an example, traceability of a time service (e.g., traceability to UTC) may comprise an indication that time information is accurate (e.g., accurate to a particular degree of accuracy), precise (e.g., to a particular degree of precision) provided by and/or determined based on one or more particular (e.g., identified) sources of time, authentic, and/or calibrated. In an example, traceability may be associated with particular time information and/or a particular time service. In an example, a wireless device may require and/or request that a network provide traceability associated with particular time information and/or a particular time service. In an example, a network that provides a time service may or may not provide traceability and/or specific aspects of traceability.

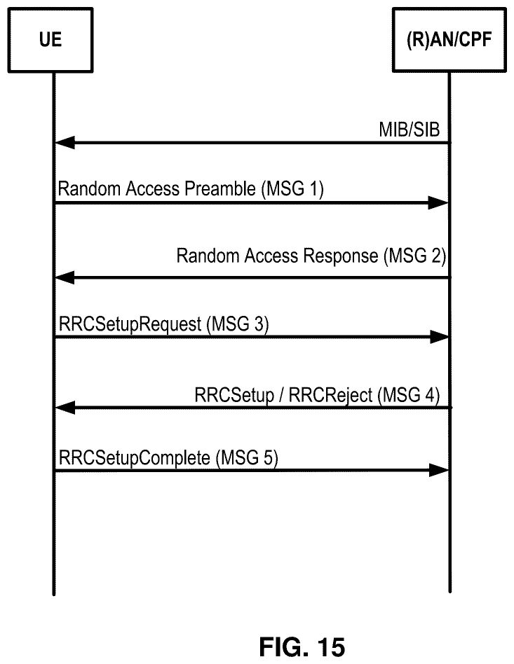

FIG. 15 is an example call flow illustrates an example of RRC connection establishment procedure. In an example, a UE may receive a master information block (MIB) information (e.g., information element, parameter, message) and/or a system information block (SIB) 1 information (e.g., information element, parameter, message) from a base station (e.g., (R)AN). The MIB information may comprise system information. For example, the MIB information may comprise at least one of parameter: systemFrameNumber, subCarrierSpacingCommon, ssb-SubcarrierOffset, dmrs-TypeA-Position, pdcch-ConfigSIB1, cellBarred, intraFreqReselection, and/or the like. In an example, the SIB 1 information may comprise information relevant when evaluating if a UE is allowed to access a cell and defines the scheduling of other system information. In an example, the SIB 1 may comprise radio resource configuration information that is common for all UEs and barring information applied to the unified access control. In an example, the UE may receive SIB x information (e.g., information element, parameter, message) from the (R)AN and/or a control plane function (CPF) (e.g., an AMF). For example, the SIB x information may comprise SIB 2, SIB 3, SIB 4, and/or the like, other than SIB 1. In an example, the SIB 2 information may comprise cell re-selection information common for intra-frequency, inter-frequency and/or inter-RAT cell re-selection (e.g., applicable for more than one type of cell re-selection but not necessarily all) as well as intra-frequency cell re-selection information other than neighbouring cell related. For example, the SIB 2 message may comprise at least one parameter: cellReselectionInfoCommon, cellReselectionServingFreqInfo, intraFreqCellReselectionInfo, and/or the like. In an example, the SIB 3 information may comprise neighbouring cell related information relevant only for intra-frequency cell re-selection. The IE includes cells with specific re-selection parameters as well as blacklisted cells. For example, the SIB 3 information may comprise at least one parameter: intraFreqNeighCellList, and/or intraFreqBlackCellList.

In response to the message received from the (R)AN and/or the CPF, the UE may transmit at least one random access preamble to the (R)AN. In an example, the UE may transmit at least one random access preamble to the CPF (e.g., via the (R)AN). For example, the UE may send the at least one random access preamble to the (R)AN via a message 1 (MSG 1). In response to the at least one random access preamble received from the UE, the (R)AN may send a random access response message to the UE. In an example, the CPF may transmit a random access response message to the UE (e.g., via the (R)AN). For example, the CPF and/or the (R)AN may send the random access response message to the UE via a message 2 (MSG 2).

In an example, in response to the random access response message, the UE may send a message (e.g., RRC setup request) to the (R)AN and/or the CPF. For example, the UE may send the RRC setup request message via a message 3 (MSG 3). For example, the UE may send the RRC setup request message to the CPF via the (R)AN. For example, the RRCSetupRequest message may indicate establishing an RRC connection for the UE. The RRCSetupRequest message may comprise at least one of: a UE identity (e.g., TMSI), a parameter (e.g., establishmentCause) indicating a cause value of RRC establishment, and/or a dedicatedNAS-Message. For example, the establishmentCause may comprise at least one of value: emergency, highPriorityAccess, mt-Access, mo-Signalling, mo-Data, mo-VoiceCall, mo-VideoCall, mo-SMS, mps-PriorityAccess, mcs-PriorityAccess, and/or the like.

In response to the message received from the UE, the (R)AN and/or the CPF may send a RRC setup message to the UE via a message 4 (MSG 4). For example, the CPF may send the RRC setup message to the UE via the (R)AN. For example, the RRC setup message may be used to establish SRB 1. In an example, the RRCSetup message may comprise at least one information element: a masterCellGroup, a radioBearerConfig and/or dedicatedNAS-Message. The masterCellGroup may indicate that the network configures the RLC bearer for the SRB1. The radioBearerConfig may indicate that the SRB1 may be configured in RRC setup.

In an example, in response to the message received from the (R)AN and/or the CPF, the UE may send a RRCSetupComplete message to the (R)AN. For example, the UE may send a RRCSetupComplete message to the CPF via a message 5 (MSG 5). For example, the UE may send the RRCSetupComplete message to the CPF via the (R)AN. RRCSetupComplete message may comprise at least one parameter: a selectedPLMN-Identity, a registeredCPF, a guami-Type (e.g., native, mapped), s-NSSAI-List (e.g. list of network slice identifiers), dedicatedNAS-Message, a TMSI, and/or the like. The registeredCPF may comprise a PLMN identity and/or a CPF identifier. In an example, the RRCSetupComplete message may comprise a NAS message. For example, the dedicatedNAS-Message of the RRCSetupComplete message may comprise the NAS message. For example, the dedicatedNAS-Message may comprise a registration request message.

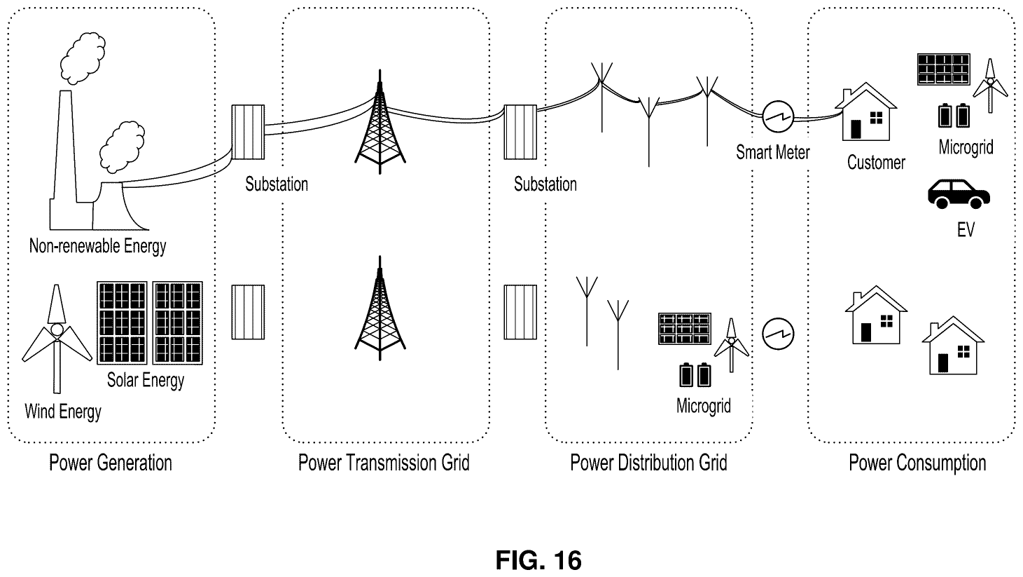

FIG. 16 illustrates an example of a power system/smart energy system. In an example, the terminologies “power system”, “power grid”, “smart grid” and/or “smart energy system” may be used interchangeable. In an example, a power system/smart energy system may comprise power generation, power transmission, power distribution, and/or power consumption. In an example, the power generation may comprise generating/supplying (electric) power by means of solar, wind, fuel cell and/or gas combined in one or more power generating centers. For example, the power generation may comprise coal-fired power generation, gas-fired power generation, hydropower, solar energy, wind energy, and/or the like. In an example, the power transmission may comprise transmitting the power from a power generating center to one or more load center (e.g., power station, power substation). In an example, the power distribution may comprise distributing the power to nearby power users/consumers (e.g., homes, industries, electric vehicles). In an example, the power consumption may comprise consuming/using the power by the power users/consumers (e.g., homes, industries, electric vehicles).

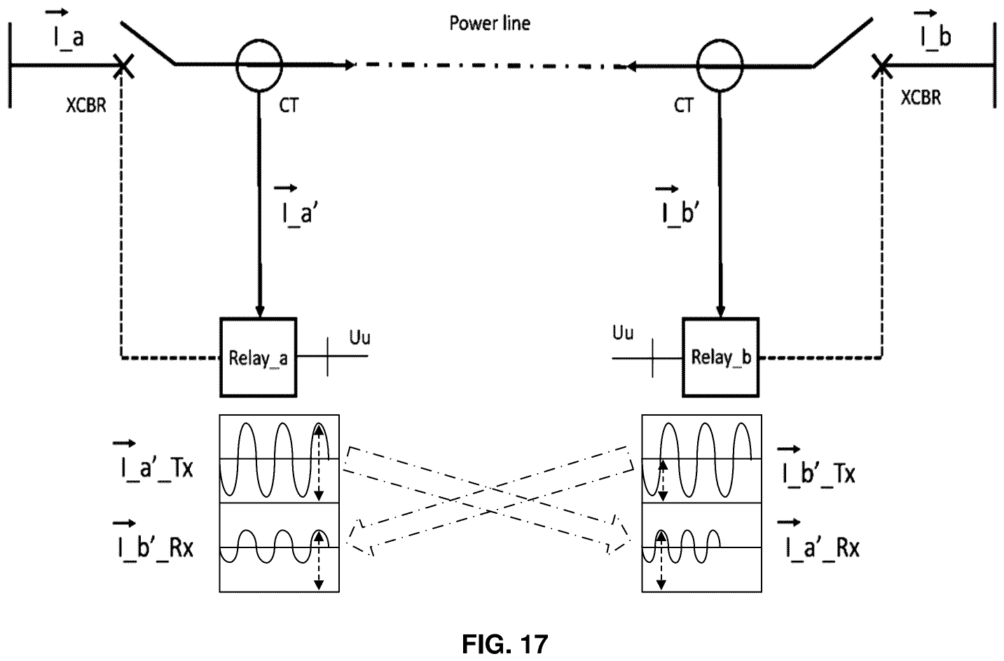

FIG. 17 illustrates an example of line current differential protection by two protection relays deployed in two substations. In an example, the line current differential protection (defined as 87L in IEEE C37.2-2008) has been widely used in electrical transmission systems to protect High-Voltage (HV) transmission lines. As a proven protection mechanism, it may be deployed for power distribution networks to protect (Medium-Voltage) MV distribution lines where applicable. The popularity of line current differential protection may come from the fast protection mechanism, reliability and the absolute selectivity of protected zones. Therefore, for Low-Voltage (LV) and MV power lines (both underground and overhead), current differential protection may be deployed easily with cellular technology without having to lay dedicated communication cables, either in refurbishment or new distribution substation construction projects.

In an example, the mechanism of line current differential protection may follow the Kirchhoff's current law, which is that the sum of currents at a junction of a circuit equals to zero. As illustrated in FIG. 17, two protection relays (e.g., Relay_a and Relay_b) deployed at two substations form the protection zone, within which the power line may be protected from incidents such as short circuit. Each protection relay continuously may measure its local current and may transmit it towards the other. Each protection relay may compare the locally measured current and the current received from the remote relay to calculate the differential current at a specific instant of time. FIG. 17 shows two communication channels (illustrated as dashed arrow boxes) between the two protection relays. Here the “communication channel” may refer to the channel used for transferring the phase segregated current value data between the two protection relays. The current phasors from the two protection relays, deployed geographically apart from each other, should be aligned in time for the current differential algorithm to execute correctly. For Relay_a, at a given moment the local current is I_a′_Tx, and the time-aligned remote current from Relay_b is I_b′_Rx. Using them as input, the protection algorithm in Relay_a may derive the differential current. The same mechanism may be applied in Relay_b. Whenever any incidents (e.g., short circuit) between Relay_a and Relay_b happened, the differential current may exceed the threshold values as determined by the relay restraint characteristics, the Relay_a and/or Relay_b may send a trip command to the circuit breaker (XCBR) to open the circuit, thus protecting the power line from being burnt down and any secondary damages (e.g., a fireball blaze on the power line may be caused by the incidents).

In an example, the protection function of the protection relays may depend on three things: (1) Sampling, buffering and transferring local current; (2) Receiving the sampled current values from the remote protection relay; (3) Time synchronization of the two protection relays—performing time-alignment of the locally buffered current samples with received remote samples.

In an example, in terms of sampling, a protection relay may need to sample the local current periodically, and transfers sampled data within a pre-defined time period T. In other words, the communication latency should not exceed T. Max of T may be between 5 ms and 10 ms (e.g., as specified in IEC 61850-90-1), which infers the latency requirement for this use case. Secondly, once the buffered samples pertinent to the same instant in time are available, the relay must align them in time. In an example, a relay may need to perform correct alignment of local and received data (e.g., current value). For example, Relay_a may have sampled a current value 1 at 3:00 PM, when receiving one or more current values from Relay_b, Relay_a may need to identify a current value 2 of one or more current values, where the current value 2 was sampled by Relay_b at 3:00 PM. As a relay needs to perform correct alignment of local and received data before calculating the differential current, the relay may need to know well enough when the remote relay transmits a specific data packet. Current clock synchronization is realized by relays attaching timestamps to measurement samples before transmission. A modern relay with an Ethernet interface normally needs to resort to IEEE 1588 Precision Time Protocol for synchronization, since the relay assumes the Ethernet network to be non-deterministic.

Regarding time alignment of local and received remote data, there may be two methods, a time-based alignment method, and/or a channel-based alignment method. In an example, when the time-based alignment method is used, a first relay (e.g., Relay_a) may send a first current value with a timestamp to a second relay (e.g., Relay_b), where the timestamp may indicate a sampling time of the first current value. Based on the timestamp, the second relay may identify a second current value sampled at the timestamp by the second relay. The second relay may compare the first current value and the second current value. If the differences between the first current value and the second current value exceeds a threshold value, the second relay may send a trip command to the circuit breaker (XCBR) to open the circuit. The first relay may take the similar actions as the second relay. In an example, the time-based alignment method may use external time source such as GNSS to get/derive the timestamp.

In an example, due to various reasons in some smaller substations a GNSS receiver is not available. Even for a substation installed with a GNSS receiver, relays may fall back to channel-based alignment for time synchronization if GNSS become unavailable. For this reason, it may be necessary to support the channel-based alignment method may be support. Different from GNSS-based alignment that is not adversely affected by communication channel asymmetry, the channel-based alignment may be critically dependent on channel symmetry—near equal latency in transmission and reception directions between two protection relays respectively. In an example, the latency may be a time (duration) it takes for sending a data from its original source (e.g., Relay_a) to its destination (e.g., Relay_b). In an example, the latency may indicate a time (duration) to (successfully) deliver a data packet/message from a first network element (e.g., UE 1) to a second network element (e.g., UE 2). In an example, the latency may be measured in microseconds, milliseconds, seconds, etc.

Currently in the Smart Grid automation market, the max communication channel asymmetry may be dependent on the chosen type of differential protection relay and may be vendor-specific. For instance, an old-fashioned TDM-based differential protection relay may be more sensitive to asymmetry than a modern type differential protection relay with an Ethernet interface. The latter may deal with asymmetry till 3 millisecond (ms), above which the relay will enter blocking mode. According to the IEEE C37.243 Guide, the asymmetry in terms of communication channel latency is around 2 ms. From here on, focus may be on how to satisfy channel-based alignment requirements using services from 5G system.

There may be two options to implement the channel-based alignment method. Option 1, the protection relays detect/measure the latencies of the relevant communication channel (e.g., the communication path between two relays). In an example, per existing protection relay algorithm implementation, channel-based alignment method may presume the delay in each communication direction (e.g., sending/uplink direction, receiving/downlink direction) to be (nearly) half of the Round-trip time (RTT). In an example, the RTT may be a duration/amount of time it takes for a signal to be sent plus the amount of time it takes for acknowledgement of that signal having been received. In an example, if 5G system provides the delay in each communication direction to be (nearly) half of the RTT, existing relay algorithm may be reused. According to IEEE C37.243 Guide, 2 ms may be required as the max communication channel latency asymmetry between the two protection relays. In an example, Relay_a may attach a timestamp to the transmitted measurement data, Relay_b may receive the timestamp from Relay_a and may re-attaches the same timestamp to the next out-going data packet towards Relay_a. By receiving the original timestamp in return packet, Relay_a may determine the RTT by subtracting the present local time with the returned original timestamp. Halving the RTT, Relay_a obtains the amount of time shift/alignment it shall apply to the current samples received from Relay_b. Therefore, it may be required that the communication channel from Relay_a to Relay_b incurs near-equal latency as the channel from Relay_b to Relay_a. Following this approach, excessive communication channel asymmetry between Relay_a and Relay_b may lead to misalignment of currents (such as the I_b′_Tx and I_a′_Rx at Relay_b in FIG. 17), manifesting in phase shift. This may result in increase or decrease of the apparent differential current, causing blocking of the protection or in the worst case a false trip and further negatively impact Smart Grid availability and reliability.

Option 2, the communication system (e.g., 5G) may provide the latencies of the relevant communication channel. In an example, alternatively, instead of requiring the communication channels (from Relay_a to Relay_b, and from Relay_b to Relay_a) to be highly symmetrical regarding latency, a different approach may be proposed as a new 5G service to improve protection relay design by the Smart Grid OEMs. To achieve the same goal as for Relay_a to know how much it needs to time shift the received current samples from Relay_b to align with its local current, it may be sufficient if the 5G system could provide such a protection relay with the latency of the relevant communication channel (latency from Relay_b to Relay_a for Relay_a, and latency from Relay_a to Relay_b for Relay_b) with good confidence/precision. This provided latency value may either be estimated or assigned by the 5G system. In this way, the channel latency information may be directly provided to relays by the 5G system, a protection relay may not need to carry out its own estimation. This may open new possibilities for the protection relay manufacturers to design new and possibly simpler time-alignment algorithms.

For time-based alignment method, the existing IEEE 1588 time master of the NG-RAN may be used. In this case, the complexity may be the use of the IEEE 1588 power/utility profile (a.k.a. IEC 61850-9-3) instead of using the telecom profile.

In an example, typically in a distribution grid, a MV power line transmits electricity between two substations. Two protection relays may be installed at both ends of the power line. Relay_a may continuously sample and measure the local current I_a′ and sends it to Relay_b, so does Relay_b. In an example, Relay_a may sample local current values I_a′ and store them locally. The Relay_a may send the local current values I_a′ to Relay_b periodically. In an example, a first timestamp may be attached to the local current values I_a′ to help Relay_b to match the data correctly. In an example, the Relay_b may sample local current values I_b′, stores them locally and sends them to Relay_a periodically. In an example, a second timestamp may be attached to the sampled values to help Relay_a to match the data correctly. In an example, the Relay_a may receive samples from Relay_b within the latency required by IEC 61850-90-1. Depending on the applied voltage levels, the max allowed latency may be between 5 ms and 10 ms. The Relay_a may store the received samples in a local buffer. In an example, the Relay_b may receive samples from Relay_a within the latency required by IEC 61850-90-1. Depending on the applied voltage levels, the max allowed latency may be between 5 ms and 10 ms. The Relay_b may store the received samples in a local buffer. In an example, inside both the Relay_a and the Relay_b, a microprocessor may decide that all the relevant data for a same instant in time are collected. The Relay may then align these data and use the algorithm to calculate the differential current for this time instant. In an example, differential current calculated at both the Relay_a and the Relay_b may stay in the restraining region (below threshold). None of the relay trips. The system may continue to function in normal condition.

In an example incident, suddenly, a strong wind blows down a tree branch falling down the overhead distribution line close to the ground. The voltage of the power line may cause an electric discharge to the objects on the ground, and may cause spark leakage. This discharge may cause current from both substations to flow with increased magnitude into the power line. Since both relays are still measuring the current and sends the sampled values to each other, the differential current may exceed the threshold. Both relays may trigger a trip signal to the connected circuit breaker. The circuit breaker may open and stop current from flowing into the power line, to avoid more serious damage. The abnormal condition of the power line in the protected zone may be duly isolated from the electrical grid.

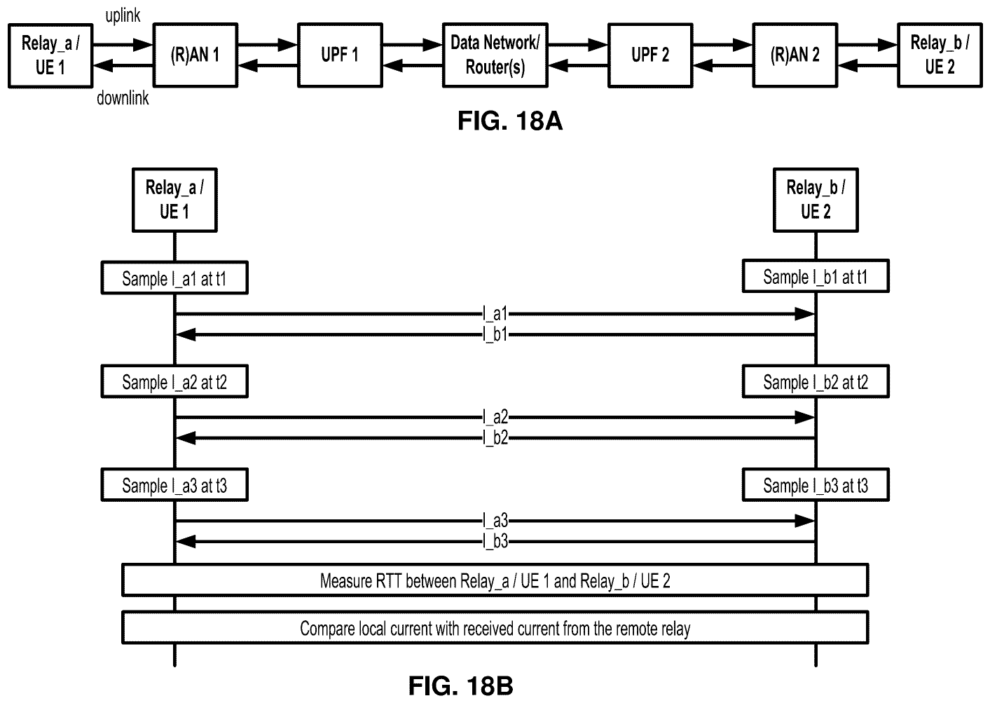

FIG. 18A and FIG. 18B are example diagrams illustrate problems of existing technologies. In an example, as shown in FIG. 18A, a Relay_a may comprise and/or be co-located with a first wireless device (illustrated as UE1), and a Relay_b may comprise and/or be co-located with a second wireless device (illustrated as UE2). The Relay_a may communicate to Relay_b using UE1, and the Relay_b may communicate to Relay_a using UE2. There may be one or more network functions and/or nodes between UE1 and UE2. In an example, from the perspective of Relay_a/UE 1, an uplink communication channel/path may comprise a direction from the Relay_a/UE 1 to the Relay_b/UE 2, and may comprise one or more network functions/nodes: the Relay_a/UE 1, a (R)AN 1, a UPF 1, Data Network/Router(s), a UPF 2, a (R)AN 2, and/or the Relay_b/UE 2. From the perspective of Relay_a/UE 1, a downlink communication channel/path may comprise a direction from the Relay_b/UE 2 to the Relay_a/UE 1, and may comprise one or more network functions/nodes: the Relay_b/UE 2, the (R)AN 2, the UPF 2, the Data Network/Router(s), the UPF 1, the (R)AN 1, and/or the Relay_a/UE 1. In an example, from the perspective of Relay_b/UE 2, an uplink communication channel/path may comprise a direction from the Relay_b/UE 2 to the Relay_a/UE 1, and may comprise one or more network functions/nodes: Relay_b/UE 2, the (R)AN 2, the UPF 2, the Data Network/Router(s), the UPF 1, the (R)AN 1, and/or the Relay_a/UE 1. From the perspective of Relay_b/UE 2, a downlink communication channel/path may comprise a direction from the Relay_a/UE 1 to the Relay_b/UE 2, and may comprise one or more network functions/nodes: the Relay_a/UE 1, the (R)AN 1, the UPF 1, the Data Network/Router(s), the UPF 2, the (R)AN 2, and/or the Relay_b/UE 2.

As shown in FIG. 18B, Relay_a/UE 1 may continuously sample and measure the local current I_a and sends it to Relay_b/UE 2, so does the Relay_b/UE 2. In an example, Relay_a/UE 1 may sample local current values I_a and store them locally. In an example, Relay_b/UE 2 may sample local current values I_b and store them locally. In an example, the Relay_a/UE 1 may measure a RTT between the Relay_a/UE 1 and the Relay_b/UE 2, so does the Relay_b/UE 2. In an example, the Relay_a/UE 1 may derive a I_b value (e.g., I_b 1) based on the RTT and an assumption that communication channel/path between the Relay_a/UE 1 and the Relay_b/UE 2 is symmetric. In an example, the communication channel/path is symmetric may indicate that the unlink communication channel/path and the downlink communication channel/path are symmetric. In an example, the unlink communication channel/path and the downlink communication channel/path are symmetric may indicate that the latency of the unlink communication channel/path (e.g., a latency from the Relay_a/UE 1 to the Relay_b/UE 2) is the same as the latency of the downlink communication channel/path (e.g., a latency from the Relay_b/UE 2 to the Relay_a/UE 1). In an example, the unlink communication channel/path and the downlink communication channel/path are symmetric may indicate that the difference between [the latency of the unlink communication channel/path] and [the latency of the downlink communication channel/path] may be less than and/or equal to a value (e.g., 2 ms).

In an example, the Relay_a/UE 1 may compare local current (e.g., I_a 1) with the derived I_b value (e.g., I_b 1), where the local current and the derived I_b are sampled at the same time. In an example, if the local current sampled by the local relay (e.g., the Relay_a/UE 1) does not equal to the current (e.g., derived I_b) received from the remote relay (e.g., Relay_b/UE 2), the Relay_a/UE 1 may trigger a trip signal to the connected circuit breaker. In an example, if the difference between [the local current sampled by the local relay] and [the current received from the remote relay] is great than a threshold, the Relay_a/UE 1 may trigger a trip signal to the connected circuit breaker. In an example, the Relay_b/UE 2 may take the similar actions as Relay_a/UE 1.

In an example, as shown in FIG. 18B, Relay_a/UE 1 may sample and measure the local current I_a 1 at time t1 (e.g., time 0) and may send the I_a 1 to the Relay_b/UE 2 at the same time (e.g., assuming internal data process time in Relay_a/UE 1 is very small and can be ignored). The Relay_b/UE 2 may sample and measure the local current I_b 1 at time t1 (e.g., time 0) and may send the I_b 1 to the Relay_a/UE 1 at the same time. The Relay_a/UE 1 may continue to sample and measure the local current (s) and send to the Relay_b/UE 2, and so does the Relay_b/UE 2. In an example, the Relay_a/UE 1 may measure a RTT (e.g., 20 ms) between the Relay_a/UE 1 and the Relay_b/UE 2. In an example, the Relay_a/UE 1 may derive a I_b value (e.g., I_b 1) based on the RTT and an assumption that communication channel/path between the Relay_a/UE 1 and the Relay_b/UE 2 is symmetric. For example, the Relay_a/UE 1 may receive the I_b 1 at a time of 10 ms, the Relay_a/UE 1 may calculate the latency of the downlink communication channel/path as half of the RTT (e.g., 10 ms), then based the latency of the downlink communication channel/path, the Relay_a/UE 1 may derive that I_b 1 was sampled and measured by the Relay_b/UE 2 at the time t1 (e.g., time 0). Then, the Relay_a/UE 1 may compare the local current (e.g., I_a 1) with the derived I_b value (e.g., I_b 1), where the local current and the derived I_b are sampled at the same time t1 (e.g., time 0).

However, existing technologies have not focused on the question of symmetric communication. For example, in the current differential protection use-case, channel symmetry may be a requirement. In the absence of effective methods of setting up and/or maintaining channel symmetry, current different protection either can not be implemented or can not be implemented reliably. This may result in power failure, and in extreme cases, severe damage and destruction (e.g., forest fires). In an example, if the communication channel/path between the Relay_a/UE 1 and the Relay_b/UE 2 is not symmetric (e.g., the latency of the unlink communication channel/path is 5 ms, and the latency of the downlink communication channel/path is 15 ms), the Relay_a/UE 1 may receive the I_b 1 at a time of 15 ms. Based on half of the RTT (e.g., 10 ms), the Relay_a/UE 1 may wrongly conclude that I_b 1 was sampled and measured by the Relay_b/UE 2 at a time of 5 ms, and I_b 1 cannot be compared with I_a 1. In an example, because of the communication channel/path between the Relay_a/UE 1 and the Relay_b/UE 2 is not symmetric, the Relay_a/UE 1 may not be able to derive a corresponding current which was received from the Relay_b/UE 2, and may not be able to compare it with the I_a 1. In an example, because of the communication channel/path between the Relay_a/UE 1 and the Relay_b/UE 2 is not symmetric, the Relay_a/UE 1 may derive a wrong current value which was received from the Relay_b/UE 2, and may cause a wrong result after comparing the wrong current value with the I_a 1. Consequently, the Relay_a/UE 1 may take wrong actions (e.g., send a trip signal to the connected circuit breaker), and the power supply may be wrongly interrupted. Or the Relay_a/UE 1 may fail to break the circuit, causing destruction of the power line. The Relay_b/UE 2 may have the similar problem as Relay_a/UE 1 if the communication channel/path between the Relay_b/UE 2 and the Relay_a/UE 1 is not symmetric.

In an example, a first user (e.g., UE 1) and a second user (e.g., UE 2) may play a game via a communication network as shown in FIG. 18A. The first user may send an order to the second user, and the latency from the first user to the second user may be 10 ms. The second user response to the first user when receiving the order. However, due to the communication channel/path between the UE 1 and the UE 2 is not symmetric, the latency from the second user to the first user may be 2 second. This may cause the first user receiving the response very slowly, and consequently, the game may not be played efficiently between the first user and the second user (for example, one user or the other may have an unfair advantage).

The existing technology may have an issue to support symmetric communication channel/path between two network functions/nodes. For example, the existing technology may have an issue to support symmetric communication channel/path between the Relay_a/UE 1 to the Relay_b/UE 2. Consequently, the Relay_a/UE 1 may take wrong actions. For example, the existing technology may have an issue to support symmetric communication channel/path between two users. Consequently, the application/service between the two users may not be performed (efficiently).

Example embodiments of the present disclosure implement an enhanced mechanism to enable a symmetric communication channel/path between two network functions/nodes. Example embodiments of the present disclosure implement an enhanced mechanism to enable symmetric communication channel/path between two wireless devices. Example embodiments of the present disclosure implement an enhanced mechanism to enable symmetric communication channel/path between a wireless device and a base station. Example embodiments of the present disclosure implement an enhanced mechanism to enable symmetric communication channel/path between a wireless device and a core network function. Example embodiments of the present disclosure implement an enhanced mechanism to improve end to end latency between two network functions/nodes. Example embodiments of the present disclosure implement an enhanced mechanism to improve end to end latency between two wireless devices.

In an example embodiment of the present disclosure, a base station may receive a radio resource control (RRC) request message from a wireless device. The RRC request message may indicate a request for symmetric communication channels. For example, the message may comprise a field, parameter, and/or information element indicating the request for symmetric communication. The indication may be referred to as a channel symmetry request (CSR), but it will be understood that other suitable terminology may be used to describe the indication. In an example, based on the CSR, the base station may determine radio bearer configuration information for the symmetric communication channels. In an example, the base station may send an RRC response message to the wireless device. The RRC response message may indicate the radio bearer configuration information.

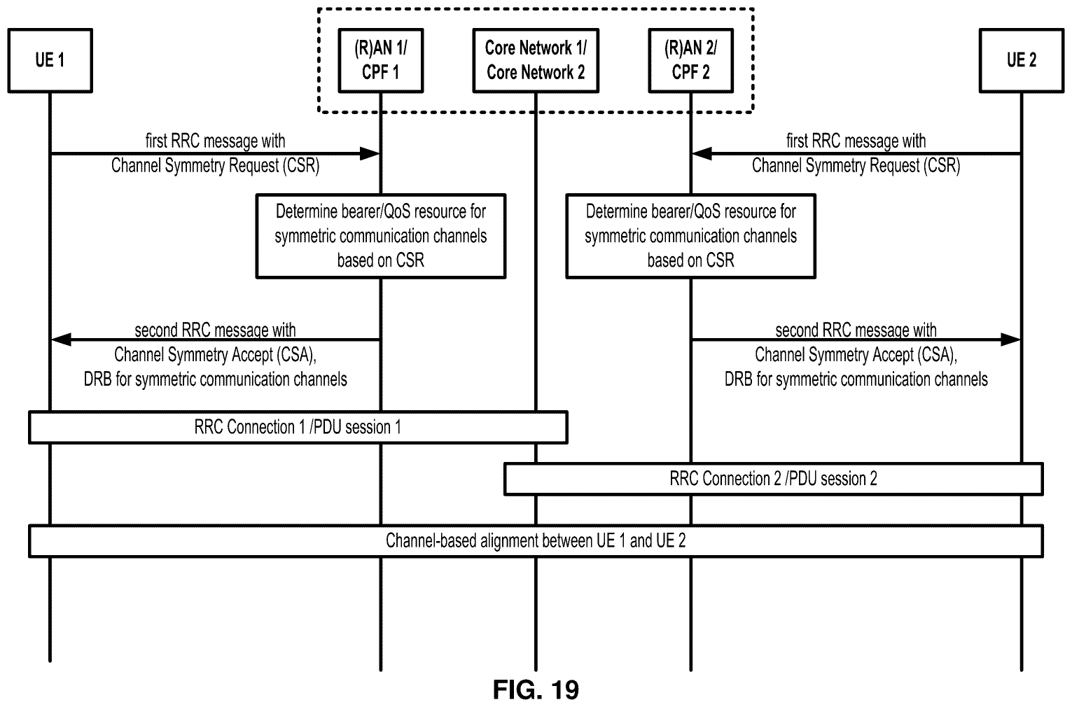

FIG. 19 is an example call flow which may comprise one or more actions. In an example, a base station (e.g., (R)AN 1 as shown in FIG. 19) may receive a first message (e.g., radio resource control (RRC) request message) from a wireless device (e.g., UE 1 as shown in FIG. 19). The RRC request message may indicate a request for symmetric communication channels. For example, the RRC request message may comprise a parameter (e.g., a channel symmetry request (CSR)) indicating a request for symmetric communication channels. In an example, the symmetric communication channels may be applied for a service and/or an application of the wireless device. In an example, the service of the wireless device may comprise a video service, a URLLC service (e.g., as described in FIG. 6), an eMBB service (e.g., as described in FIG. 6), an mMTC service (e.g., as described in FIG. 6), a Massive Internet of things (MIoT) service, a High-Performance Machine-Type Communications (HMTC) service, and/or the like. In an example, the MIoT may indicate one or more physical objects that are embedded with sensors, processing ability, software, and other technologies that connect and exchange data with other devices and systems over the Internet or other communications networks. In an example, the HMTC service may indicate a type of low power wide area network (LPWAN) radio technology to enable a wide range of cellular devices, sensors, and services (e.g., for M2M and/or IoT applications). In an example, the application of the wireless device may be an application for the smart energy (e.g., line current differential protection). In an example, the application of the wireless device may be a game application.

In an example, the parameter/Channel Symmetry Request may indicate requesting a radio bearer for the symmetric communication channels, wherein the radio bearer may comprise a data radio bearer (DRB) and/or a signaling radio bearer (SRB). In an example, the parameter/Channel Symmetry Request may indicate requesting a PDU session for the symmetric communication channels. The PDU session may be associated with at least one radio bearer, wherein the at least one radio bearer may comprise at least one data radio bearer and/or at least one signaling radio bearer.

In an example, the symmetric communication channels may comprise at least one symmetric uplink communication channel and/or at least one downlink communication channel. In an example, the at least one symmetric uplink communication channel and/or the at least one downlink communication channel may indicate end to end latency of the at least one uplink communication channel equals to end to end latency of the at least one downlink communication channel. In an example, the at least one symmetric uplink communication channel and/or the at least one downlink communication channel may indicate that a difference between [end to end latency of the at least one uplink communication channel] and [end to end latency of the at least one downlink communication channel] is less than and/or equal a configured (e.g., threshold) value (e.g., 2 ms).

In an example, the at least one uplink communication channel may indicate a communication path from a first network element to a second network element. In an example, the at least one downlink communication channel may indicate a communication path from the second network element to the first network element. In an example, the first network element may comprise at least one of: a first wireless device; a first base station; a first access and mobility management function (AMF); a first session management function (SMF); a first user plane function (UPF); a first network exposure function (NEF); a first router; and/or the like. In an example, the second network element may comprise at least one of: a second wireless device; a second base station; a second AMF; a second SMF; a second UPF; a second NEF; a second router; and/or the like. In an example, the communication path may comprise at least one of: at least one physical uplink control channel (PUCCH); at least one physical downlink control channel (PDCCH); at least one physical uplink shared channel (PUSCH); at least one physical downlink shared channel (PDSCH); at least one signaling radio bearer (SRB); at least one data radio bearer (DRB); at least one RRC connection; at least one service data flow; at least one QoS flow; at least one protocol data unit (PDU) session; and/or the like. In an example, the communication path may indicate a path of communication over at least one of: an air interface; an ethernet cable; a fiber cable; a communication network; and/or the like.

In an example, the end to end latency of the at least one uplink communication channel may indicate a time (duration) to (successfully) deliver a data packet/message from the first network element (e.g., UE 1) to the second network element (e.g., UE 2). In an example, the end to end latency of the at least one downlink communication channel may indicate a time (duration) to (successfully) deliver a data packet/message from the second network element (e.g., UE 2) to the first network element (e.g., UE 1). In an example, the end to end latency of the at least one downlink communication channel may indicate a time (duration) to (successfully) receive a data packet/message from the second network element (e.g., UE 2) by the first network element (e.g., UE 1).

In an example, the parameter/Channel Symmetry Request may indicate that a requested maximum end to end latency asymmetry/difference between [the at least one uplink communication channel] and [the at least one downlink communication channel] is less than and/or equal to a value (e.g., 2 ms). For example, the end to end latency of the at least one uplink communication channel is 5 ms, the end to end latency of the at least one downlink communication channel is 7 ms, based on above information, the end to end latency asymmetry/difference between [the at least one uplink communication channel] and [the at least one downlink communication channel] is 2 ms (e.g., 7 ms−5 ms=2 ms). In an example, the RRC request message may comprise a second parameter (e.g., Asymmetric End to End Latency) indicating requesting maximum end to end latency asymmetry/difference between [the at least one uplink communication channel] and [the at least one downlink communication channel] is less than and/or equal to a value.

In an example, the parameter/Channel Symmetry Request may indicate that end to end latency between the first network element and the second network element is less than and/or equal to a value (e.g., 5 ms, 10 ms). In an example, the end to end latency between the first network element and the second network element may indicate a time (duration) to (successfully) deliver a data packet/message from the first network element (e.g., UE 1) to the second network element (e.g., UE 2). In an example, the parameter/Channel Symmetry Request may indicate requesting end to end latency of the at least one uplink communication channel is less than and/or equal to a value (e.g., 5 ms, 10 ms). In an example, the parameter/Channel Symmetry Request may indicate requesting end to end latency of the at least one downlink communication channel is less than and/or equal to a value (e.g., 5 ms, 10 ms). In an example, the RRC request message comprises a third parameter (e.g., End to End Latency) indicating requesting end to end latency between two network elements is less than and/or equal to a value (e.g., 5 ms, 10 ms). In an example, the third parameter/End to End Latency may indicate requesting end to end latency of the at least one uplink communication channel is less than and/or equal to a value. In an example, the third parameter/End to End Latency may indicate requesting end to end latency of the at least one downlink communication channel is less than and/or equal to a value.

In an example, the RRC request message may comprise an identity of the wireless device, wherein the identity of the wireless device comprises at least one of: a Generic Public Subscription Identifier (GPSI); a Subscription Permanent Identifier (SUPI); a Subscription Concealed Identifier (SUCI); a 5G Globally unique Temporary Identity (5G-GUTI); a permanent equipment identifier (PEI); an IP address; an application level identifier to identify the wireless device; an external identifier of the wireless device; and/or the like to identify the wireless device. In an example, the GPSI may comprise a Mobile Station Integrated Services Digital Network (MSISDN) and/or an external identifier. In an example, the SUPI may comprise an International Mobile Subscriber Identity (IMSI) and/or Network Access Identifier (NAI). In an example, the PEI may comprise an International Mobile Equipment Identity (IMEI). In an example, the IP address may comprise an IPv4 address and/or an IPv6 prefix. In an example, in order to avoid disclosing the information of the wireless device, the external identifier of the wireless device may be used by an application (e.g., a 3rd party).

In an example, the RRC request message may comprise an identity of a second wireless device (e.g., UE 2 as shown in FIG. 19), wherein the symmetry communication channels may be between the wireless device and the second wireless device. In an example, the definition/content of the identity of the second wireless device may be similar to the definition/content of the identity of the wireless device as described above.

In an example, the parameter/Channel Symmetry Request, the identity of the wireless device and/or the identity of the second wireless device may indicate that the wireless device (e.g., UE 1) requesting symmetric communication channels between the wireless device (e.g., UE 1) and the second wireless device (e.g., UE 2).

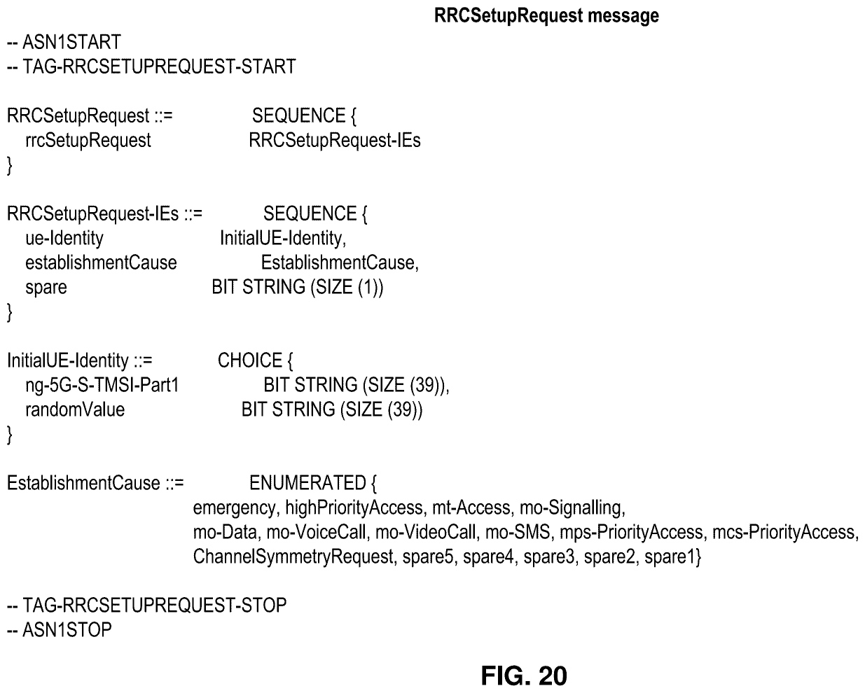

In an example, the first message may comprise at least one of: an MSG 3; an MSG 5; a RRCSetupRequest message; a RRCSetupComplete message; a RRCResumeRequest message; a RRCResumeComplete message; a UEAssistanceInformation message; a UEInformationResponse message; a UECapabilityInformation message; and/or the like. FIG. 20 is an example diagram depicting a RRCSetupRequest message, wherein the RRCSetupRequest message comprise a parameter/ChannelSymmetryRequest indicating requesting symmetric communication channels.

In response to the message received from the wireless device (e.g., UE 1), the base station (e.g., (R)AN 1) may determine whether to accept the RRC request and/or requesting symmetric communication channels, based on at least one of: the RRC request message, the resource of the base station, the local policy, and/or subscription information of the wireless device. For example, the RRC request message may comprise the parameter/Channel Symmetry Request, the identity of the wireless device and/or the identity of the second wireless device; the RRC request message may indicate that the UE 1 requesting symmetric communication channels between the UE 1 and the UE 2; the local policy and/or the subscription information of the UE 1 may indicate that the network allowed to provide symmetric communication channels for the UE 1; the resource of the base station may indicate that the base station has enough resource to provide symmetric communication channels for the UE 1; etc., based on above information, the (R)AN 1 may determine to accept the RRC request and/or the request of symmetric communication channels.

In an example, based on the base station determining whether to accept the RRC request and/or requesting symmetric communication channels, the base station may determine a fourth parameter (e.g., Channel Symmetry Accept) indicating accepting the RRC request and/or the request of symmetric communication channels. For example, fourth parameter/Channel Symmetry Accept may comprise a field, parameter, and/or information element indicating acceptance of the request for symmetric communication. The fourth parameter/Channel Symmetry Accept may be referred to as a channel symmetry accept (CSA), but it will be understood that other suitable terminology may be used to describe the indication.

In an example, in response to the message received from the wireless device (e.g., UE 1), the base station (e.g., (R)AN 1) may determine radio bearer and/or QoS resource for the symmetric communication channels, based on at least one of: the determining that whether to accept the RRC request and/or requesting symmetric communication channels, the RRC request message, the resource of the base station, the local policy, and/or subscription information of the wireless device. In an example, the radio bearer may comprise at least one data radio bearer (DRB) and/or at least one signal radio bearer (SRB). In an example, the base station (e.g., (R)AN 1) may determine radio bearer configuration information for the symmetric communication channels, based on at least one of: the determining that whether to accept the RRC request and/or requesting symmetric communication channels, the RRC request message, the resource of the base station, the local policy, and/or subscription information of the wireless device. In an example, the base station may determine the at least one data radio bearer (DRB) and/or the at least one signal radio bearer (SRB) for the symmetric communication channels, based on at least one of: the determining that whether to accept the RRC request and/or requesting symmetric communication channels, the RRC request message, the resource of the base station, the local policy, and/or subscription information of the wireless device. For example, the (R)AN 1 may determine to accept the RRC request and/or the request of symmetric communication channels; the (R)AN 1 may determine the fourth parameter/Channel Symmetry Accept; the RRC request message may comprise the parameter/Channel Symmetry Request, the identity of the wireless device and/or the identity of the second wireless device; the RRC request message may indicate that the UE 1 requesting symmetric communication channels between the UE 1 and the UE 2; the local policy and/or the subscription information of the UE 1 may indicate that it's allowed to provide symmetric communication channels for the UE 1; the resource of the base station may indicate that the base station has enough resource to provide symmetric communication channels for the UE 1; based on above information, the (R)AN 1 may determine radio bearer configuration information for the symmetric communication channels. In an example, based on above information, the (R)AN 1 may determine radio bearer configuration information of a data radio bearer for the symmetric communication channels. In an example, based on above information, the (R)AN 1 may determine at least one data radio bearer (DRB) and/or at least one signal radio bearer (SRB) for the symmetric communication channels.

In an example, the radio bearer configuration information may comprise the second parameter/Asymmetric End to End Latency indicating that the radio bearer configuration information may be applied to the symmetric communication channels. In an example, the radio bearer configuration information may comprise the second parameter/Asymmetric End to End Latency indicating that the radio bearer configuration information may be applied to a radio bearer for the symmetric communication channels. In an example, the second parameter/Asymmetric End to End Latency may indicate allowed (maximum) end to end latency asymmetry/difference between [the at least one uplink communication channel] and [the at least one downlink communication channel].

In an example, the radio bearer configuration information may comprise parameters for at least one DRB. In an example, the radio bearer configuration information may comprise parameters for at least one SRB. In an example, the radio bearer configuration information may comprise QoS parameters for at least one signal radio bearer and/or at least one data radio bearer for the symmetric communication channels.

In an example, the at least one data radio bearer may be used to transmit user plane data. In an example, the at least one signal radio bearer may be radio bearer(s) that is used for the transmission of RRC and/or NAS messages. In an example, the at least one signal radio bearer may comprise at least one of: SRB0, SRB1, SRB2, and/or SRB3. In an example, the SRB0 may be for RRC messages using a Common Control Channel (CCCH) logical channel. In an example, the SRB1 may be for RRC messages (which may comprise a piggybacked NAS message) as well as for NAS messages prior to establishment of SRB2, all using Dedicated Control Channel (DCCH) logical channel. In an example, the SRB2 may be for NAS messages and for RRC messages which comprise logged measurement information, all using DCCH logical channel. SRB2 may have a lower priority than SRB1 and may be configured by the network. In an example, the SRB3 may be for specific RRC messages when UE is in E-UTRA New Radio Dual Connectivity with E-UTRA connected to EPC ((NG)EN-DC) and/or New Radio Dual Connectivity (NR-DC), all using DCCH logical channel.

In an example, the QoS parameters for the at least one SRB and/or the at least one DRB may comprise at least one of: Resource type; priority level; Packet Delay Budget (PDB); Packet Error Rate (PER); Averaging window; Maximum Data Burst Volume; and/or the like. In an example, the Resource type may indicate resource for Non-Guaranteed Bit Rate (GBR), resource for GBR, and/or resource for Delay-critical GBR. In an example, the resource type may determine whether dedicated network resources are permanently allocated (e.g., by an admission control function in a radio base station). In an example, the priority level may indicate a priority in scheduling resources among DRB/SRB/QoS Flows. In an example, a lowest priority level value may indicate a highest priority. In an example, the Packet Delay Budget (PDB) may indicate an upper bound for the time that a packet may be delayed between a UE and another network function (e.g., UPF). In an example, the Packet Error Rate (PER) may indicate an upper bound for the rate of PDUs (e.g., IP packets) that have been processed by the sender of a link layer protocol (e.g., RLC in RAN of a 3GPP access) but that are not successfully delivered by the corresponding receiver to the upper layer (e.g., PDCP in RAN of a 3GPP access). The PER may define an upper bound for a rate of non-congestion related packet losses. In an example, each GBR QoS Flow may be associated with an Averaging window. The Averaging window may represent the duration over which the Guaranteed Flow Bit Rate (GFBR) and Maximum Flow Bit Rate (MFBR) may be calculated (e.g., in the (R)AN, UPF, UE). In an example, each GBR QoS Flow with Delay-critical resource type may be associated with a Maximum Data Burst Volume (MDBV). The MDBV may indicate the largest amount of data that a base station is required to serve within a period of 5G-AN PDB. For example, the (R)AN 1 may determine the QoS parameters for the at least one SRB and/or the at least one DRB for the symmetric communication channels, e.g., uplink end to end delay of the at least one DRB equal to downlink end to end delay of the at least one DRB. For example, the (R)AN 1 may determine the QoS parameters for the at least one SRB and/or the at least one DRB for the symmetric communication channels, e.g., to make sure that asymmetry/difference between the uplink end to end delay of the at least one DRB and the downlink end to end delay of the at least one DRB is less than and/or equal to a value. In an example, the at least one SRB and/or the at least one DRB may be between the UE 1 and the (R)AN 1.

In an example, the radio bearer configuration information may comprise parameters of SDAP configuration information. In an example, the SDAP configuration information may be used to set the configurable SDAP parameters for a data radio bearer. In an example, the SDAP configuration information may comprise at least one of the following information elements (IEs)/parameters: defaultDRB; mappedQoS-FlowsToAdd, FlowsToRelease, PDU session ID, and/or SDAP header information. In an example, the defaultDRB may indicate whether or not this is the default DRB for a PDU session identified by the PDU session ID. In an example, the mappedQoS-FlowsToAdd may indicate list of QoS flow IDs (QFIs) of uplink (UL) QoS flows of the PDU session to be additionally mapped to this DRB. A QFI value may be included at most once in all configured instances of SDAP-Config with the same PDU session ID. For QoS flow remapping, the QFI value of the remapped QoS flow may be only included in mappedQoS-FlowsToAdd in sdap-Config corresponding to the new DRB and not included in mappedQoS-FlowsToRelease in sdap-Config corresponding to the old DRB. In an example, the mappedQoS-FlowsToRelease may indicate list of QFIs of QoS flows of the PDU session to be released from existing QoS flow to DRB mapping of this DRB. In an example, the SDAP header information may indicate whether or not a SDAP header is present for uplink data and/or downlink data on this DRB.

In an example, the radio bearer configuration information may comprise parameters of PDCP configuration information. In an example, the PDCP configuration information may comprise at least one parameter: PDCP SN UL Size, PDCP SN DL Size, RLC mode, ROHC Parameters, UL Data Split Threshold, PDCP Duplication, PDCP Re-establishment, PDCP Data Recovery, Duplication Activation, Out Of Order Delivery, PDCP Status Report Indication, Additional PDCP duplication Information, EHC Parameters, and/or the like. In an example, the PDCP SN UL Size may indicate PDCP sequence number size (e.g. in bits) for uplink. The PDCP SN DL Size may indicate PDCP sequence number size (e.g. in bits) for downlink. The RLC mode may indicate the RLC mode for the DRB, for example, Acknowledged Mode (AM), Unacknowledged Mode (UM) and/or Transparent Mode (TM). The ROHC Parameters may indicate ROHC parameters for header compression. The UL Data Split Threshold may indicate the uplink data split threshold (e.g. in bytes). The PDCP Duplication may indicates whether PDCP duplication is to be configured for the DRB. The PDCP Re-establishment may indicate PDCP entity re-establishment to be triggered. The PDCP Data Recovery may indicate PDCP data recovery to be triggered. The Duplication Activation may comprise information on the initial state of DL PDCP duplication. Out Of Order Delivery may indicate whether or not outOfOrderDelivery specified is configured. Out of order delivery may be configured only when the radio bearer is established. The PDCP Status Report Indication may indicate PDCP Status Report. For example, For Acknowledged Mode DRB, “downlink” indicates that the PDCP entity is configured to send PDCP status report(s) to the UE, and “uplink” indicates that the UE is configured to send PDCP status report(s). The Additional PDCP duplication Information may indicate number of PDCP duplication configured when it is more than 2 for the DRB. The EHC Parameters may indicate Ethernet Header Compression parameters.

In an example, in response to the message received from the wireless device (e.g., UE 1), the base station (e.g., (R)AN 1) may determine RRC configuration information for the symmetric communication channels, based on at least one of: the determining that whether to accept the RRC request and/or requesting symmetric communication channels, the RRC request message, the resource of the base station, the local policy, and/or subscription information of the wireless device. For example, the (R)AN 1 may determine to accept the RRC request and/or the request of symmetric communication channels; the (R)AN 1 may determine the fourth parameter/Channel Symmetry Accept; the RRC request message may comprise the parameter/Channel Symmetry Request, the identity of the wireless device and/or the identity of the second wireless device; the RRC request message may indicate that the UE 1 requesting symmetric communication channels between the UE 1 and the UE 2; the local policy and/or the subscription information of the UE 1 may indicate that it's allowed to provide symmetric communication channels for the UE 1; the resource of the base station may indicate that the base station has enough resource to provide symmetric communication channels for the UE 1; based on above information, the (R)AN 1 may determine RRC configuration information for the symmetric communication channels. In an example, based on above information, the (R)AN 1 may determine RRC configuration information of at least one data radio bearer for the symmetric communication channels.

In an example, the RRC configuration information for the symmetric communication channels may comprise the radio bearer configuration information and/or logical channel configuration information for the symmetric communication channels. In an example, the RRC configuration information may comprise the second parameter/Asymmetric End to End Latency indicating that the RRC configuration information may be applied to the symmetric communication channels. In an example, the RRC configuration information may comprise the second parameter/Asymmetric End to End Latency indicating that the RRC configuration information may be applied to a radio bearer for the symmetric communication channels. In an example, the second parameter/Asymmetric End to End Latency may indicate allowed maximum end to end latency asymmetry/difference between [the at least one uplink communication channel] and [the at least one downlink communication channel]. In an example, the logical channel configuration information may comprise the second parameter/Asymmetric End to End Latency indicating that logical channel configuration information may be applied to the symmetric communication channels. In an example, logical channel configuration information may comprise the second parameter/Asymmetric End to End Latency indicating that the logical channel configuration information may be applied to a radio bearer for the symmetric communication channels. In an example, the second parameter/Asymmetric End to End Latency may indicate allowed end to end latency asymmetry/difference between [the at least one uplink communication channel] and [the at least one downlink communication channel].

In an example, the base station (e.g., (R)AN 1) may determine at least one logical channel for the symmetric communication channels, based on at least one of: the determining that whether to accept the RRC request and/or requesting symmetric communication channels, the RRC request message, the resource of the base station, the local policy, and/or subscription information of the wireless device. For example, the (R)AN 1 may determine the QoS parameters for the at least one logical channel for the symmetric communication channels, e.g., uplink end to end delay of the at least one logical channel equal to downlink end to end delay of the at least one logical channel. For example, the (R)AN 1 may determine the QoS parameters for the at least one logical channel for the symmetric communication channels, e.g., to make sure that asymmetry/difference between the uplink end to end delay of the at least one logical channel and the downlink end to end delay of the at least one logical channel is less than and/or equal to a value. In an example, the at least one logical channel may be between the UE 1 and the (R)AN 1.

In an example, the logical channel may indicate different kinds of data transfer services as offered by MAC. In an example, the logical channel may comprise Control Channels (e.g., for the transfer of control plane information) and/or Traffic Channels (e.g., for the transfer of user plane information). In an example, the control channel may comprise at least one of: Broadcast Control Channel (BCCH), Paging Control Channel (PCCH), Common Control Channel (CCCH), and/or Dedicated Control Channel (DCCH). In an example, the Traffic channel may comprise Dedicated Traffic Channel (DTCH).

In an example, the BCCH may be a downlink channel for broadcasting system control information. In an example, the PCCH may be a downlink channel that carries paging messages. In an example, the CCCH may be a channel for transmitting control information between UEs and network. This channel may be used for UEs having no RRC connection with the network. In an example, the DCCH may be a point-to-point bi-directional channel that transmits dedicated control information between a UE and the network. Used by UEs having an RRC connection. In an example, the DTCH may be a point-to-point channel, dedicated to one UE, for the transfer of user information. A DTCH may exist in both uplink and downlink.

In an example, the RRC configuration information (e.g., RRCReconfiguration) may comprise cell group configuration information (e.g., CellGroupConfig). In an example, the cell group configuration information (e.g., CellGroupConfig) may be used to configure a master cell group (MCG) and/or a secondary cell group (SCG). In an example, a cell group may comprise one Medium Access Control (MAC) entity, a set of logical channels associated with RLC entities, a primary cell (SpCell) and/or one or more secondary cells (SCells). In an example, the cell group configuration information (e.g., CellGroupConfig) may comprise Radio link control (RLC) bearer configuration information (e.g., RLC-BearerConfig). In an example, the RLC bearer configuration information (e.g., RLC-BearerConfig) may be used to configure an RLC entity, a corresponding logical channel in MAC and the linking to a PDCP entity (served radio bearer). In an example, the RLC bearer configuration information (e.g., RLC-BearerConfig) may comprise logical channel configuration information (e.g., LogicalChannelConfig). In an example, the logical channel configuration information (e.g., LogicalChannelConfig) may be used to configure logical channel parameters.

In an example, the logical channel configuration information (e.g., LogicalChannelConfig) may comprise at least one of following IEs/parameters: priority; prioritisedBitRate; bucketSizeDuration; allowedServingCells; allowedSCS-List; maxPUSCH-Duration; configuredGrantType1Allowed; logicalChannelGroup; schedulingRequestID; logicalChannelSR-Mask; logicalChannelSR-DelayTimerApplied; bitRateQueryProhibitTimer; allowedCG-List-r16; allowedPHY-PriorityIndex-r16; channelAccessPriority-r16; and/or bitRateMultiplier-r16.

In an example, the priority, the prioritisedBitRate, and/or the bucketSizeDuration may be used for Logical Channel Prioritization (LCP) procedure when a new transmission is performed (by MAC layer). In an example, the priority may indicate a logical channel priority per MAC entity. In an example, an increasing priority value may indicate a lower priority level. In an example, the prioritisedBitRate may set the Prioritized Bit Rate (PBR). In an example, the prioritisedBitRate value may be in kiloBytes/s. In an example, prioritisedBitRate value kBps0 may be corresponds to 0 kiloBytes/s, value kBps8 may be corresponds to 8 kiloBytes/s, and so on. For SRBs, the value may be set to infinity. In an example, the bucketSizeDuration may set the Bucket Size Duration (BSD). In an example, for the at least one uplink communication channel and the at least one downlink communication channel, the base station may set proper value (s) (e.g., higher priority, low latency) for the priority, the prioritisedBitRate, and/or the bucketSizeDuration.

In an example, the RRC configuration information and/or logical channel configuration information) may control the LCP procedure by configuring mapping restrictions for each logical channel. In an example, configuring mapping restrictions for each logical channel may use at least one of the following IEs/parameters: allowedSCS-List, maxPUSCH-Duration, configuredGrantType1Allowed, allowedServingCells, allowedCG-List, and/or allowedPHY-PriorityIndex. In an example, the allowedSCS-List may set allowed Subcarrier Spacing(s) for transmission. In an example, the maxPUSCH-Duration may set the maximum PUSCH duration allowed for transmission. In an example, the configuredGrantType1Allowed may set whether a configured grant Type 1 can be used for transmission. In an example, the allowedServingCells may set the allowed cell(s) for transmission. In an example, the allowedCG-List may set the allowed configured grant(s) for transmission. In an example, the allowedPHY-PriorityIndex may set the allowed PHY priority index(es) of a dynamic grant for transmission.

In an example, in response to the first message, the base station may send a second message (e.g., RRC response message) to the wireless device. In an example, the second message may indicate accepting the symmetric communication channels. In an example, the second message may comprise at least one of: the RRC configuration information for the symmetric communication channels, the radio bearer configuration information for the symmetric communication channels, the logical channel configuration information for the symmetric communication channels, the second parameter/Asymmetric End to End Latency, the third parameter/End to End Latency, and/or the fourth parameter/Channel Symmetry Accept.

In an example, the second message may comprise at least one of: an MSG 4; a RRCSetup message; a RRCResume message; a UEReconfiguration message; a UEInformationRequest message; a UECapabilityEnquiry message; and/or the like.

In response to the message received, the wireless device (e.g., UE 1) may take one or more actions. In an example action, the wireless device (e.g., UE 1) may allocate radio bearer/QoS resource for the symmetric communication channels based on at least one of: the RRC configuration information for the symmetric communication channels, the radio bearer configuration information for the symmetric communication channels, the logical channel configuration information for the symmetric communication channels, the second parameter/Asymmetric End to End Latency, the third parameter/End to End Latency, and/or the fourth parameter/Channel Symmetry Accept.

In an example action, the wireless device (e.g., UE 1) may establish at least one RRC connection for the symmetric communication channels. The RRC connection for the symmetric communication channels may be between the wireless device (e.g., UE 1) and the base station (e.g., (R)AN 1). The wireless device (e.g., UE 1) and the base station (e.g., (R)AN 1) may establish the RRC connection for the symmetric communication channels based on the procedure as shown in FIG. 15.

In an example action, the wireless device (e.g., UE 1) may establish at least one protocol data unit (PDU) session for the symmetric communication channels. The PDU session may be between the UE and a core network (e.g., core network 1 as shown in FIG. 19). The core network may comprise at least one of: AMF, SMF, UPF, PCF, and/or the like.

In an example, the radio bearer for the symmetric communication channels may be associated with the RRC connection for the symmetric communication channels. In an example, radio bearer and/or the RRC connection for the symmetric communication channels may be associated with the PDU session for the symmetric communication channels.

In an example, as shown in the FIG. 19, the second wireless device (e.g., UE 2) may take the similar actions as UE 1, and the second base station (e.g., (R)AN 2) may take the similar actions as (R)AN 1. For example, the UE 2 may send a first message to the (R)AN 2 and may receive a second message from the (R)AN 2, wherein the first message and/or the second message may be similar to the first message and/or the second message between UE 1 and (R)AN 1. For example, in response to receiving the first message, the (R)AN 2 may take similar actions as (R)AN 1. For example, the UE 2 may establish at least one RRC connection with (R)AN 2 for the symmetric communication channels. For example, the UE 2 may establish at least one PDU session with a second core network for the symmetric communication channels. In an example, the UE 1 and UE 2 may access to the same base station, e.g., (R)AN 1 and (R)AN 2 are same base station. In an example, the UE 1 and UE 2 may access to the same core network, e.g., the core network 1 and core network 2 are same core network.

In an example action, UE 1 and UE 2 may perform/run applications and/or services over the symmetric communication channels. For example, the Relay_a/UE 1 and Relay_b/UE 2 may perform/run channel-based alignment method for Line Current Differential Protection between the Relay_a/UE 1 and Relay_b/UE 2 over the symmetric communication channels (e.g., PDU session 1 and/or PDU session 2, QoS flows/service data flows, RRC connections, radio bearers). In an example, UE 1 and UE 2 may play games over the symmetric communication channels (e.g., PDU session 1 and/or PDU session 2, QoS flows/service data flows, RRC connections, radio bearers).

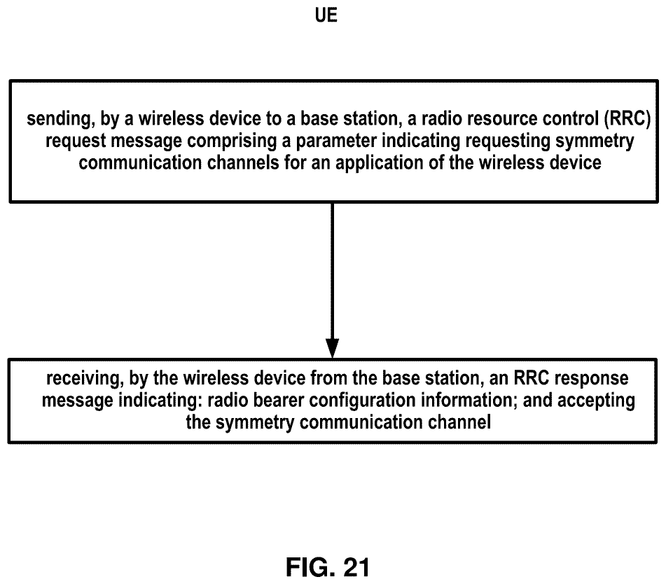

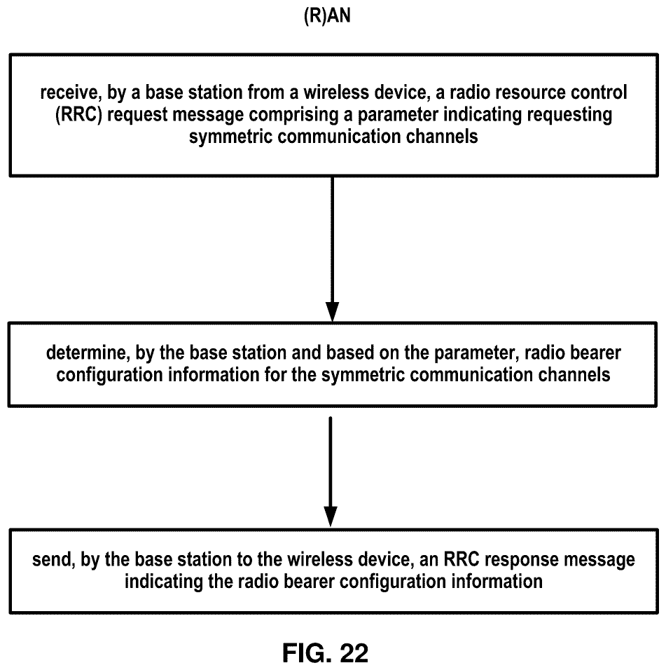

FIG. 20 is an example diagram depicting a RRCSetupRequest message as per an aspect of an embodiment of the present disclosure. FIG. 21 is an example diagram depicting the procedures of a wireless device as per an aspect of an embodiment of the present disclosure. FIG. 22 is an example diagram depicting the procedures of a base station as per an aspect of an embodiment of the present disclosure.

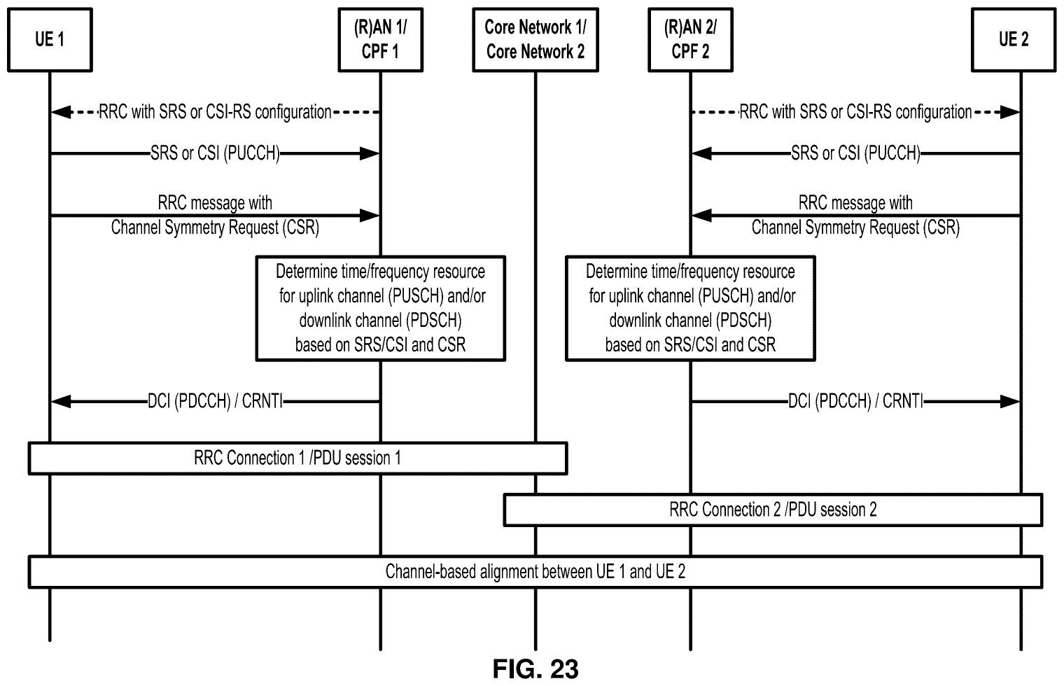

FIG. 23 is an example call flow which may comprise one or more actions. In an example, a base station (e.g., (R)AN 1 as shown in FIG. 23) may send a first message to a wireless device (e.g., UE, or UE 1 as shown in FIG. 23), wherein the first message may comprise Sounding Reference Signal (SRS) configuration parameters/information requesting SRS report from the wireless device. In an example, the first message may comprise Channel Status Information Reference Signal (CSI-RS) configuration requesting channel condition report from the wireless device.

In an example, the first message may comprise at least one of: a RRCReconfiguration message, an MSG 4; a RRCSetup message; a RRCResume message; a UEReconfiguration message; a UEInformationRequest message; a UECapabilityEnquiry message; a master information block (MIB) message, a system information block (SIB) message, a Random Access (RA) preamble assignment message, and/or the like.

For example, the base station may send a RRC configuration message (e.g., RRCReconfiguration), wherein the RRC configuration message (e.g., RRCReconfiguration) may comprise cell group configuration information (e.g., CellGroupConfig). In an example, the cell group configuration information (e.g., CellGroupConfig) may comprise serving cell configuration information (e.g., ServingCellConfig). In an example, the serving cell configuration information (e.g., ServingCellConfig) may comprise uplink configuration information (e.g., UplinkConfig). In an example, the uplink configuration information (e.g., UplinkConfig) may comprise bandwidth part (BWP)-UplinkDedicated, and the BWP-UplinkDedicated may comprise SRS configuration information (e.g., SRS-Config).

In an example, the base station may semi-statically configure/send the UE with one or more SRS configuration parameters indicating at least one of following: a SRS resource configuration identifier; a number of SRS ports; time domain behavior of an SRS resource configuration (e.g., an indication of periodic, semi-persistent, or aperiodic SRS); slot, mini-slot, and/or subframe level periodicity; offset for a periodic and/or an aperiodic SRS resource; a number of OFDM symbols in an SRS resource; a starting OFDM symbol of an SRS resource; an SRS bandwidth; a frequency hopping bandwidth; a cyclic shift; and/or an SRS sequence ID.

In an example, the base station (e.g., (R)AN 1) may send the CSI-RS to the wireless device (e.g., UE 1) and the CSI-RS may be used by the UE 1 to acquire channel state information (CSI). The base station may configure the UE 1 with one or more CSI-RSs for channel estimation or any other suitable purpose. The base station may configure the UE 1 with one or more of the same/similar CSI-RSs. In an example, the base station may semi-statically configure the UE 1 with one or more CSI-RS resource sets. A CSI-RS resource may be associated with a location in the time and frequency domains and a periodicity. The base station may selectively activate and/or deactivate a CSI-RS resource. The base station may indicate to the UE 1 that a CSI-RS resource in the CSI-RS resource set is activated and/or deactivated. The base station may configure the UE 1 to report CSI measurements. The base station may configure the UE 1 to provide CSI reports periodically, aperiodically, or semi-persistently. For periodic CSI reporting, the UE 1 may be configured with a timing and/or periodicity of a plurality of CSI reports. For aperiodic CSI reporting, the base station may request a CSI report. For example, the base station may command the UE 1 to measure a configured CSI-RS resource and provide a CSI report relating to the measurements. For semi-persistent CSI reporting, the base station may configure the UE 1 to transmit periodically, and selectively activate or deactivate the periodic reporting. The base station may configure the UE with a CSI-RS resource set and CSI reports using RRC signaling. In an example, the CSI-RS configuration may comprise one or more parameters indicating, for example, up to 32 antenna ports. The UE 1 may be configured to employ the same OFDM symbols for a downlink CSI-RS and a control resource set (CORESET) when the downlink CSI-RS and CORESET are spatially QCLed and resource elements associated with the downlink CSI-RS are outside of the physical resource blocks (PRBs) configured for the CORESET. The UE 1 may be configured to employ the same OFDM symbols for downlink CSI-RS and SS/PBCH blocks when the downlink CSI-RS and SS/PBCH blocks are spatially QCLed and resource elements associated with the downlink CSI-RS are outside of PRBs configured for the SS/PBCH blocks.

In response to the message received, the wireless device may perform SRS measurements and/or CSI measurements. In an example, the UE 1 may measure the one or more CSI-RSs. The UE 1 may estimate a downlink channel state and/or generate a CSI report based on the measuring of the one or more downlink CSI-RSs.

In an example, the wireless device may send the SRS measurements report and/or the CSI (measurements) report to the base station. In an example, the SRS (measurements report) may be transmitted by the UE 1 to the (R)AN 1 for channel state estimation to support uplink channel dependent scheduling and/or link adaptation.

In an example, the base station (e.g., (R)AN 1) may receive a second message (e.g., a RRC request message) from the wireless device (e.g., UE 1). The second message may comprise a parameter (e.g., Channel Symmetry Request) indicating requesting symmetric communication channels. In an example, the second message may comprise a second parameter (e.g., Asymmetric End to End Latency) indicating requesting maximum end to end latency asymmetry/difference between [the at least one uplink communication channel] and [the at least one downlink communication channel] is less than and/or equal to a value (e.g., 2 ms). In an example, the RRC request message comprises a third parameter (e.g., End to End Latency) indicating requesting end to end latency between two network elements is less than and/or equal to a value (e.g., 5 ms, 10 ms). In an example, the second message may comprise an identity of the wireless device (e.g., UE 1) and/or an identity of a second wireless device (e.g., UE 2 as shown in FIG. 23). In an example, the definition/content of the parameter/Channel Symmetry Request may be similar to the definition/content of the parameter/Channel Symmetry Request as described in FIG. 19. For brevity, further description will not be repeated here. In an example, the definition/content of the second parameter/Asymmetric End to End Latency may be similar to the definition/content of the second parameter/Asymmetric End to End Latency as described in the FIG. 19. For brevity, further description will not be repeated here. In an example, the definition/content of the third parameter/End to End Latency may be similar to the definition/content of the third parameter/End to End Latency as described in the FIG. 19. For brevity, further description will not be repeated here. In an example, the definition/content of the identity of the UE 1 and/or UE 2 may be similar to the definition/content of the identity of the UE 1 and/or UE 2 as described in the FIG. 19. For brevity, further description will not be repeated here.

In an example, in response to the message received, the base station may determine time and/or frequency resource for the symmetry communication channels based on at least one of: the SRS measurements report, the CSI (measurements) report, the second message, the resource of the base station; local policy; and/or subscription information of the wireless device. For example, the base station may determine time and/or frequency resource for the symmetry communication channels based on at least one of: the SRS measurements report, the CSI (measurements) report, the parameter/Channel Symmetry Request, the second parameter/Asymmetric End to End Latency, the third parameter/End to End Latency, the resource of the base station; local policy; and/or subscription information of the wireless device.

In an example, the symmetry communication channels may comprise at least one uplink communication channel and/or at least one downlink communication channel. In an example, at least one uplink communication channel may comprise at least one uplink physical channel, e.g., physical uplink control channel (PUCCH) and/or physical uplink shared channel (PUSCH). In an example, the at least one downlink communication channel may comprise at least one downlink physical channel, e.g., physical downlink control channel (PDCCH) and/or physical downlink shared channel (PDSCH).

In an example, the SRS (measurements report) transmitted by the UE 1 may allow the (R)AN 1 to estimate an uplink channel state at one or more frequencies. The CSI (measurements) report transmitted by the UE 1 may allow the (R)AN 1 to estimate a downlink channel state at one or more frequencies. In an example, the parameter/Channel Symmetry Request and/or the identity of the UE 1 may indicate requesting symmetric communication channels between the UE 1 and the (R)AN 1. In an example, the parameter/Channel Symmetry Request, the identity of the UE 1 and the identity of the UE 2 may indicate requesting symmetric communication channels between the UE 1 and the UE 2. The second parameter/Asymmetric End to End Latency may indicate a requested end to end latency asymmetry/difference between [the at least one uplink communication channel] and [the at least one downlink communication channel] is less than 2 ms, wherein the at least one uplink communication channel and/or the at least one downlink communication channel is between the UE 1 and the UE 2. The third parameter/End to End Latency may indicate a requested end to end latency between UE 1 and UE 2 is equal to 5 ms. There is resource in the base station to support the symmetric communication channels. The local policy and/or the subscription information of the wireless device may indicate that the symmetric communication channels is allowed. Based on above information, the (R)AN 1 may determine time and/or frequency resource for the symmetry communication channels. For example, in order to support the symmetry communication channels between the UE 1 and the UE 2 and/or the symmetry communication channels between the UE 1 and the (R)AN 1, considering the SRS (measurements report) and/or the CSI (measurements) report, the (R)AN 1 may determine time and/or frequency resource for the symmetry communication channels. For example, the (R)AN 1 may determine time resource for the symmetry communication channels by allocating proper time slots for at least one uplink communication channel (e.g., PUSCH) and/or at least one downlink communication channel (e.g., PDSCH). For example, the (R)AN 1 may determine frequency resource for the symmetry communication channels by allocating proper resource blocks (RBs) and/or the corresponding bandwidth part (BWP). In an example, the BWP may comprise set of resource blocks (RBs) on a given carrier. In an example, the resource block (RB) may indicate the smallest unit of resources that can be allocated to a user. In an example, the RB may comprise 12 consecutive subcarriers in the frequency domain. In an example, based on the SRS (measurements report) and/or the CSI (measurements) report, the (R)AN 1 may determine frequency resource for the symmetry communication channels by allocating proper frequency band and/or carrier frequency for the symmetry communication channels. In an example, to support the symmetry communication channels, the (R)AN 1 may determine proper channel coding, modulation for the at least one uplink communication channel (e.g., PUSCH) and/or the at least one downlink communication channel (e.g., PDSCH).

In an example, the SRS (measurements report) transmitted by the UE 1 may allow the base station to estimate an uplink channel state at one or more frequencies. A scheduler at the base station may employ the estimated uplink channel state to assign one or more resource blocks for an uplink PUSCH transmission from the UE 1. The base station may semi-statically configure the UE 1 with one or more SRS resource sets. For an SRS resource set, the base station may configure the UE 1 with one or more SRS resources. An SRS resource set applicability may be configured by a higher layer (e.g., RRC) parameter. For example, when a higher layer parameter indicates beam management, an SRS resource in a SRS resource set of the one or more SRS resource sets (e.g., with the same/similar time domain behavior, periodic, aperiodic, and/or the like) may be transmitted at a time instant (e.g., simultaneously). The UE 1 may transmit one or more SRS resources in SRS resource sets. An NR network may support aperiodic, periodic and/or semi-persistent SRS transmissions. The UE 1 may transmit SRS resources based on one or more trigger types, wherein the one or more trigger types may comprise higher layer signaling (e.g., RRC) and/or one or more DCI formats. In an example, at least one DCI format may be employed for the UE 1 to select at least one of one or more configured SRS resource sets. An SRS trigger type 0 may refer to an SRS triggered based on a higher layer signaling. An SRS trigger type 1 may refer to an SRS triggered based on one or more DCI formats. In an example, when PUSCH and SRS are transmitted in a same slot, the UE 1 may be configured to transmit SRS after a transmission of a PUSCH and a corresponding uplink DMRS. In an example, the UE 1 may provide the CSI report to the base station. The base station may use feedback provided by the UE 1 (e.g., the estimated downlink channel state) to perform link adaptation.

In an example, the base station may send a third message to the wireless device, the third message may comprise at least one of: a Downlink Control Information (DCI), and/or a Cell Radio Network Temporary Identifier (C-RNTI). In an example, the third message may be a MAC layer message. In an example, the third message may be an RRC message. In an example, the third message may be a physical layer message. In an example, the base station may send the third message to the wireless device via a PDCCH. In an example, the DCI may indicate time and/or frequency resource for the symmetry communication channels. In an example, the C-RNTI may indicate a RRC Connection and scheduling, wherein the RRC Connection and scheduling are dedicated to the wireless device. In an example, the third message and/or the DCI may indicate an allowed end to end latency asymmetry/difference between the at least one uplink communication channel (e.g., PUSCH) and the at least one downlink communication channel (e.g., PDSCH) is less than and/or equal to a value (e.g., 2 ms). In an example, the third message and/or the DCI may indicate an allowed end to end latency between two network elements (e.g., between the UE 1 and the UE2, between the UE 1 and the (R)AN 1) is less than and/or equal to a value (e.g., 5 ms, 10 ms).

In an example, the downlink control signaling may comprise: a downlink scheduling assignment; an uplink scheduling grant indicating uplink radio resources and/or a transport format; a slot format information; a preemption indication; a power control command; and/or any other suitable signaling. The UE may receive the downlink control signaling in a payload transmitted by the base station on a physical downlink control channel (PDCCH). The payload transmitted on the PDCCH may be referred to as downlink control information (DCI). In some scenarios, the PDCCH may be a group common PDCCH (GC-PDCCH) that is common to a group of UEs.

In an example, a base station may attach one or more cyclic redundancy check (CRC) parity bits to a DCI in order to facilitate detection of transmission errors. When the DCI is intended for a UE (or a group of the UEs), the base station may scramble the CRC parity bits with an identifier of the UE (or an identifier of the group of the UEs). Scrambling the CRC parity bits with the identifier may comprise Modulo-2 addition (or an exclusive OR operation) of the identifier value and the CRC parity bits. The identifier may comprise a 16-bit value of a radio network temporary identifier (RNTI).

In an example, DCIs may be used for different purposes. A purpose may be indicated by the type of RNTI used to scramble the CRC parity bits. For example, a DCI having CRC parity bits scrambled with a paging RNTI (P-RNTI) may indicate paging information and/or a system information change notification. The P-RNTI may be predefined as “FFFE” in hexadecimal. A DCI having CRC parity bits scrambled with a system information RNTI (SI-RNTI) may indicate a broadcast transmission of the system information. The SI-RNTI may be predefined as “FFFF” in hexadecimal. A DCI having CRC parity bits scrambled with a random access RNTI (RA-RNTI) may indicate a random access response (RAR). A DCI having CRC parity bits scrambled with a cell RNTI (C-RNTI) may indicate a dynamically scheduled unicast transmission and/or a triggering of PDCCH-ordered random access. A DCI having CRC parity bits scrambled with a temporary cell RNTI (TC-RNTI) may indicate a contention resolution (e.g., a MSG 3). Other RNTIs configured to the UE by a base station may comprise a Configured Scheduling RNTI (CS-RNTI), a Transmit Power Control-PUCCH RNTI (TPC-PUCCH-RNTI), a Transmit Power Control-PUSCH RNTI (TPC-PUSCH-RNTI), a Transmit Power Control-SRS RNTI (TPC-SRS-RNTI), an Interruption RNTI (INT-RNTI), a Slot Format Indication RNTI (SFI-RNTI), a Semi-Persistent CSI RNTI (SP-CSI-RNTI), a Modulation and Coding Scheme Cell RNTI (MCS-C-RNTI), and/or the like. In an example, depending on the purpose and/or content of a DCI, the base station may transmit the DCIs with one or more DCI formats. For example, DCI format 0_0 may be used for scheduling of PUSCH in a cell. DCI format 0_0 may be a fallback DCI format (e.g., with compact DCI payloads). DCI format 0_1 may be used for scheduling of PUSCH in a cell (e.g., with more DCI payloads than DCI format 0_0). DCI format 1_0 may be used for scheduling of PDSCH in a cell. DCI format 1_0 may be a fallback DCI format (e.g., with compact DCI payloads). DCI format 1_1 may be used for scheduling of PDSCH in a cell (e.g., with more DCI payloads than DCI format 1_0). DCI format 2_0 may be used for providing a slot format indication to a group of UEs. DCI format 2_1 may be used for notifying a group of UEs of a physical resource block and/or OFDM symbol where the UE may assume no transmission is intended to the UE. DCI format 22 may be used for transmission of a transmit power control (TPC) command for PUCCH or PUSCH. DCI format 23 may be used for transmission of a group of TPC commands for SRS transmissions by one or more UEs. DCI format(s) for new functions may be defined in future releases. DCI formats may have different DCI sizes, or may share the same DCI size.

After scrambling a DCI with a RNTI, the base station may process the DCI with channel coding (e.g., polar coding), rate matching, scrambling and/or QPSK modulation. A base station may map the coded and modulated DCI on resource elements used and/or configured for a PDCCH. Based on a payload size of the DCI and/or a coverage of the base station, the base station may transmit the DCI via a PDCCH occupying a number of contiguous control channel elements (CCEs). The number of the contiguous CCEs (referred to as aggregation level) may be 1, 2, 4, 8, 16, and/or any other suitable number. A CCE may comprise a number (e.g., 6) of resource-element groups (REGs). A REG may comprise a resource block in an OFDM symbol. The mapping of the coded and modulated DCI on the resource elements may be based on mapping of CCEs and REGs (e.g., CCE-to-REG mapping).

In an example action, the wireless device (e.g., UE 1) may establish at least one RRC connection for the symmetric communication channels. The RRC connection for the symmetric communication channels may be between the wireless device (e.g., UE 1) and the base station (e.g., (R)AN 1). The wireless device (e.g., UE 1) and the base station (e.g., (R)AN 1) may establish the RRC connection for the symmetric communication channels based on the procedure as shown in FIG. 15.

In an example action, the wireless device (e.g., UE 1) may establish at least one protocol data unit (PDU) session for the symmetric communication channels. The PDU session may be between the UE and a core network (e.g., core network 1 as shown in FIG. 19). The core network may comprise at least one of: AMF, SMF, UPF, PCF, and/or the like.

In an example, the at least one uplink communication channel and/or the at least one downlink communication channel may be associated with the RRC connection. In an example, the RRC connection for the symmetric communication channels may be associated with the PDU session for the symmetric communication channels.

In an example, as shown in the FIG. 23, the second wireless device (e.g., UE 2) may take the similar actions as UE 1 as described above, and the second base station (e.g., (R)AN 2) may take the similar actions as (R)AN 1 as described above. For example, the (R)AN 2 may determine time and/or frequency resource for the symmetry communication channels based on at least one of: the SRS measurements report, the CSI (measurements) report, the second message, the resource of the base station; local policy; and/or subscription information of the wireless device. For example, the UE 2 may establish at least one RRC connection with (R)AN 2 for the symmetric communication channels. For example, the UE 2 may establish at least one PDU session with a second core network for the symmetric communication channels. In an example, the UE 1 and UE 2 may access to the same base station, e.g., (R)AN 1 and (R)AN 2 are same base station. In an example, the UE 1 and UE 2 may access to the same core network, e.g., the core network 1 and core network 2 are same core network.

In an example action, UE 1 and UE 2 may perform/run applications and/or services over the symmetric communication channels. For example, the Relay_a/UE 1 and Relay_b/UE 2 may perform/run channel-based alignment method for Line Current Differential Protection between the Relay_a/UE 1 and Relay_b/UE 2 over the symmetric communication channels (e.g., PDU session 1 and/or PDU session 2, QoS flows/service data flows, RRC connections, radio bearers). In an example, UE 1 and UE 2 may play games over the symmetric communication channels (e.g., PDU session 1 and/or PDU session 2, QoS flows/service data flows, RRC connections, radio bearers).

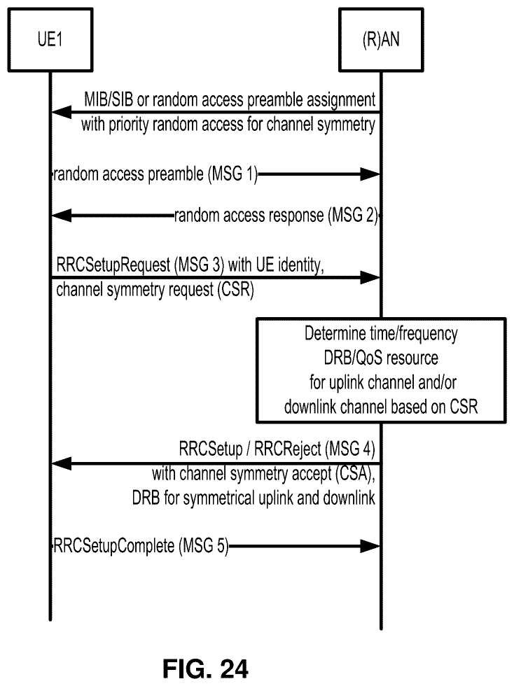

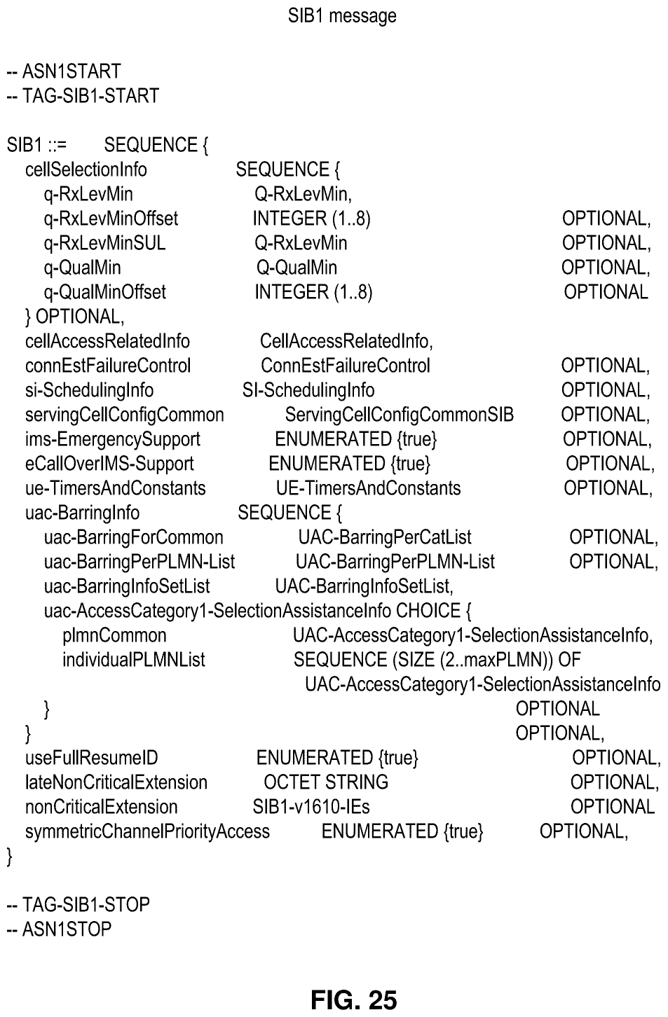

FIG. 24 is an example call flow which may comprise one or more actions. In an example, a base station (e.g., (R)AN) may send a first message (e.g., master information block (MIB), system information block (SIB), and/or Random Access (RA) preamble assignment) to the wireless device, wherein the first message may comprise a parameter indicating priority random access for symmetry communication channels for an application of the wireless device. In an example, the symmetry communication channels may be between the UE and the base station. In an example, the symmetry communication channels may be between two wireless devices. The content/definition of the symmetry communication channels may be similar to the content/definition of the symmetry communication channels as described in FIG. 19. For brevity, further description will not be repeated here. In an example, the (R)AN may send a MIB and/or a SIB message to one or more UEs in one or more cells, and the MIB and/or SIB message may comprise a parameter indicating supporting priority random access for symmetry communication channels. In an example, the priority random access for symmetry communication channels may indicate a wireless device has a higher priority of random access to the network for symmetry communication channels than other wireless device (s) which does not request symmetry communication channels. In an example, supporting priority random access for symmetry communication channels may indicate a wireless device may request a prioritized RRC connection for the symmetry communication channels than other wireless device (s). In an example, the MIB and/or SIB message may comprise parameters of powerRampingStepHighPriority and/or scalingFactorBI indicating priority random access for symmetry communication channels, e.g., in order to reduce the latency of priority random access for the symmetry communication channels. In an example, SIB1 message may comprise a parameter (e.g., symmetricChannelPriorityAccess as shown in FIG. 25) indicating priority random access for symmetry communication channels. In an example, the SIB1 message may comprise an IE/parameter ServingCellConfigCommon, and the ServingCellConfigCommon may comprise the parameter/symmetricChannelPriorityAccess. In an example, the ServingCellConfigCommon may comprise an IE/parameter uplinkConfigCommon, and the uplinkConfigCommon may comprise the parameter/symmetricChannelPriorityAccess.

In an example, the wireless device may be in idle state or inactive state. In response to the first message received, the wireless device may determine a 4 step random access procedure or a 2 step random access procedure. In an example, the wireless device may determine a 4 step random access procedure. The wireless device may send at least one random access preamble (e.g., MSG1) to the base station. For example, the wireless device may send at least one random access preamble based on the parameter(s) of the first message received from the base station. In an example, the at least one random access preamble may comprise a random access radio network temporary identifier (RA-RNTI). In response to the random access preamble received, the base station may send a random access response (e.g., MSG2) to the wireless device. In an example, the random access response may comprise a random access preamble identifier. In an example, the random access response may comprise the RA-RNTI.

In an example, in response to the message received, the wireless device may send a radio resource control (RRC) request message to the base station. For a 4 step random access procedure, the RRC request message may be an MSG 3. In an example, the RRC request message/MSG 3 may be a RRCSetupRequest message. In an example, the RRC request message/MSG 3 may be a RRCResumeRequest message. In an example, the wireless device may determine a 2 step random access procedure. For the 2 step random access procedure, the wireless device may send an MSG A to the base station. The RRC request message may request an RRC connection of the wireless device. In an example, the RRC request message/MSG 3/MSG A may comprise at least one of the following IEs/parameters: a parameter (e.g., Channel Symmetry Request) indicating requesting symmetric communication channels; a second parameter (e.g., Asymmetric End to End Latency) indicating requesting maximum end to end latency asymmetry/difference between [the at least one uplink communication channel] and [the at least one downlink communication channel] is less than and/or equal to a value (e.g., 2 ms); a third parameter (e.g., End to End Latency) indicating requesting end to end latency between two network elements is less than and/or equal to a value (e.g., 5 ms, 10 ms); an identity of the wireless device (e.g., UE 1); and/or an identity of a second wireless device (e.g., UE 2). In an example, the definition/content of the parameter/Channel Symmetry Request may be similar to the definition/content of the parameter/Channel Symmetry Request as described in FIG. 19. In an example, the definition/content of the second parameter/Asymmetric End to End Latency may be similar to the definition/content of the second parameter/Asymmetric End to End Latency as described in the FIG. 19. In an example, the definition/content of the third parameter/End to End Latency may be similar to the definition/content of the third parameter/End to End Latency as described in the FIG. 19. In an example, the definition/content of the identity of the UE 1 and/or UE 2 may be similar to the definition/content of the identity of the UE 1 and/or UE 2 as described in the FIG. 19. For brevity, further description will not be repeated here.

In an example, the parameter/Channel Symmetry Request and/or the identity of the wireless device may indicate requesting symmetric communication channels between the wireless device and the base station. In an example, the parameter/Channel Symmetry Request, the identity of the UE 1 and the identity of the UE 2 may indicate requesting symmetric communication channels between the UE 1 and the UE 2. In an example, the parameter/Channel Symmetry Request may indicate UE requesting priority random access for symmetry communication channels. In an example, the parameter/Channel Symmetry Request may indicate UE requesting a prioritized RRC connection for symmetry communication channels. In an example, the RRCSetupRequest message may comprise an establishment cause parameter, and the establishment cause parameter may comprise the parameter (e.g., channelSymmetryRequest) indicating: UE requesting priority random access for symmetry communication channels, and/or UE requesting a prioritized RRC connection for symmetry communication channels. In an example, the identity of the wireless device may indicate that the UE requesting priority random access for symmetry communication channels, and/or UE requesting a prioritized RRC connection for symmetry communication channels.

In an example, the RRCSetupRequest message may comprise an establishment cause parameter, and the establishment cause parameter may comprise one or more parameters: emergency, highPriorityAccess, Mcs-PriorityAccess, Mps-PriorityAccess, mt-Access, mo-Signalling, mo-Data, mo-VoiceCall, mo-VideoCall, and/or mo-SMS.

In an example, the RRCResumeRequest message may comprise a resume cause parameter, and the resume cause parameter may comprise one or more parameters: emergency, highPriorityAccess, mps-PriorityAccess, mcs-PriorityAccess, mt-Access, mo-Signalling, mo-Data, mo-VoiceCall, mo-VideoCall, mo-SMS, and/or ma-Update.

In an example, in response to the RRC message, the base station may take one or more actions. In an example, in response to the message received from the wireless device, the base station may determine whether to accept the RRC request and/or requesting symmetric communication channels, based on at least one of: the RRC request message, resource of the base station, local policy, and/or subscription information of the wireless device. In an example, based on the base station determining whether to accept the RRC request and/or requesting symmetric communication channels, the base station may determine a fourth parameter (e.g., Channel Symmetry Accept) indicating accepting the RRC request and/or the request of symmetric communication channels. In an example, the base station may determine radio bearer and/or QoS resource for the symmetric communication channels, based on at least one of: the determining that whether to accept the RRC request and/or requesting symmetric communication channels, the RRC request message, the resource of the base station, the local policy, and/or subscription information of the wireless device. In an example, the radio bearer may comprise at least one data radio bearer (DRB) and/or at least one signal radio bearer (SRB). In an example, the base station (e.g., (R)AN 1) may determine radio bearer configuration information for the symmetric communication channels, based on at least one of: the determining that whether to accept the RRC request and/or requesting symmetric communication channels, the RRC request message, the resource of the base station, the local policy, and/or subscription information of the wireless device. In an example, the base station may determine the at least one data radio bearer (DRB) and/or the at least one signal radio bearer (SRB) for the symmetric communication channels, based on at least one of: the determining that whether to accept the RRC request and/or requesting symmetric communication channels, the RRC request message, the resource of the base station, the local policy, and/or subscription information of the wireless device. In an example, the base station may determine RRC configuration information for the symmetric communication channels, based on at least one of: the determining that whether to accept the RRC request and/or requesting symmetric communication channels, the RRC request message, the resource of the base station, the local policy, and/or subscription information of the wireless device. In an example, the base station may determine at least one logical channel for the symmetric communication channels, based on at least one of: the determining that whether to accept the RRC request and/or requesting symmetric communication channels, the RRC request message, the resource of the base station, the local policy, and/or subscription information of the wireless device. The above actions of the base station may be similar to the actions of the base station as described in FIG. 19. For brevity, further description will not be repeated here.

In an example, in response to the message received, the base station may determine time and/or frequency resource for the symmetry communication channels based on at least one of: SRS measurements report and/or CSI (measurements) report from the wireless device, the RRC request message, the resource of the base station; the local policy; and/or the subscription information of the wireless device. The above actions of the base station may be similar to the actions of the base station as described in FIG. 23. For brevity, further description will not be repeated here.

In an example action, in response to the RRC request message, the base station may send a RRC response message to the wireless device. In an example, for the 4 step random access procedure, the RRC response message may be an MSG 4. In an example, the RRC response message/MSG 4 may be a RRCSetup message. In an example, the RRC response message/MSG 4 may be a RRCResume message. In an example, for the 4 step random access procedure, the RRC response message may be an MSG B.

In an example, the RRC response message may indicate accepting the symmetric communication channels. In an example, the RRC response message may comprise at least one of: the RRC configuration information for the symmetric communication channels, the radio bearer configuration information for the symmetric communication channels, the logical channel configuration information for the symmetric communication channels, the second parameter/Asymmetric End to End Latency, the third parameter/End to End Latency, and/or the fourth parameter/Channel Symmetry Accept. In an example, the RRC response message may indicate reject the RRC request.

In an example, in response to receiving the RRC response message, the wireless device may take one or more actions. In an example action, the wireless device may send an MSG 5 to the base station. In an example, the MSG 5 may be a RRC complete message. For example, the wireless device may send a RRCSetupComplete message to the base station, the RRCSetupComplete message may be used to confirm the successful completion of an RRC connection establishment, wherein the RRC connection may be used for the symmetric communication channels. For example, the wireless device may send a RRCResumeComplete message to the base station. The RRCResumeComplete message may be used to confirm the successful completion of an RRC connection resumption, wherein the RRC connection may be used for the symmetric communication channels.

In an example action, the wireless device may allocate radio bearer/QoS resource for the symmetric communication channels based on at least one of: the RRC configuration information for the symmetric communication channels, the radio bearer configuration information for the symmetric communication channels, the logical channel configuration information for the symmetric communication channels, the second parameter/Asymmetric End to End Latency, the third parameter/End to End Latency, and/or the fourth parameter/Channel Symmetry Accept.

In an example action, the wireless device may establish at least one protocol data unit (PDU) session for the symmetric communication channels. The PDU session may be between the UE and a core network. The core network may comprise at least one of: AMF, SMF, UPF, PCF, and/or the like.

In an example, the radio bearer for the symmetric communication channels may be associated with the RRC connection for the symmetric communication channels. In an example, radio bearer and/or the RRC connection for the symmetric communication channels may be associated with the PDU session for the symmetric communication channels.

In an example action, the wireless device may perform/run applications and/or services over the symmetric communication channels. For example, the UE may perform/run channel-based alignment method for Line Current Differential Protection over the symmetric communication channels (e.g., PDU session, QoS flows/service data flows, RRC connections, radio bearers). In an example, the wireless device may play games over the symmetric communication channels.

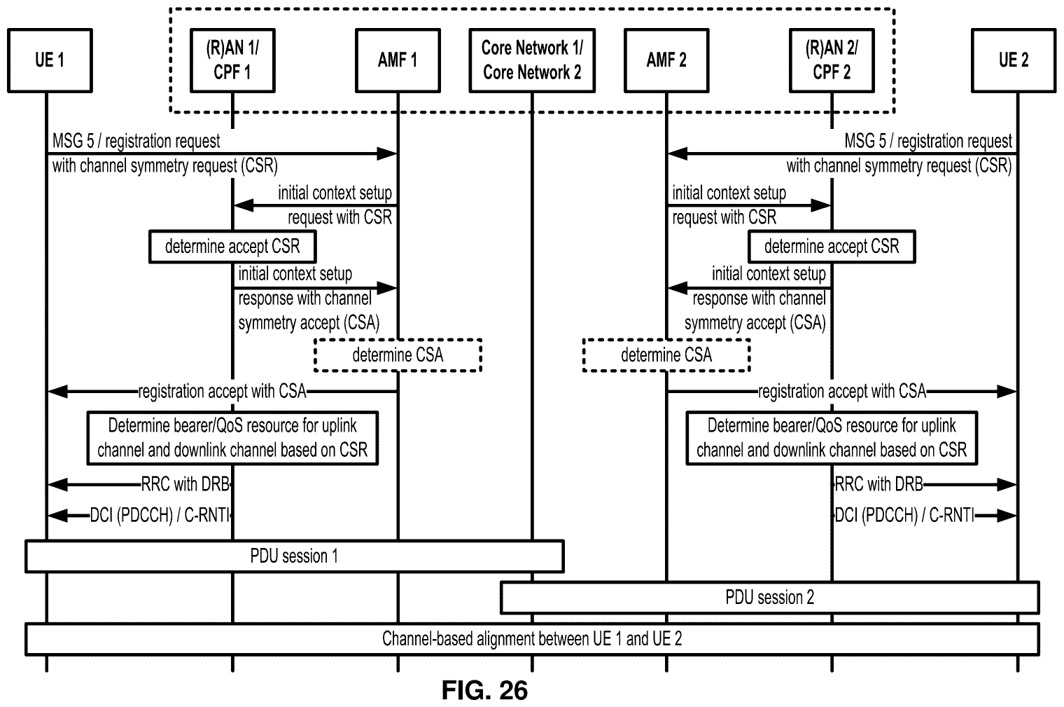

FIG. 26 is an example call flow which may comprise one or more actions. In an example, an AMF (e.g., AMF 1 as shown in FIG. 26) may receive a first message from a wireless device (e.g., UE 1 as shown in FIG. 26), the first message may comprise a parameter indicating requesting symmetric communication channels for an application/service of the wireless device. In an example, the first message may be a NAS message (e.g., registration request) and/or an RRC MSG 5 (e.g., RRCSetupComplete). For example, the first message may be an RRC RRCSetupComplete comprising a registration request message. In an example, the UE 1 may send the NAS message via a base station (e.g., (R)AN 1 as shown in FIG. 26). In an example, the definition/content of the symmetric communication channels may be similar to the definition/content of the symmetric communication channels as described in FIG. 19. For brevity, further description will not be repeated here.

In an example, the first message may comprise at least one of the following IEs/parameters: a parameter (e.g., Channel Symmetry Request) indicating requesting symmetric communication channels; a second parameter (e.g., Asymmetric End to End Latency) indicating requesting maximum end to end latency asymmetry/difference between [at least one uplink communication channel] and [at least one downlink communication channel] is less than and/or equal to a value (e.g., 2 ms); a third parameter (e.g., End to End Latency) indicating requesting end to end latency between two network elements is less than and/or equal to a value (e.g., 5 ms, 10 ms); an identity of the wireless device (e.g., UE 1); and/or an identity of a second wireless device (e.g., UE 2). In an example, the definition/content of the parameter/Channel Symmetry Request may be similar to the definition/content of the parameter/Channel Symmetry Request as described in FIG. 19. In an example, the definition/content of the second parameter/Asymmetric End to End Latency may be similar to the definition/content of the second parameter/Asymmetric End to End Latency as described in the FIG. 19. In an example, the definition/content of the third parameter/End to End Latency may be similar to the definition/content of the third parameter/End to End Latency as described in the FIG. 19. In an example, the definition/content of the identity of the UE 1 and/or UE 2 may be similar to the definition/content of the identity of th e UE 1 and/or UE 2 as described in the FIG. 19. For brevity, further description will not be repeated here. In an example, the parameter/Channel Symmetry Request and/or the identity of the UE 1 may indicate requesting symmetric communication channels between the UE 1 and the (R)AN 1. In an example, the parameter/Channel Symmetry Request, the identity of the UE 1 and the identity of the UE 2 may indicate requesting symmetric communication channels between the UE 1 and the UE 2.

In an example, the registration request message may comprise at least one of: registration type, UE identity (e.g., SUCI, SUPI and/or 5G-GUTI), last visited TAI (if available), security parameters, requested NSSAI, mapping of requested NSSAI, UE 5GC capability, PDU session status, PDU session(s) to be re-activated, Follow on request, MICO mode preference, and/or the like.

In response to the message, the AMF may take one or more actions. In an example action, the AMF may send a second message to the base station. In an example, the second message may comprise the IEs/parameters received from the first message. In an example, the second message may comprise PDU session configuration information associated with the symmetric communication channels. In an example, the second message may comprise a fourth parameter (e.g., Channel Symmetry Accept) indicating the AMF accepts the symmetric communication channels. For example, the AMF 1 may send an Initial Context Setup Request message to the (R)AN 1, the Initial Context Setup Request message may comprise at least one of: the parameter/Channel Symmetry Request; the second parameter/Asymmetric End to End Latency; the third parameter/End to End Latency; the fourth parameter/Channel Symmetry Accept; the identity of the UE 1 and/or the identity of the UE 2. In an example, the Initial Context Setup Request message may comprise at least one of: AMF UE NGAP ID, RAN UE NGAP ID, UE Aggregate Maximum Bit Rate, Core Network Assistance Information for RRC INACTIVE, GUAMI, PDU Session Resource Setup Request List (e.g., PDU session associated with the symmetric communication channels), Allowed NSSAI, UE Security Capabilities, Security Key, Mobility Restriction List, Trace Activation, UE Radio Capability, Index to RAT/Frequency Selection Priority, Masked IMEISV, NAS-PDU, Emergency Fallback Indicator, RRC Inactive Transition Report Request, UE Radio Capability for Paging, Enhanced Coverage Restriction, UE Differentiation Information, NR V2X Services Authorized, UE User Plane CIoT Support Indicator, and/or UE Radio Capability ID.

In response to the message received, the base station (e.g., (R)AN 1) may take one or more actions. In an example action, the base station (e.g., (R)AN 1) may determine whether to accept the requesting of symmetric communication channels, based on at least one of: the second message, the resource of the base station, local policy, and/or subscription information of the wireless device. For example, the Initial Context Setup Request message may indicate that the UE 1 requesting symmetric communication channels between the UE 1 and the UE 2; the local policy and/or the subscription information of the UE 1 may indicate that it's allowed to provide symmetric communication channels for the UE 1; the resource of the base station may indicate that the base station has enough resource to provide symmetric communication channels for the UE 1; based on above information, the (R)AN 1 may determine to accept the requesting of symmetric communication channels.

In an example, based on the base station determining whether to accept the requesting of symmetric communication channels, the base station may determine a fourth parameter (e.g., Channel Symmetry Accept) indicating accepting the requesting of symmetric communication channels. In an example, the base station may determine radio bearer and/or QoS resource for the symmetric communication channels, based on at least one of: the determining that whether to accept the requesting of symmetric communication channels, the second message, the resource of the base station, the local policy, and/or the subscription information of the wireless device. In an example, the radio bearer may comprise at least one data radio bearer (DRB) and/or at least one signal radio bearer (SRB). In an example, the base station (e.g., (R)AN 1) may determine radio bearer configuration information for the symmetric communication channels, based on at least one of: the determining that whether to accept the requesting of symmetric communication channels, the second message, the resource of the base station, the local policy, and/or the subscription information of the wireless device. In an example, the base station may determine the at least one data radio bearer (DRB) and/or the at least one signal radio bearer (SRB) for the symmetric communication channels, based on at least one of: the determining that whether to accept requesting of symmetric communication channels, the second message, the resource of the base station, the local policy, and/or the subscription information of the wireless device. In an example, the base station may determine RRC configuration information for the symmetric communication channels, based on at least one of: the determining that whether to accept requesting of symmetric communication channels, the second message, the resource of the base station, the local policy, and/or the subscription information of the wireless device. In an example, the base station may determine at least one logical channel for the symmetric communication channels, based on at least one of: the determining that whether to accept requesting of symmetric communication channels, the second message, the resource of the base station, the local policy, and/or the subscription information of the wireless device. The above actions of the base station may be similar to the actions of the base station as described in FIG. 19. For brevity, further description will not be repeated here.

In an example action, in response to the message received, the base station may determine time and/or frequency resource for the symmetry communication channels based on at least one of: SRS measurements report and/or CSI (measurements) report from the wireless device, the determining that whether to accept requesting of symmetric communication channels, the second message, the resource of the base station, the local policy, and/or the subscription information of the wireless device. The above actions of the base station may be similar to the actions of the base station as described in FIG. 23. For brevity, further description will not be repeated here.

In an example action, the base station may send an RRC message (e.g., RRCReconfiguration) to the wireless device. The RRCReconfiguration message may indicate accepting the symmetric communication channels. In an example, the RRCReconfiguration message may comprise at least one of: the RRC configuration information for the symmetric communication channels, the radio bearer configuration information for the symmetric communication channels, the logical channel configuration information for the symmetric communication channels, the second parameter/Asymmetric End to End Latency, the third parameter/End to End Latency, and/or the fourth parameter/Channel Symmetry Accept. In an example, the RRCReconfiguration message may indicate reject the RRC request.

In an example, the base station may send a third message to the wireless device, the third message may comprise at least one of: a Downlink Control Information (DCI), and/or a Cell Radio Network Temporary Identifier (C-RNTI). In an example, the third message may be a MAC layer message. In an example, the third message may be a physical layer message. In an example, the base station may send the third message to the wireless device via a PDCCH. In an example, the DCI may indicate time and/or frequency resource for the symmetry communication channels. In an example, the C-RNTI may indicate a RRC Connection and scheduling, wherein the RRC Connection and scheduling are dedicated to the wireless device. In an example, the third message and/or the DCI may indicate an allowed end to end latency asymmetry/difference between the at least one uplink communication channel (e.g., PUSCH) and the at least one downlink communication channel (e.g., PDSCH) is less than and/or equal to a value (e.g., 2 ms). In an example, the third message and/or the DCI may indicate an allowed end to end latency between two network elements (e.g., between the UE 1 and the UE2, between the UE 1 and the (R)AN 1) is less than and/or equal to a value (e.g., 5 ms, 10 ms).

In an example action, the base station may send a response message (e.g., Initial Context Setup Response) message to the AMF indicating accepting the symmetric communication channels. For example, the (R)AN 1 may send the Initial Context Setup Response message to the AMF 1, wherein the Initial Context Setup Response message may comprise the fourth parameter/Channel Symmetry Accept indicating that the (R)AN 1 accepts the requesting of symmetric communication channels. In an example, the Initial Context Setup Response message may comprise at least one of the following parameters associated with the symmetric communication channels: parameter(s) for radio bearer configuration, parameter(s) for MAC configuration, parameter(s) for PDCP configuration, parameter(s) for RRC configuration, and/or parameter(s) for physical layer configuration. In an example, the Initial Context Setup Response may comprise at least one of: AMF UE NGAP ID, RAN UE NGAP ID, PDU Session Resource Setup Response List, PDU Session Resource Failed to Setup List, and/or Criticality Diagnostics. In an example, the Criticality Diagnostics IE may be sent by the (R)AN or the AMF when parts of a received message have not been comprehended or were missing, or if the message contained logical errors.

In an example, in response to the message received, the AMF may send a NAS (response) message (e.g., registration accept) to the wireless device indicating accepting the symmetric communication channels. For example, the AMF 1 may send a registration accept message to the UE 1 via the (R)AN 1. In an example, the registration accept may comprise the fourth parameter/Channel Symmetry Accept. In an example, the registration accept message may comprise at least one of: 5G-GUTI, Registration Area, Mobility restrictions, PDU Session status, Allowed NSSAI, Mapping Of Allowed NSSAI, Configured NSSAI for the Serving PLMN, Mapping Of Configured NSSAI, NSSRG Information, rejected S-NSSAIs, Pending NSSAI, Mapping Of Pending NSSAI, Periodic Registration Update timer, Active Time, Strictly Periodic Registration Timer Indication, LADN Information, accepted MICO mode, IMS Voice over PS session supported Indication, Emergency Service Support indicator, Accepted DRX parameters for E-UTRA and NR, Accepted DRX parameters for NB-IoT, extended idle mode DRX parameters, Paging Time Window, Network support of Interworking without N26, Access Stratum Connection Establishment NSSAI Inclusion Mode, Network Slicing Subscription Change Indication, Operator-defined access category definitions, List of equivalent PLMNs, Enhanced Coverage Restricted information, Supported Network Behaviour, Service Gap Time, PLMN-assigned UE Radio Capability ID, PLMN-assigned UE Radio Capability ID deletion, WUS Assistance Information, Truncated 5G-S-TMSI Configuration, Connection Release Supported, Paging Cause Supported, Paging Restriction Supported, and/or Reject Paging Supported.

In an example, in response to the message received from the base station (e.g., (R)AN 1) and/or the AMF (e.g., AMF 1), the wireless device (e.g., UE 1) may take one or more actions. In an example action, the wireless device may allocate radio bearer/QoS resource for the symmetric communication channels based on at least one of: the RRC configuration information for the symmetric communication channels, the radio bearer configuration information for the symmetric communication channels, the logical channel configuration information for the symmetric communication channels, the second parameter/Asymmetric End to End Latency, the third parameter/End to End Latency, and/or the fourth parameter/Channel Symmetry Accept.

In an example action, the wireless device (e.g., UE 1) may establish at least one RRC connection for the symmetric communication channels. In an example, the RRC connection for the symmetric communication channels may be between the wireless device (e.g., UE 1) and the base station (e.g., (R)AN 1). The wireless device (e.g., UE 1) and the base station (e.g., (R)AN 1) may establish the RRC connection for the symmetric communication channels based on the procedure as shown in FIG. 15. In an example, the RRC connection for the symmetric communication channels may be between two wireless devices (e.g., UE 1 and UE 2).

In an example action, the wireless device (e.g., UE 1) may establish at least one protocol data unit (PDU) session for the symmetric communication channels. The PDU session may be between the UE and a core network (e.g., core network 1 as shown in FIG. 26). The core network may comprise at least one of: AMF, SMF, UPF, PCF, and/or the like.

In an example, the at least one uplink communication channel and/or the at least one downlink communication channel may be associated with the RRC connection. In an example, the RRC connection for the symmetric communication channels may be associated with the PDU session for the symmetric communication channels.

In an example, as shown in the FIG. 26, the second wireless device (e.g., UE 2) may take the similar actions as UE 1 as described above, and the second base station (e.g., (R)AN 2) may take the similar actions as (R)AN 1 as described above. In an example, the second AMF (e.g., AMF 2) may take the similar action as AMF 1 as described above.

In an example action, UE 1 and UE 2 may perform/run applications and/or services over the symmetric communication channels. For example, the Relay_a/UE 1 and Relay_b/UE 2 may perform/run channel-based alignment method for Line Current Differential Protection between the Relay_a/UE 1 and Relay_b/UE 2 over the symmetric communication channels (e.g., PDU session 1 and/or PDU session 2, QoS flows/service data flows, RRC connections, radio bearers). In an example, UE 1 and UE 2 may play games over the symmetric communication channels (e.g., PDU session 1 and/or PDU session 2, QoS flows/service data flows, RRC connections, radio bearers).

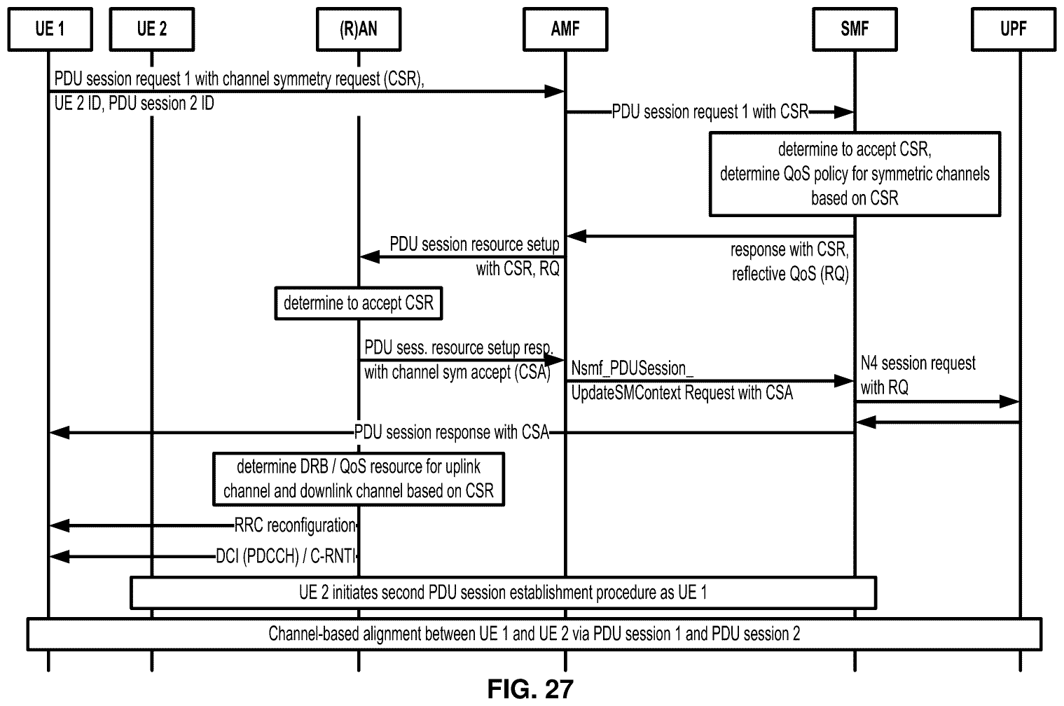

FIG. 27 is an example call flow which may comprise one or more actions. In an example, a control plane function (e.g., an SMF as shown in FIG. 27) of a network may receive a first message from a wireless device (e.g., UE 1 as shown in FIG. 27). In an example, the first message may comprise a parameter (e.g., Channel Symmetry Request) indicating requesting symmetric communication channels for an application/service of the wireless device. In an example, the definition/content of the symmetric communication channels may be similar to the definition/content of the symmetric communication channels as described in FIG. 19. For brevity, further description will not be repeated here.

In an example, the first message may comprise at least one of the following IEs/parameters: the parameter/Channel Symmetry Request; a second parameter (e.g., Asymmetric End to End Latency) indicating requesting maximum end to end latency asymmetry/difference between [at least one uplink communication channel] and [at least one downlink communication channel] is less than and/or equal to a value (e.g., 2 ms); a third parameter (e.g., End to End Latency) indicating requesting end to end latency between two network elements is less than and/or equal to a value (e.g., 5 ms, 10 ms); an identity of the wireless device (e.g., UE 1); an identity of a second wireless device (e.g., UE 2); an identity of a first PDU session for the UE 1; and/or an identity of a second PDU session for the UE 2. In an example, the definition/content of the parameter/Channel Symmetry Request may be similar to the definition/content of the parameter/Channel Symmetry Request as described in FIG. 19. In an example, the definition/content of the second parameter/Asymmetric End to End Latency may be similar to the definition/content of the second parameter/Asymmetric End to End Latency as described in the FIG. 19. In an example, the definition/content of the third parameter/End to End Latency may be similar to the definition/content of the third parameter/End to End Latency as described in the FIG. 19. In an example, the definition/content of the identity of the UE 1 and/or UE 2 may be similar to the definition/content of the identity of the UE 1 and/or UE 2 as described in the FIG. 19. For brevity, further description will not be repeated here. In an example, the parameter/Channel Symmetry Request, the identity of the UE 1, and/or the identity of the first PDU session may indicate the UE 1 requesting symmetric communication channels between the UE 1 and a core network (e.g., core network 1) over the first PDU session. In an example, the core network (e.g., core network 1) may comprise an AMF (e.g., AMF 1), the SMF (e.g., SMF 1), and/or a UPF (e.g., UPF 1). In an example, the parameter/Channel Symmetry Request, the identity of the UE 1, the identity of the UE 2, the identity of the first PDU session, and/or the identity of the second PDU session may indicate the UE 1 requesting symmetric communication channels between the UE 1 and the UE 2, wherein the symmetric communication channels may be over the first PDU session and/or the second PDU session.

In an example, the network may be a communication system (e.g., 5G system), where the communication system may comprise base station(s), AMF(s), SMF(s) and/or UPF(s). In an example, the first message may comprise a NAS message (e.g., PDU Session Establishment Request). In an example, the UE 1 may send the PDU Session Establishment Request message to the SMF via a base station (e.g., (R)AN) and/or an AMF. For example, the UE 1 may send a NAS message to the AMF. In an example, the NAS message may comprise at least one of: S-NSSAI(s), UE Requested DNN, PDU Session ID (s) (e.g., the identity of the first PDU session, and/or the identity of the second PDU session), Request type, Old PDU Session ID, and/or a N1 SM container. In an example, the N1 SM container may comprise a PDU Session Establishment Request message and/or a Port Management Information Container. In an example, the PDU Session Establishment Request message may comprise the parameter/Channel Symmetry Request; the second parameter/Asymmetric End to End Latency; the third parameter/End to End Latency; the identity of the wireless device (e.g., UE 1); the identity of the second wireless device (e.g., UE 2); the identity of the first PDU session; and/or the identity of the second PDU session.

In an example, the PDU Session Establishment Request message may comprise at least one of: PDU session ID (s), Requested PDU Session Type, a Requested SSC mode, 5GSM Capability, PCO, SM PDU DN Request Container, Number of Packet Filters, Header Compression Configuration, UE Integrity Protection Maximum Data Rate, Always-on PDU Session Requested, and/or the like.

In an example, in response to the message received, the AMF may select an SMF, and send a Nsmf_PDUSession_CreateSMContext Request message to the SMF. The Nsmf_PDUSession_CreateSMContext Request message may comprise at least one of: SUPI, selected DNN, UE requested DNN, S-NSSAI(s), PDU Session ID (s), AMF ID, Request Type, [PCF ID, Same PCF Selection Indication], Priority Access, [Small Data Rate Control Status], N1 SM container (PDU Session Establishment Request message), User location information, Access Type, RAT Type, PEI, GPSI, UE presence in LADN service area, Subscription For PDU Session Status Notification, DNN Selection Mode, Trace Requirements, Control Plane CIoT 5GS Optimisation indication, and/or Control Plane Only indicator.

In response to the message received, the SMF may take one or more actions. In an example action, the SMF may determine whether to accept the requesting of symmetric communication channels, based on at least one of: the PDU session establishment request message; resource of the core network; local operator policy; and/or subscription information of the wireless device. For example, the PDU Session Establishment Request message may comprise the parameter/Channel Symmetry Request; the second parameter/Asymmetric End to End Latency; the third parameter/End to End Latency; the identity of the wireless device (e.g., UE 1); the identity of the second wireless device (e.g., UE 2); the identity of the first PDU session; and/or the identity of the second PDU session; the resource of the network (e.g., AMF, SMF, and/or UPF) may support the symmetric communication channels; the local operator policy and/or subscription information of the wireless device may indicate that the symmetric communication channels is allowed to the wireless device; based on above information, the SMF may determine to accept the requesting of symmetric communication channels. In an example, based on the SMF determining whether to accept the requesting of symmetric communication channels, the SMF may determine a fourth parameter (e.g., Channel Symmetry Accept) indicating accepting the requesting of symmetric communication channels.

In an example action, the SMF may determine QoS policy/parameters for the symmetric communication channels based on at least one of: the determining whether to accept the requesting of symmetric communication channels; the PDU session establishment request message; resource of the core network; local operator policy; and/or subscription information of the wireless device. For example, the SMF has determined the fourth parameter/Channel Symmetry Accept indicating accepting the requesting of symmetric communication channels; the PDU Session Establishment Request message may comprise the parameter/Channel Symmetry Request; the second parameter/Asymmetric End to End Latency; the third parameter/End to End Latency; the identity of the wireless device (e.g., UE 1); the identity of the second wireless device (e.g., UE 2); the identity of the first PDU session; and/or the identity of the second PDU session; the resource of the network (e.g., AMF, SMF, and/or UPF) may support the symmetric communication channels; the local operator policy and/or subscription information of the wireless device may indicate that the symmetric communication channels is allowed to the wireless device; based on above information, the SMF may determine QoS policy/parameters for the symmetric communication channels for the wireless device.

In an example, the symmetric communication channels may comprise the first PDU session and/or the second PDU session. In an example, the QoS policy/parameters determined by the SMF may be applied to uplink first PDU session and/or downlink first PDU session, wherein the uplink PDU session may be between the UE 1 and the core network 1 (e.g., UPF 1), and downlink PDU session may be between the core network 1 (e.g., UPF 1) and the UE 1. In an example, the QoS policy/parameters determined by the SMF may be applied to the first PDU session and/or the second PDU session between the UE 1 and the UE 2.

In an example, the first PDU session and/or the second PDU session may comprise at least one QoS flow and/or at least one service data flow. In an example, the QoS policy/parameters determined by the SMF may be applied to uplink of the at least one QoS flow and/or uplink of the at least one service data flow, and/or downlink of the at least one QoS flow and/or downlink of the at least one service data flow. In an example, the QoS policy/parameters determined by the SMF may be applied to the at least one QoS flow and/or at least one service data flow of the first PDU session, and/or the at least one QoS flow and/or at least one service data flow of the second PDU session, between the UE 1 and the UE 2.

In an example, the at least one service data flow (SDF) may be an aggregate set of packet flows carried through the UPF that matches a service data flow template. In an example, the service data flow template may be set of service data flow filters in a PCC Rule or an application identifier in a PCC rule referring to an application detection filter in the SMF and/or in the UPF, required for defining a service data flow. In an example, the Service data flow filter may be a set of packet flow header parameter values/ranges used to identify one or more of the packet flows in the UPF. In an example, a QoS Flow may be the finest granularity of QoS differentiation in the PDU Session. A QoS flow may be similar to a bearer in 4G/LTE. A QoS Flow ID (QFI) may be used to identify a QoS Flow in the 5G System. User Plane traffic with the same QFI within a PDU Session may receive the same traffic forwarding treatment (e.g., scheduling, admission threshold). The QFI may be carried in an encapsulation header on N3 interface (and/or N9 interface) e.g., without any changes to the e2e packet header. QFI may be used for all PDU Session Types. The QFI may be unique within a PDU Session. The QFI may be dynamically assigned or may be equal to the 5QI. Within the 5GS, a QoS Flow may be controlled by the SMF and may be preconfigured, or established via the PDU Session Establishment procedure, or the PDU Session Modification procedure.

In an example, the QoS policy/parameters determined by the SMF may comprise at least one PCC rule for the symmetric communication channels for the wireless device. In an example, the at least one PCC rule may comprise at least one of: at least one charging control rule; at least one policy control rule; at least one usage monitoring control rule; at least one application detection and control rule; at least one traffic steering control rule; and/or at least one service data flow detection information (e.g., service data flow template). In an example, the at least one policy control rule may comprise at least one QoS control rule and/or at least one gating control rule. In an example, the at least one charging control rule may comprise at least one of: an information element indicating a charging method/charging type; an information element indicating at least one charging rate; and/or an information element indicating at least one identifier or address of a CHF. In an example, the charging method/charging type may comprise at least one of: online charging, offline charging, and/or converged charging.

In an example, the policy control rule may be used for policy control, where the at least one QoS control rule may be used for QoS control, and the at least one gating control rule may be used for gating control. In an example, the QoS control rule may be used to authorize QoS on a service data flow and/or a QoS flow. In an example, the gating control rule may be used to discard packets that don't match service data flow of the gating control rule and/or associated PCC rules. In an example, the usage monitoring control rule may be used to monitor, both volume and time usage, and report the accumulated usage of network resources. In an example, the application detection and control rule may comprise a request to detect a specified application traffic, report to a PCF on a start or stop of application traffic and to apply a specified enforcement and charging actions. In an example, the traffic steering control rule may be used to activate/deactivate traffic steering policies for steering a subscriber's traffic to appropriate operator or 3rd party service functions (e.g., NAT, antimalware, parental control, DDoS protection) in an (S)Gi-LAN. In an example, the service data flow detection information (e.g., service data flow template) may comprise a list of service data flow filters or an application identifier that references the corresponding application detection filter for the detection of the service data flow. In an example, the service data flow detection information (e.g., service data flow template) may comprise combination of traffic patterns of the Ethernet PDU traffic.

In an example, the QoS policy/parameters determined by the SMF may comprise at least one of: 5QI/QCI, ARP, RQA, GFBR, MFBR and/or maximum packet loss rate as described in FIG. 8. In an example, the QoS policy/parameters determined by the SMF may comprise a QoS class identifier (QCI). The QCI may be a scalar that is used as a reference to a specific packet forwarding behavior (e.g., packet loss rate, packet delay budget) to be provided to a SDF. This may be implemented in the access network by the QCI referencing node specific parameters that control packet forwarding treatment (e.g., scheduling weights, admission thresholds, queue management thresholds, link layer protocol configuration, etc.), that have been pre-configured by the operator at a specific node(s) (e.g., base station).

In an example, the QoS policy/parameters determined by the SMF may comprise at least one of: a fifth parameter (e.g., Channel Symmetry Indication); the second parameter/Asymmetric End to End Latency; and/or the third parameter/End to End Latency. In an example, the fifth parameter (e.g., Channel Symmetry Indication) may indicate the QoS policy/parameters is applied to symmetric communication channels for the wireless device. In an example, the second parameter/Asymmetric End to End Latency may indicate maximum end to end latency asymmetry/difference between [at least one uplink communication channel] and [at least one downlink communication channel] is less than and/or equal to a value (e.g., 2 ms). In an example, the third parameter/End to End Latency may indicate end to end latency between two network elements is less than and/or equal to a value (e.g., 5 ms, 10 ms).

In an example action, the SMF may send a message (e.g., Nsmf_PDUSession_CreateSMContext Response) to the AMF. In an example, the Nsmf_PDUSession_CreateSMContext Response message may comprise at least one of: the parameter/Channel Symmetry Request; the second parameter/Asymmetric End to End Latency; the third parameter/End to End Latency; and/or the fourth parameter/Channel Symmetry Accept. In an example, the Nsmf_PDUSession_CreateSMContext Response message may comprise a Reflective QoS Indication (RQI) indicating requesting symmetric communication channels for the wireless device. In an example, the RQI may indicate maximum end to end latency asymmetry/difference between [at least one uplink communication channel] and [at least one downlink communication channel] is less than and/or equal to a value (e.g., 2 ms). In an example, the RQI may indicate end to end latency between two network elements is less than and/or equal to a value (e.g., 5 ms, 10 ms).

In an example, the Nsmf_PDUSession_CreateSMContext Response message may comprise at least one of: Cause, SM Context ID and/or a N1 SM container, wherein the N1 SM container may comprise a PDU Session Reject message. In an example, the PDU Session Reject message may comprise a cause value indicating the reject reason. In an example, the Nsmf_PDUSession_CreateSMContext Response message may comprise N2 SM information, wherein the N2 SM information may comprise list of PDU session(s) to be setup by the base station for the symmetric communication channels. For example, the N2 SM information may comprise at least one of: PDU Session ID (s) for the symmetric communication channels, QFI(s) for the symmetric communication channels, QoS Profile(s) for the symmetric communication channels (e.g., the QoS policy/parameters determined by the SMF), CN Tunnel Info, S-NSSAI from the Allowed NSSAI, Session-AMBR, PDU Session Type, User Plane Security Enforcement information, UE Integrity Protection Maximum Data Rate, RSN, and/or PDU Session Pair ID.

In response to the message received, the AMF may take one or more actions. In an example action, the AMF may send a message (e.g., PDU Session Resource Setup) to the base station. In an example, the PDU Session Resource Setup message may comprise one or more IEs/parameters of the Nsmf_PDUSession_CreateSMContext Response message. For example, the PDU Session Resource Setup may comprise at least one of: the parameter/Channel Symmetry Request; the second parameter/Asymmetric End to End Latency; the third parameter/End to End Latency; the fourth parameter/Channel Symmetry Accept; and/or the RQI.

In an example, the PDU Session Resource Setup message may comprise at least one of: AMF UE NGAP ID, RAN UE NGAP ID, RAN Paging Priority, NAS-PDU, PDU Session Resource Setup Request List for the symmetric communication channels, and/or UE Aggregate Maximum Bit Rate. In an example, the PDU Session Resource Setup Request List may comprise list of PDU session(s) to be setup by the base station for the symmetric communication channels. For example, the PDU Session Resource Setup Request List may comprise at least one of: PDU Session ID (s), S-NSSAI, PDU Session NAS-PDU, and/or PDU Session Resource Setup Request Transfer. In an example, the PDU Session NAS-PDU may comprise a NAS message sent from core network (e.g., SMF/AMF) to the wireless device. In an example, the PDU Session Resource Setup Request Transfer may comprise PDU session information to be setup by the base station for the symmetric communication channels, wherein the PDU session information may be associated with the SMF.

In response to the message received, the base station (e.g., (R)AN) may take one or more actions. In an example action, the base station may determine whether to accept the requesting of symmetric communication channels, based on at least one of: the PDU Session Resource Setup message, the resource of the base station, local policy, and/or subscription information of the wireless device.

In an example, based on the base station determining whether to accept the requesting of symmetric communication channels, the base station may determine a fourth parameter (e.g., Channel Symmetry Accept) indicating accepting the requesting of symmetric communication channels. In an example, the base station may determine radio bearer and/or QoS resource for the symmetric communication channels, based on at least one of: the determining that whether to accept the requesting of symmetric communication channels, the PDU Session Resource Setup message, the resource of the base station, the local policy, and/or the subscription information of the wireless device. In an example, the radio bearer may comprise at least one data radio bearer (DRB) and/or at least one signal radio bearer (SRB). In an example, the base station may determine radio bearer configuration information for the symmetric communication channels, based on at least one of: the determining that whether to accept the requesting of symmetric communication channels, the PDU Session Resource Setup message, the resource of the base station, the local policy, and/or the subscription information of the wireless device. In an example, the base station may determine the at least one data radio bearer (DRB) and/or the at least one signal radio bearer (SRB) for the symmetric communication channels, based on at least one of: the determining that whether to accept requesting of symmetric communication channels, the PDU Session Resource Setup message, the resource of the base station, the local policy, and/or the subscription information of the wireless device. In an example, the base station may determine RRC configuration information for the symmetric communication channels, based on at least one of: the determining that whether to accept requesting of symmetric communication channels, the PDU Session Resource Setup message, the resource of the base station, the local policy, and/or the subscription information of the wireless device. In an example, the base station may determine at least one logical channel for the symmetric communication channels, based on at least one of: the determining that whether to accept requesting of symmetric communication channels, the PDU Session Resource Setup message, the resource of the base station, the local policy, and/or the subscription information of the wireless device. The above actions of the base station may be similar to the actions of the base station as described in FIG. 19. For brevity, further description will not be repeated here.

In an example action, in response to the message received, the base station may determine time and/or frequency resource for the symmetry communication channels based on at least one of: SRS measurements report and/or CSI (measurements) report from the wireless device, the determining that whether to accept requesting of symmetric communication channels, the second message, the resource of the base station, the local policy, and/or the subscription information of the wireless device. The above actions of the base station may be similar to the actions of the base station as described in FIG. 23. For brevity, further description will not be repeated here.

In an example action, the base station may send an RRC message (e.g., RRCReconfiguration) to the wireless device. The RRCReconfiguration message may indicate accepting the symmetric communication channels. In an example, the RRCReconfiguration message may comprise at least one of: the RRC configuration information for the symmetric communication channels, the radio bearer configuration information for the symmetric communication channels, the logical channel configuration information for the symmetric communication channels, the second parameter/Asymmetric End to End Latency, the third parameter/End to End Latency, and/or the fourth parameter/Channel Symmetry Accept.

In an example, the base station may send a third message to the wireless device, the third message may comprise at least one of: a Downlink Control Information (DCI), and/or a Cell Radio Network Temporary Identifier (C-RNTI). In an example, the third message may be a MAC layer message. In an example, the third message may be a physical layer message. In an example, the base station may send the third message to the wireless device via a PDCCH. In an example, the DCI may indicate time and/or frequency resource for the symmetry communication channels. In an example, the C-RNTI may indicate a RRC Connection and scheduling, wherein the RRC Connection and scheduling are dedicated to the wireless device. In an example, the third message and/or the DCI may indicate an allowed end to end latency asymmetry/difference between the at least one uplink communication channel (e.g., PUSCH) and the at least one downlink communication channel (e.g., PDSCH) is less than and/or equal to a value (e.g., 2 ms). In an example, the third message and/or the DCI may indicate an allowed end to end latency between two network elements (e.g., between the UE 1 and the UE2, between the UE 1 and the (R)AN) is less than and/or equal to a value (e.g., 5 ms, 10 ms).

In an example action, the base station may send a response message (e.g., PDU Session Resource Setup Response) message to the AMF indicating accepting the symmetric communication channels. For example, the (R)AN may send the PDU Session Resource Setup Response message to the AMF, wherein the PDU Session Resource Setup Response message may comprise the fourth parameter/Channel Symmetry Accept indicating that the (R)AN accepts the requesting of symmetric communication channels. In an example, the PDU Session Resource Setup Response message may comprise at least one of: AMF UE NGAP ID, RAN UE NGAP ID, PDU Session Resource Setup Response List, PDU Session Resource Failed to Setup List, and/or Criticality Diagnostics. In an example, the Criticality Diagnostics IE may be sent by the NG-RAN node and/or the AMF when parts of a received message have not been comprehended or were missing, or if the message contained logical errors.

In an example, in response to the message received, the AMF may send a message (e.g., Nsmf_PDUSession_UpdateSMContext Request) to the SMF. In an example, the Nsmf_PDUSession_UpdateSMContext Request message may comprise at least one of: the fourth parameter/Channel Symmetry Accept, SM Context ID, N2 SM information and/or Request Type. In an example, the N2 SM information may comprise one or more IEs/parameters of the PDU Session Resource Setup Response message.

In an example, in response to the message received, the SMF may take one or more actions. In an example action, the SMF may determine at least one user plane rule for the symmetric communication channels for the wireless device. In an example, the SMF may determine the at least one user plane rule based on at least one of: the QoS policy/parameters determined by the SMF; the parameter/Channel Symmetry Request; the second parameter/Asymmetric End to End Latency; the third parameter/End to End Latency; the fourth parameter/Channel Symmetry Accept; and/or the RQI. In an example, the at least one user plane rule determined by the SMF may comprise at least one of: the second parameter/Asymmetric End to End Latency; the third parameter/End to End Latency; and/or the fifth parameter/Channel Symmetry Indication.

In an example, the at least one user plane rule may comprise at least one of: at least one packet detection rule; at least one forwarding action rule; at least one QoS enforcement rule; and/or at least one usage reporting rule. In an example, the at least one packet detection rule may comprise data/traffic packet detection information, e.g., one or more match fields against which incoming packets are matched and may apply other user plane rules (e.g., at least one forwarding action rule, at least one QoS enforcement rule, and/or at least one usage reporting rule) to the data/traffic packets matching the packet detection rule. In an example, the at least one forwarding action rule may comprise an apply action parameter, which may indicate whether a UP function may forward, duplicate, drop or buffer the data/traffic packet respectively. In an example, the at least one usage reporting rule may be used to measure the network resources usage in terms of traffic data volume, duration (e.g., time) and/or events, according to a measurement method in the usage reporting rule. In an example, the event may indicate a start of time service and/or a stop of time service. In an example, the at least one QoS enforcement rule may comprise instructions to request the UP function to perform QoS enforcement of the user plane traffic.

In an example, the SMF may determine a packet detection rule based on the service data flow detection information (e.g., service data flow template). In an example, the SMF may determine a forwarding action rule based on the policy control rule. In an example, the SMF may determine a usage reporting rule based on the usage monitoring control rule.

In an example action, the SMF may select a UPF to support the symmetric communication channels based on the capability of the UPF that whether the UPF supports the symmetric communication channels. In an example action, the SMF may send to the UPF a message (e.g., N4 session establishment/modification request) comprising the at least one user plane rule. In response to receiving the message from the SMF, the UPF may install the user plane rules received from the SMF. The UPF may send to the SMF a response message (e.g., N4 session establishment/modification response), and enforce the user plane rules.

In an example, in response to the message received, the UPF may take one or more actions based on the at least one user plane rule. In an example action, based on the N4 session establishment/modification request message, the UPF may determine whether to provide the symmetric communication channels based on the capability of the UPF and/or local configuration. In an example action, the UPF may allocate resources for the symmetric communication channels. In an example action, the UPF may schedule uplink and/or downlink data packet to support the symmetric communication channels. In an example, the UPF may schedule uplink and/or downlink data packet to support the asymmetric End to End Latency. In an example, the UPF may schedule uplink and/or downlink data packet to support the End to End Latency.

In an example action, the UPF may enforce the at least one user plane rule. For example, the UPF may enforce the at least one packet detection rule by matching a user data/traffic packet with service data flow template (e.g., service data flow filters and/or application identifiers) and may apply other user plane rules (e.g., forwarding action rule, QoS enforcement rule, and usage reporting rule) to the data/traffic packets matched the packet detection rule. In an example, the UPF may enforce the at least one forwarding action rule by forwarding, duplicating, dropping or buffering a data/traffic packet respectively. In an example, the UPF may redirect the traffic to a web portal of the operator. In an example, the UPF may enforce the at least one usage reporting rule by measuring network resources usage in terms of traffic data volume, duration (e.g., time) and/or events, according to a measurement method in the usage reporting rule; the UPF may report the network resources usage to the SMF when the quota/threshold reached, and/or event and/or another trigger is (are) met. In an example, the UPF may enforce the at least one QoS enforcement rule by applying at least one of QoS parameters: 5QI, ARP, MBR, GBR to a service data flow; In an example, the UPF may enforce the at least one QoS enforcement rule by applying at least one of QoS parameters: Session AMBR and default 5QI/ARP combination to a PDU session.

In an example action, in response to the message received from the UE, the SMF may send a NAS response message (e.g., PDU session establishment response) to the wireless device. In an example, the PDU session establishment response message (e.g., PDU Session Establishment Accept) may indicate accepting the requesting from the wireless device for the symmetric communication channels. In an example, the PDU session establishment response message may indicate accepting the request for the asymmetric End to End Latency. In an example, the PDU session establishment response message may indicate accepting the request for the End to End Latency. In an example, the PDU session establishment response message may comprise at least one of: the QoS policy/parameters determined by the SMF; the RQI; the second parameter/Asymmetric End to End Latency; the third parameter/End to End Latency; the fourth parameter/Channel Symmetry Accept; and/or the fifth parameter/Channel Symmetry Indication.

In an example, the SMF may send the NAS response message to the wireless device via the AMF and/or the base station. For example, the SMF may send a Namf_Communication_N1N2MessageTransfer message to the AMF. In an example, the Namf_Communication_N1N2MessageTransfer message may comprise at least one of: the QoS policy/parameters determined by the SMF; the RQI; the second parameter/Asymmetric End to End Latency; the third parameter/End to End Latency; the fourth parameter/Channel Symmetry Accept; and/or the fifth parameter/Channel Symmetry Indication. In an example, the Namf_Communication_N1N2MessageTransfer message may comprise at least one of: PDU Session ID (s) for the symmetric communication channels, N2 SM information and/or N1 SM container. In an example, the N2 SM information may comprise information sent to the base station. In an example, the N1 SM container may comprise information sent to the wireless device. In an example, the N2 SM information may comprise at least one of: the QoS policy/parameters determined by the SMF; the RQI; the second parameter/Asymmetric End to End Latency; the third parameter/End to End Latency; the fourth parameter/Channel Symmetry Accept; and/or the fifth parameter/Channel Symmetry Indication; PDU Session ID (s) for the symmetric communication channels, QFI(s) for the symmetric communication channels, QoS Profile(s) for the symmetric communication channels, CN Tunnel Info, S-NSSAI from the Allowed NSSAI, Session-AMBR, PDU Session Type, User Plane Security Enforcement information, UE Integrity Protection Maximum Data Rate, RSN, and/or PDU Session Pair ID. In an example, the N1 SM container may comprise a PDU Session Establishment Accept message/parameter, wherein the PDU Session Establishment Accept message/parameter may comprise at least one of: the QoS policy/parameters determined by the SMF; the RQI; the second parameter/Asymmetric End to End Latency; the third parameter/End to End Latency; the fourth parameter/Channel Symmetry Accept; and/or the fifth parameter/Channel Symmetry Indication; QoS Rule(s) and QoS Flow level QoS parameters if needed for the QoS Flow(s) associated with the QoS rule(s) for the symmetric communication channels, selected SSC mode, S-NSSAI(s), UE Requested DNN, allocated IPv4 address, interface identifier, Session-AMBR, selected PDU Session Type, Reflective QoS Timer (if available), P-CSCF address(es), Control Plane Only indicator, Header Compression Configuration, Always-on PDU Session Granted, Small Data Rate Control parameters, Small Data Rate Control Status, and/or Serving PLMN Rate Control.

In an example, the AMF may send the N2 SM information to the base station. In an example, the AMF may send the N1 SM container to the wireless device in a NAS message. In an example, in response to the message received from the AMF, based on the N2 SM information, the base station may take one or more actions. In an example action, the base station may send an RRC message (e.g., RRCReconfiguration) to the wireless device. The RRCReconfiguration message may indicate accepting the symmetric communication channels. In an example, the RRCReconfiguration message may comprise at least one of: the RC configuration information for the symmetric communication channels, the radio bearer configuration information for the symmetric communication channels, the logical channel configuration information for the symmetric communication channels, the second parameter/Asymmetric End to End Latency, the third parameter/End to End Latency, and/or the fourth parameter/Channel Symmetry Accept.

In an example action, the base station may associate/map the PDU session to the at least one QoS flow/service data flow for the symmetric communication channels. In an example action, the base station may associate/map the at least one QoS flow/service data flow to the at least one DRB and/or at least one SRB for the symmetric communication channels. In an example action, the base station may associate/map the at least one DRB and/or at least one SRB to the at least one logical channel and/or at least one physical channel for the symmetric communication channels. In an example action, the base station may allocate resources for the symmetric communication channels. In an example action, the base station may schedule uplink and/or downlink data packet to support the symmetric communication channels. In an example action, the base station may schedule uplink and/or downlink data packet to support the asymmetric End to End Latency. In an example, the base station may schedule uplink and/or downlink data packet to support the End to End Latency.

In response to the message received from the SMF, AMF and/or the base station, the wireless device may take one or more actions based on at least one of: the QoS policy/parameters determined by the SMF; the RQI; the second parameter/Asymmetric End to End Latency; the third parameter/End to End Latency; the fourth parameter/Channel Symmetry Accept; and/or the fifth parameter/Channel Symmetry Indication. In an example action, the wireless device may allocate radio bearer/QoS resource for the symmetric communication channels based on at least one of: the RRC configuration information for the symmetric communication channels, the radio bearer configuration information for the symmetric communication channels, the logical channel configuration information for the symmetric communication channels, the second parameter/Asymmetric End to End Latency, the third parameter/End to End Latency, and/or the fourth parameter/Channel Symmetry Accept.

In an example action, the wireless device may schedule uplink and/or downlink data packet to support the symmetric communication channels. In an example action, the wireless device may schedule uplink and/or downlink data packet to support the asymmetric End to End Latency. In an example action, the wireless device may schedule uplink and/or downlink data packet to support the End to End Latency.

In an example action, the wireless device may establish at least one RRC connection for the symmetric communication channels. In an example, the RRC connection for the symmetric communication channels may be between the wireless device and the base station. The wireless device and the base station may establish the RRC connection for the symmetric communication channels based on the procedure as shown in FIG. 15. In an example, the RRC connection for the symmetric communication channels may be between two wireless devices (e.g., UE 1 and UE 2).

In an example, the at least one uplink communication channel and/or the at least one downlink communication channel may be associated with the RRC connection. In an example, the RRC connection for the symmetric communication channels may be associated with the PDU session for the symmetric communication channels.

In an example, the second wireless device (e.g., UE 2 as shown in the FIG. 27) may take the similar actions as UE 1 as described above. The UE 2 may establish a second PDU session via the (R)AN, the AMF, the SMF, and/or the UPF, where the second PDU session establishment procedure may be similar to the PDU session established by the UE 1. In an example, the UE 2 may establish the second PDU session via a (R)AN 2, a AMF 2, a SMF 2, and/or a UPF 2.

In an example action, UE 1 and UE 2 may perform/run applications and/or services over the symmetric communication channels. For example, the Relay_a/UE 1 and Relay_b/UE 2 may perform/run channel-based alignment method for Line Current Differential Protection between the Relay_a/UE 1 and Relay_b/UE 2 over the symmetric communication channels (e.g., PDU session 1 and/or PDU session 2, QoS flows/service data flows, RRC connections, radio bearers). In an example, UE 1 and UE 2 may play games over the symmetric communication channels (e.g., PDU session 1 and/or PDU session 2, QoS flows/service data flows, RRC connections, radio bearers).

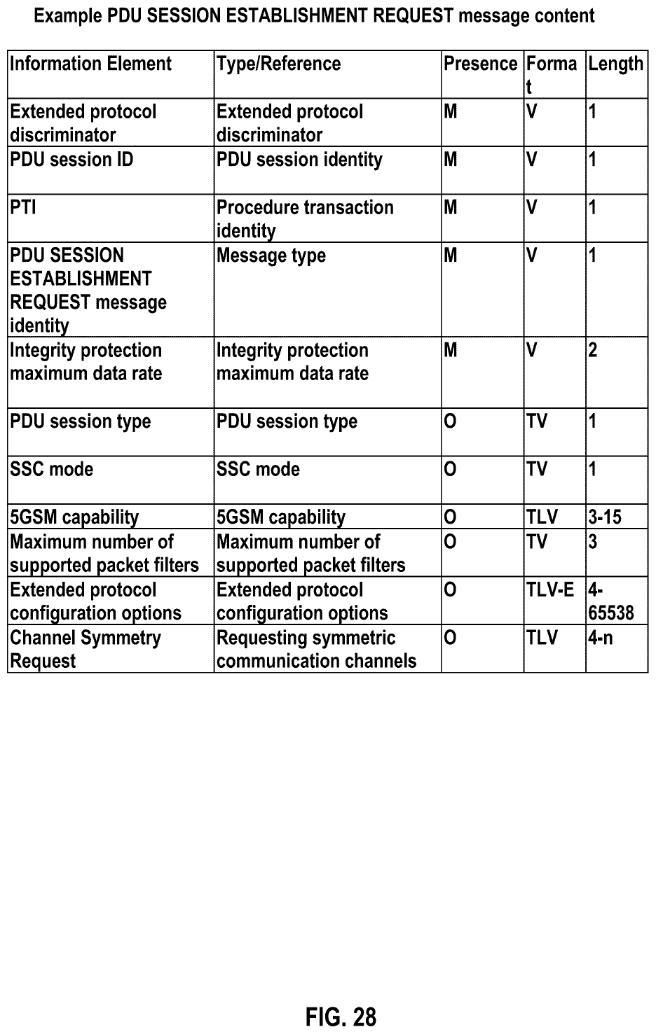

FIG. 28 is an example diagram depicting a PDU session establishment request message as per an aspect of an embodiment of the present disclosure.

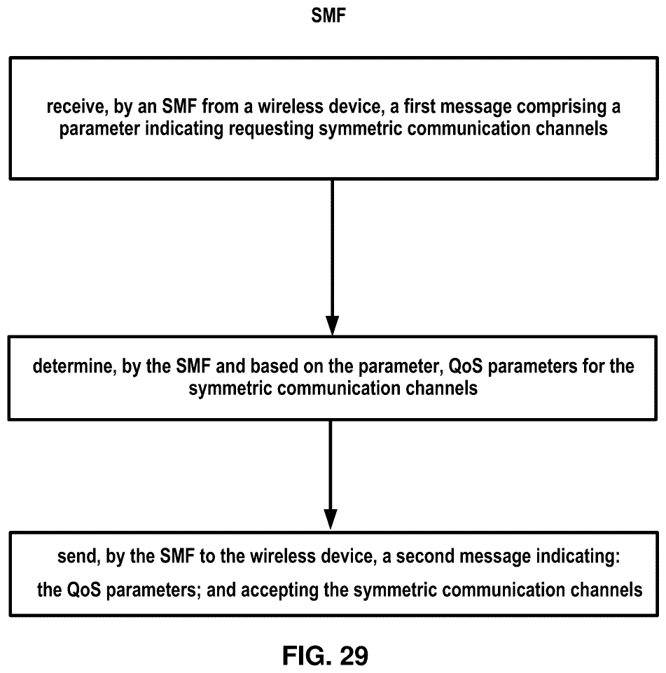

FIG. 29 is an example diagram depicting the procedures of a SMF as per an aspect of an embodiment of the present disclosure.

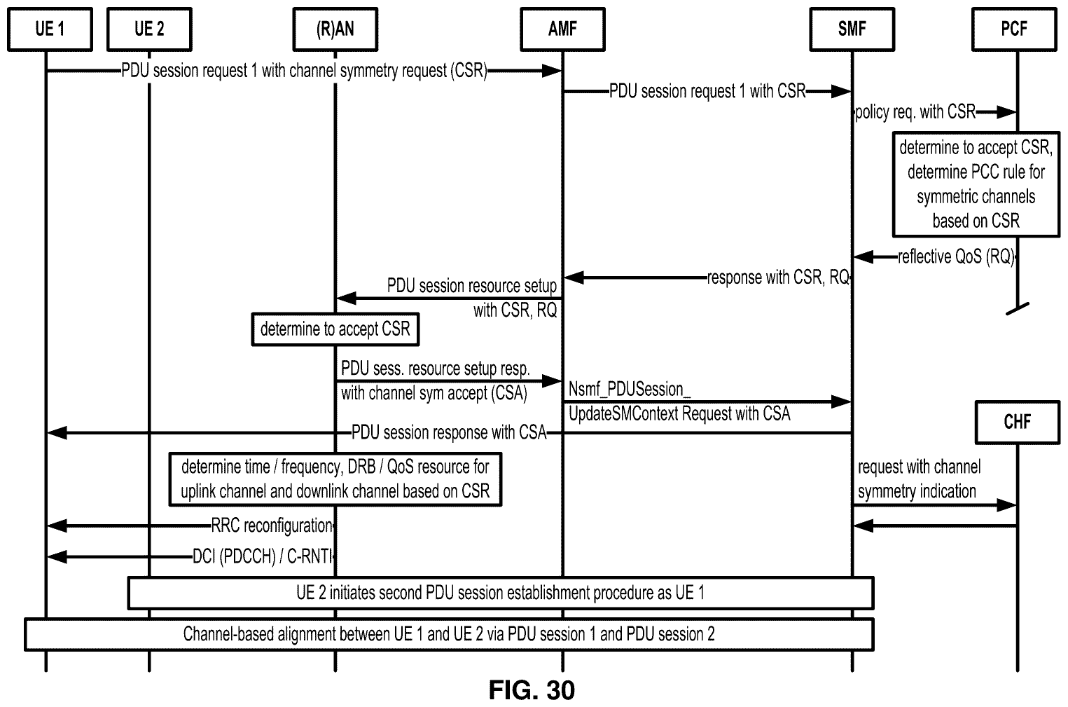

FIG. 30 is an example call flow as per an aspect of an embodiment of the present disclosure. In an example, a control plane function (e.g., an SMF as shown in FIG. 30) of a network may receive a first message from a wireless device (e.g., UE 1 as shown in FIG. 30). In an example, the first message may comprise a parameter (e.g., Channel Symmetry Request) indicating requesting symmetric communication channels for an application/service of the wireless device. In an example, the definition/content of the symmetric communication channels may be similar to the definition/content of the symmetric communication channels as described in FIG. 19. For brevity, further description will not be repeated here.

In an example, the first message may comprise at least one of the following IEs/parameters: the parameter/Channel Symmetry Request; a second parameter (e.g., Asymmetric End to End Latency) indicating requesting maximum end to end latency asymmetry/difference between [at least one uplink communication channel] and [at least one downlink communication channel] is less than and/or equal to a value (e.g., 2 ms); a third parameter (e.g., End to End Latency) indicating requesting end to end latency between two network elements is less than and/or equal to a value (e.g., 5 ms, 10 ms); an identity of the wireless device (e.g., UE 1); an identity of a second wireless device (e.g., UE 2); an identity of a first PDU session for the UE 1; and/or an identity of a second PDU session for the UE 2. In an example, the definition/content of the parameter/Channel Symmetry Request may be similar to the definition/content of the parameter/Channel Symmetry Request as described in FIG. 19. In an example, the definition/content of the second parameter/Asymmetric End to End Latency may be similar to the definition/content of the second parameter/Asymmetric End to End Latency as described in the FIG. 19. In an example, the definition/content of the third parameter/End to End Latency may be similar to the definition/content of the third parameter/End to End Latency as described in the FIG. 19. In an example, the definition/content of the identity of the UE 1 and/or UE 2 may be similar to the definition/content of the identity of the UE 1 and/or UE 2 as described in the FIG. 19. For brevity, further description will not be repeated here. In an example, the parameter/Channel Symmetry Request, the identity of the UE 1, and/or the identity of the first PDU session may indicate the UE 1 requesting symmetric communication channels between the UE 1 and a core network (e.g., core network 1) over the first PDU session. In an example, the core network (e.g., core network 1) may comprise an AMF (e.g., AMF 1), the SMF (e.g., SMF 1), and/or a UPF (e.g., UPF 1). In an example, the parameter/Channel Symmetry Request, the identity of the UE 1, the identity of the UE 2, the identity of the first PDU session, and/or the identity of the second PDU session may indicate the UE 1 requesting symmetric communication channels between the UE 1 and the UE 2, wherein the symmetric communication channels may be over the first PDU session and/or the second PDU session. In an example, the second PDU session may be established by the UE 2 with the core network 1. In an example, the second PDU session may be established by the UE 2 with a core network 2, wherein the core network 2 may comprise an AMF (e.g., AMF 2), an SMF (e.g., SMF 2), and/or a UPF (e.g., UPF 2).

In an example, the network may be a communication system (e.g., 5G system), where the communication system may comprise base station(s), AMF(s), SMF(s) and/or UPF(s). In an example, the first message may comprise a NAS message (e.g., PDU Session Establishment Request). In an example, the UE 1 may send the PDU Session Establishment Request message to the SMF via a base station (e.g., (R)AN) and/or an AMF. For example, the UE 1 may send a NAS message to the AMF. In an example, the NAS message may comprise at least one of: S-NSSAI(s), UE Requested DNN, PDU Session ID (s) (e.g., the identity of the first PDU session, and/or the identity of the second PDU session), Request type, Old PDU Session ID, and/or a N1 SM container. In an example, the N1 SM container may comprise a PDU Session Establishment Request message and/or a Port Management Information Container. In an example, the PDU Session Establishment Request message may comprise the parameter/Channel Symmetry Request; the second parameter/Asymmetric End to End Latency; the third parameter/End to End Latency; the identity of the wireless device (e.g., UE 1); the identity of the second wireless device (e.g., UE 2); the identity of the first PDU session; and/or the identity of the second PDU session.

In an example, the PDU Session Establishment Request message may comprise at least one of: PDU session ID (s), Requested PDU Session Type, a Requested SSC mode, 5GSM Capability, PCO, SM PDU DN Request Container, Number of Packet Filters, Header Compression Configuration, UE Integrity Protection Maximum Data Rate, Always-on PDU Session Requested, and/or the like.

In an example, in response to the message received, the AMF may select an SMF, and send a Nsmf_PDUSession_CreateSMContext Request message to the SMF. The Nsmf_PDUSession_CreateSMContext Request message may comprise at least one of: SUPI, selected DNN, UE requested DNN, S-NSSAI(s), PDU Session ID (s), AMF ID, Request Type, [PCF ID, Same PCF Selection Indication], Priority Access, [Small Data Rate Control Status], N1 SM container (PDU Session Establishment Request message), User location information, Access Type, RAT Type, PEI, GPSI, UE presence in LADN service area, Subscription For PDU Session Status Notification, DNN Selection Mode, Trace Requirements, Control Plane CIoT 5GS Optimisation indication, and/or Control Plane Only indicator.

In response to the message received, the SMF may take one or more actions. In an example action, the SMF may send a message (e.g., policy request) to a PCF. In an example, the policy request message (e.g., Npcf_SMPolicyControl_Create service) may comprise at least one of: the parameter/Channel Symmetry Request; the second parameter/Asymmetric End to End Latency; the third parameter/End to End Latency; the identity of the wireless device (e.g., UE 1); the identity of the second wireless device (e.g., UE 2); the identity of the first PDU session; and/or the identity of the second PDU session. In an example, the policy request message may comprise at least one of: Access Type, IPv4 address and/or IPv6 prefix of the wireless device, PEI, GPSI, User Location Information, UE Time Zone, Serving Network (PLMN ID, or PLMN ID and NID), Charging Characteristics information, Session AMBR, subscribed default QoS information, Trace Requirements and Internal Group Identifier, DN Authorization Profile Index, Framed Route information. MA PDU Request indication, MA PDU Network-Upgrade Allowed indication, ATSSS capabilities of the MA PDU Session, QoS constraints from the VPLMN, Satellite Backhaul Category information, list of NWDAF instance Ids used by AMF, SMF, and UPF and corresponding Analytics ID(s).

In response to the message received from the SMF, the PCF may take one or more actions. In an example action, the PCF may determine whether to accept the requesting of symmetric communication channels, based on at least one of: the policy request message; resource of the core network; local operator policy; and/or subscription information of the wireless device. For example, the policy request message may comprise the parameter/Channel Symmetry Request, the second parameter/Asymmetric End to End Latency, the third parameter/End to End Latency, the identity of the wireless device (e.g., UE 1), the identity of the second wireless device (e.g., UE 2), the identity of the first PDU session, and/or the identity of the second PDU session; the resource of the network (e.g., AMF, SMF, and/or UPF) may support the symmetric communication channels; the local operator policy and/or subscription information of the wireless device may indicate that the symmetric communication channels is allowed to the wireless device; based on above information, the PCF may determine to accept the requesting of symmetric communication channels. In an example, based on the PCF determining whether to accept the requesting of symmetric communication channels, the PCF may determine a fourth parameter (e.g., Channel Symmetry Accept) indicating accepting the requesting of symmetric communication channels.

In an example action, the PCF may determine at least one Policy and Charging Control (PCC) rule/PCC policy for the symmetric communication channels based on at least one of: the determining whether to accept the requesting of symmetric communication channels; the PDU session establishment request message; resource of the core network; local operator policy; and/or subscription information of the wireless device. In an example action, the PCF may make (PCC) policy decision for the symmetric communication channels based on at least one of: the determining whether to accept the requesting of symmetric communication channels; the PDU session establishment request message; resource of the core network; local operator policy; and/or subscription information of the wireless device. For example, the PCF has determined the fourth parameter/Channel Symmetry Accept indicating accepting the requesting of symmetric communication channels; the policy request message may comprise the parameter/Channel Symmetry Request, the second parameter/Asymmetric End to End Latency, the third parameter/End to End Latency, the identity of the wireless device (e.g., UE 1), the identity of the second wireless device (e.g., UE 2), the identity of the first PDU session, and/or the identity of the second PDU session; the resource of the network (e.g., AMF, SMF, and/or UPF) may support the symmetric communication channels; the local operator policy and/or subscription information of the wireless device may indicate that the symmetric communication channels is allowed to the wireless device; based on above information, the PCF may determine PCC rules for the symmetric communication channels for the wireless device.

In an example, the at least one PCC rule may be a set of information enabling the detection of a service data flow and providing parameters for policy control and/or charging control and/or other control or support information. In an example, the symmetric communication channels may comprise the first PDU session and/or the second PDU session. In an example, the at least one PCC rule determined by the PCF may be applied to uplink first PDU session and/or downlink first PDU session, wherein the uplink PDU session may be between the UE 1 and the core network 1 (e.g., UPF 1), and downlink PDU session may be between the core network 1 (e.g., UPF 1) and the UE 1. In an example, the at least one PCC rule determined by the PCF may be applied to the first PDU session and/or the second PDU session between the UE 1 and the UE 2. In an example, the first PDU session and/or the second PDU session may comprise at least one QoS flow and/or at least one service data flow. In an example, the at least one PCC rule determined by the PCF may be applied to uplink of the at least one QoS flow and/or uplink of the at least one service data flow, and/or downlink of the at least one QoS flow and/or downlink of the at least one service data flow. In an example, the at least one PCC rule determined by the PCF may be applied to the at least one QoS flow and/or at least one service data flow of the first PDU session, and/or the at least one QoS flow and/or at least one service data flow of the second PDU session, between the UE 1 and the UE 2.

In an example, the at least one service data flow (SDF) may be an aggregate set of packet flows carried through the UPF that matches a service data flow template. In an example, the service data flow template may be set of service data flow filters in a PCC Rule or an application identifier in a PCC rule referring to an application detection filter in the SMF and/or in the UPF, required for defining a service data flow. In an example, the Service data flow filter may be a set of packet flow header parameter values/ranges used to identify one or more of the packet flows in the UPF. In an example, a QoS Flow may be the finest granularity of QoS differentiation in the PDU Session. In an example, a QoS flow may be similar to a bearer in 4G/LTE. A QoS Flow ID (QFI) may be used to identify a QoS Flow in the 5G System. User Plane traffic with the same QFI within a PDU Session may receive the same traffic forwarding treatment (e.g., scheduling, admission threshold). The QFI may be carried in an encapsulation header on N3 interface (and/or N9 interface) e.g., without any changes to the e2e packet header. QFI may be used for all PDU Session Types. The QFI may be unique within a PDU Session. The QFI may be dynamically assigned or may be equal to the 5QI. Within the 5GS, a QoS Flow may be controlled by the SMF and may be preconfigured, or established via the PDU Session Establishment procedure, or the PDU Session Modification procedure.

In an example, the at least one PCC rule may comprise at least one of: at least one charging control rule; at least one policy control rule; at least one usage monitoring control rule; at least one application detection and control rule; at least one traffic steering control rule; and/or at least one service data flow detection information (e.g., service data flow template). In an example, the at least one charging control rule may comprise at least one of: an information element indicating a charging method/charging type; an information element indicating at least one charging rate; and/or an information element indicating at least one identifier or address of a charging function (CHF). In an example, the charging method/charging type may comprise at least one of: online charging, offline charging, and/or converged charging. For example, the PCF may determine the at least one charging control rule for the symmetric communication channels, wherein the at least one charging control rule may comprise at least one charging rate for the symmetric communication channels. In an example, the at least one charging control rule may comprise a charging method (e.g., offline charging) for the symmetric communication channels. In an example, the at least one charging control rule may comprise an address of a CHF for the symmetric communication channels.

In an example, the at least one policy control rule may comprise at least one QoS control rule and/or at least one gating control rule. In an example, the policy control rule may be used for policy control, where the at least one QoS control rule may be used for QoS control, and the at least one gating control rule may be used for gating control. In an example, the QoS control rule may be used to authorize QoS on a service data flow and/or a QoS flow. In an example, the gating control rule may be used to discard packets that don't match service data flow of the at least one gating control rule and/or associated at least one PCC rules. In an example, the usage monitoring control rule may be used to monitor, both volume and time usage, and report the accumulated usage of network resources. In an example, the application detection and control rule may comprise a request to detect a specified application traffic, report to a PCF on a start or stop of application traffic and to apply a specified enforcement and charging actions. In an example, the traffic steering control rule may be used to activate/deactivate traffic steering policies for steering a subscriber's traffic to appropriate operator or 3rd party service functions (e.g., NAT, antimalware, parental control, DDoS protection) in an (S)Gi-LAN. In an example, the service data flow detection information (e.g., service data flow template) may comprise a list of service data flow filters or an application identifier that references the corresponding application detection filter for the detection of the service data flow. In an example, the service data flow detection information (e.g., service data flow template) may comprise combination of traffic patterns of the Ethernet PDU traffic.

In an example, the at least one PCC rule determined by the PCF may comprise at least one QoS parameter: 5QI/QCI, ARP, RQA, GFBR, MFBR and/or maximum packet loss rate as described in FIG. 8. In an example, the QoS policy/parameters determined by the SMF may comprise a QoS class identifier (QCI). The QCI may be a scalar that is used as a reference to a specific packet forwarding behavior (e.g., packet loss rate, packet delay budget) to be provided to a SDF. This may be implemented in the access network by the QCI referencing node specific parameters that control packet forwarding treatment (e.g., scheduling weights, admission thresholds, queue management thresholds, link layer protocol configuration, etc.), that have been pre-configured by the operator at a specific node(s) (e.g., base station). In an example, the at least one PCC rule determined by the PCF may comprise a Reflective QoS Indication (RQI) indicating symmetric communication channels for the wireless device. In an example, the RQI may indicate maximum end to end latency asymmetry/difference between [at least one uplink communication channel] and [at least one downlink communication channel] is less than and/or equal to a value (e.g., 2 ms). In an example, the RQI may indicate end to end latency between two network elements is less than and/or equal to a value (e.g., 5 ms, 10 ms).

In an example, the at least one PCC rule determined by the PCF may comprise at least one of: a fifth parameter (e.g., Channel Symmetry Indication); the second parameter/Asymmetric End to End Latency; and/or the third parameter/End to End Latency. In an example, the fifth parameter (e.g., Channel Symmetry Indication) may indicate the at least one PCC rule is applied to symmetric communication channels for the wireless device. In an example, the second parameter/Asymmetric End to End Latency may indicate maximum end to end latency asymmetry/difference between [at least one uplink communication channel] and [at least one downlink communication channel] is less than and/or equal to a value (e.g., 2 ms). In an example, the third parameter/End to End Latency may indicate end to end latency between two network elements is less than and/or equal to a value (e.g., 5 ms, 10 ms).

In an example, the PCF may send a policy response message (e.g., Npcf_SMPolicyControl_Create service response) to the SMF, the policy response message may comprise the at least one PCC rule determined by the PCF.

In response to the message received from the PCF, the SMF may take one or more actions based on the policy response message (e.g., the at least one PCC rule determined by the PCF). In an example action, the SMF may enforce the at least one PCC rule by determining/deriving at least one QoS policy/parameters. In an example, the at least one QoS policy/parameters may comprise at least one QoS parameters: 5QI/QCI, ARP, RQA, GFBR, MFBR, maximum packet loss, RQI. In an example, the at least one QoS policy/parameters determined/derived by the SMF (e.g., 5QI/QCI, ARP, RQA, GFBR, MFBR, maximum packet loss, RQI) may be the same as the at least one QoS parameter in the at least one PCC rule. In an example, the RQI may indicate requesting symmetric communication channels for the wireless device. In an example, the RQI may indicate maximum end to end latency asymmetry/difference between [at least one uplink communication channel] and [at least one downlink communication channel] is less than and/or equal to a value (e.g., 2 ms). In an example, the RQI may indicate end to end latency between two network elements is less than and/or equal to a value (e.g., 5 ms, 10 ms).

In an example action, the SMF may send a message (e.g., Nsmf_PDUSession_CreateSMContext Response) to the AMF. In an example, the Nsmf_PDUSession_CreateSMContext Response message may comprise at least one of: the parameter/Channel Symmetry Request; the second parameter/Asymmetric End to End Latency; the third parameter/End to End Latency; and/or the fourth parameter/Channel Symmetry Accept. In an example, the Nsmf_PDUSession_CreateSMContext Response message may comprise the RQI).

In an example, the Nsmf_PDUSession_CreateSMContext Response message may comprise at least one of: Cause, SM Context ID and/or a N1 SM container, wherein the N1 SM container may comprise a PDU Session Reject message. In an example, the PDU Session Reject message may comprise a cause value indicating the reject reason. In an example, the Nsmf_PDUSession_CreateSMContext Response message may comprise N2 SM information, wherein the N2 SM information may comprise list of PDU session(s) to be setup by the base station for the symmetric communication channels. For example, the N2 SM information may comprise at least one of: PDU Session ID (s) for the symmetric communication channels, QFI(s) for the symmetric communication channels, QoS Profile(s) for the symmetric communication channels (e.g., the QoS policy/parameters determined by the SMF), CN Tunnel Info, S-NSSAI from the Allowed NSSAI, Session-AMBR, PDU Session Type, User Plane Security Enforcement information, UE Integrity Protection Maximum Data Rate, RSN, and/or PDU Session Pair ID.

In response to the message received, the AMF may take one or more actions. In an example action, the AMF may send a message (e.g., PDU Session Resource Setup) to the base station. In an example, the PDU Session Resource Setup message may comprise one or more IEs/parameters of the Nsmf_PDUSession_CreateSMContext Response message. For example, the PDU Session Resource Setup may comprise at least one of: the parameter/Channel Symmetry Request; the second parameter/Asymmetric End to End Latency; the third parameter/End to End Latency; the fourth parameter/Channel Symmetry Accept; and/or the RQI.

In an example, the PDU Session Resource Setup message may comprise at least one of: AMF UE NGAP ID, RAN UE NGAP ID, RAN Paging Priority, NAS-PDU, PDU Session Resource Setup Request List for the symmetric communication channels, and/or UE Aggregate Maximum Bit Rate. In an example, the PDU Session Resource Setup Request List may comprise list of PDU session(s) to be setup by the base station for the symmetric communication channels. For example, the PDU Session Resource Setup Request List may comprise at least one of: PDU Session ID (s), S-NSSAI, PDU Session NAS-PDU, and/or PDU Session Resource Setup Request Transfer. In an example, the PDU Session NAS-PDU may comprise a NAS message sent from core network (e.g., SMF/AMF) to the wireless device. In an example, the PDU Session Resource Setup Request Transfer may comprise PDU session information to be setup by the base station for the symmetric communication channels, wherein the PDU session information may be associated with the SMF.

In response to the message received, the base station (e.g., (R)AN) may take one or more actions. In an example action, the base station may determine whether to accept the requesting of symmetric communication channels, based on at least one of: the PDU Session Resource Setup message, the resource of the base station, local policy, and/or subscription information of the wireless device.

In an example, based on the base station determining whether to accept the requesting of symmetric communication channels, the base station may determine a fourth parameter (e.g., Channel Symmetry Accept) indicating accepting the requesting of symmetric communication channels. In an example, the base station may determine radio bearer and/or QoS resource for the symmetric communication channels, based on at least one of: the determining that whether to accept the requesting of symmetric communication channels, the PDU Session Resource Setup message, the resource of the base station, the local policy, and/or the subscription information of the wireless device. In an example, the radio bearer may comprise at least one data radio bearer (DRB) and/or at least one signal radio bearer (SRB). In an example, the base station may determine radio bearer configuration information for the symmetric communication channels, based on at least one of: the determining that whether to accept the requesting of symmetric communication channels, the PDU Session Resource Setup message, the resource of the base station, the local policy, and/or the subscription information of the wireless device. In an example, the base station may determine the at least one data radio bearer (DRB) and/or the at least one signal radio bearer (SRB) for the symmetric communication channels, based on at least one of: the determining that whether to accept requesting of symmetric communication channels, the PDU Session Resource Setup message, the resource of the base station, the local policy, and/or the subscription information of the wireless device. In an example, the base station may determine RRC configuration information for the symmetric communication channels, based on at least one of: the determining that whether to accept requesting of symmetric communication channels, the PDU Session Resource Setup message, the resource of the base station, the local policy, and/or the subscription information of the wireless device. In an example, the base station may determine at least one logical channel for the symmetric communication channels, based on at least one of: the determining that whether to accept requesting of symmetric communication channels, the PDU Session Resource Setup message, the resource of the base station, the local policy, and/or the subscription information of the wireless device. The above actions of the base station may be similar to the actions of the base station as described in FIG. 19. For brevity, further description will not be repeated here.

In an example action, in response to the message received, the base station may determine time and/or frequency resource for the symmetry communication channels based on at least one of: SRS measurements report and/or CSI (measurements) report from the wireless device, the determining that whether to accept requesting of symmetric communication channels, the second message, the resource of the base station, the local policy, and/or the subscription information of the wireless device. The above actions of the base station may be similar to the actions of the base station as described in FIG. 23. For brevity, further description will not be repeated here.

In an example action, the base station may send an RRC message (e.g., RRCReconfiguration) to the wireless device. The RRCReconfiguration message may indicate accepting the symmetric communication channels. In an example, the RRCReconfiguration message may comprise at least one of: the RRC configuration information for the symmetric communication channels, the radio bearer configuration information for the symmetric communication channels, the logical channel configuration information for the symmetric communication channels, the second parameter/Asymmetric End to End Latency, the third parameter/End to End Latency, and/or the fourth parameter/Channel Symmetry Accept.

In an example, the base station may send a third message to the wireless device, the third message may comprise at least one of: a Downlink Control Information (DCI), and/or a Cell Radio Network Temporary Identifier (C-RNTI). In an example, the third message may be a MAC layer message. In an example, the third message may be a physical layer message. In an example, the base station may send the third message to the wireless device via a PDCCH. In an example, the DCI may indicate time and/or frequency resource for the symmetry communication channels. In an example, the C-RNTI may indicate a RRC Connection and scheduling, wherein the RRC Connection and scheduling are dedicated to the wireless device. In an example, the third message and/or the DCI may indicate an allowed end to end latency asymmetry/difference between the at least one uplink communication channel (e.g., PUSCH) and the at least one downlink communication channel (e.g., PDSCH) is less than and/or equal to a value (e.g., 2 ms). In an example, the third message and/or the DCI may indicate an allowed end to end latency between two network elements (e.g., between the UE 1 and the UE2, between the UE 1 and the (R)AN) is less than and/or equal to a value (e.g., 5 ms, 10 ms).

In an example action, the base station may send a response message (e.g., PDU Session Resource Setup Response) message to the AMF indicating accepting the symmetric communication channels. For example, the (R)AN may send the PDU Session Resource Setup Response message to the AMF, wherein the PDU Session Resource Setup Response message may comprise the fourth parameter/Channel Symmetry Accept indicating that the (R)AN accepts the requesting of symmetric communication channels. In an example, the PDU Session Resource Setup Response message may comprise at least one of: AMF UE NGAP ID, RAN UE NGAP ID, PDU Session Resource Setup Response List, PDU Session Resource Failed to Setup List, and/or Criticality Diagnostics. In an example, the Criticality Diagnostics IE may be sent by the NG-RAN node and/or the AMF when parts of a received message have not been comprehended or were missing, or if the message contained logical errors.

In an example, in response to the message received, the AMF may send a message (e.g., Nsmf_PDUSession_UpdateSMContext Request) to the SMF. In an example, the Nsmf_PDUSession_UpdateSMContext Request message may comprise at least one of: the fourth parameter/Channel Symmetry Accept, SM Context ID, N2 SM information and/or Request Type. In an example, the N2 SM information may comprise one or more IEs/parameters of the PDU Session Resource Setup Response message.

In an example, in response to the message received from the AMF and/or the message received from the PCF, the SMF may take one or more actions. In an example action, the SMF may enforce the at least one PCC rule by determining at least one user plane rule for the symmetric communication channels for the wireless device. In an example, the SMF may determine the at least one user plane rule based on at least one of: the at least one PCC rule determined by the PCF; the QoS policy/parameters determined by the SMF; the parameter/Channel Symmetry Request; the second parameter/Asymmetric End to End Latency; the third parameter/End to End Latency; the fourth parameter/Channel Symmetry Accept; and/or the RQI. In an example, the at least one user plane rule determined by the SMF may comprise at least one of: the second parameter/Asymmetric End to End Latency; the third parameter/End to End Latency; and/or the fifth parameter/Channel Symmetry Indication.

In an example, the at least one user plane rule may comprise at least one of: at least one packet detection rule; at least one forwarding action rule; at least one QoS enforcement rule; and/or at least one usage reporting rule. In an example, the at least one packet detection rule may comprise data/traffic packet detection information, e.g., one or more match fields against which incoming packets are matched and may apply other user plane rules (e.g., at least one forwarding action rule, at least one QoS enforcement rule, and/or at least one usage reporting rule) to the data/traffic packets matching the packet detection rule. In an example, the at least one forwarding action rule may comprise an apply action parameter, which may indicate whether a UP function may forward, duplicate, drop or buffer the data/traffic packet respectively. In an example, the at least one usage reporting rule may be used to measure the network resources usage in terms of traffic data volume, duration (e.g., time) and/or events for the symmetric communication channels, according to a measurement method in the usage reporting rule. In an example, the event may indicate a start of time service and/or a stop of time service. In an example, the at least one QoS enforcement rule may comprise instructions to request the UP function to perform QoS enforcement of the user plane traffic.

In an example, the SMF may determine a packet detection rule based on the service data flow detection information (e.g., service data flow template) received from the PCF. In an example, the SMF may determine a forwarding action rule based on the policy control rule (e.g., QoS control rule) received from the PCF. In an example, the SMF may determine a usage reporting rule based on the usage monitoring control rule.

In an example action, the SMF may select a UPF to support the symmetric communication channels based on the capability of the UPF that whether the UPF supports the symmetric communication channels. In an example action, the SMF may send to the UPF a message (e.g., N4 session establishment/modification request) comprising the at least one user plane rule. In response to receiving the message from the SMF, the UPF may install the at least one user plane rule received from the SMF. The UPF may send to the SMF a response message (e.g., N4 session establishment/modification response), and enforce the user plane rules.

In an example, in response to the message received, the UPF may take one or more actions based on the at least one user plane rule. In an example action, based on the N4 session establishment/modification request message, the UPF may determine whether to provide the symmetric communication channels based on the capability of the UPF and/or local configuration. In an example action, the UPF may allocate resources for the symmetric communication channels. In an example action, the UPF may schedule uplink and/or downlink data packet to support the symmetric communication channels. In an example action, the UPF may schedule uplink and/or downlink data packet to support the asymmetric End to End Latency. In an example action, the UPF may schedule uplink and/or downlink data packet to support the End to End Latency.

In an example action, the UPF may enforce the at least one user plane rule. For example, the UPF may enforce the at least one packet detection rule by matching a user data/traffic packet with service data flow template (e.g., service data flow filters and/or application identifiers) and may apply other user plane rules (e.g., forwarding action rule, QoS enforcement rule, and usage reporting rule) to the data/traffic packets matched the packet detection rule. In an example, the UPF may enforce the at least one forwarding action rule by forwarding, duplicating, dropping or buffering a data/traffic packet respectively. In an example, the UPF may redirect the traffic to a web portal of the operator. In an example, the UPF may enforce the at least one QoS enforcement rule by applying at least one of QoS parameters: 5QI, ARP, MBR, GBR to a service data flow; In an example, the UPF may enforce the at least one QoS enforcement rule by applying at least one of QoS parameters: Session AMBR and default 5QI/ARP combination to a PDU session.

In an example, the UPF may enforce the at least one usage reporting rule by measuring network resources usage in terms of traffic data volume, duration (e.g., time) and/or events for the symmetric communication channels (e.g., associated PDU sessions, at least one QoS flow/at least one SDF), according to a measurement method in the usage reporting rule; the UPF may report the network resources usage to the SMF when the quota/threshold reached, and/or event and/or another trigger is (are) met. In an example, the UPF may send the network resources usage of the symmetric communication channels to the SMF. For example, the UPF may send a message (e.g., N4 Session Report) to the SMF, the N4 Session Report message may comprise network resources usage of the symmetric communication channels (e.g., the symmetric communication channels associated PDU sessions/at least one QoS flow/at least one SDF) for the wireless device.

In response to the message received from the UPF, the SMF may enforce the at least one PCC rule by sending the network resources usage of the symmetric communication channels to a charging function (CHF). In an example, the SMF may determine/select the CHF based on local configuration (e.g., for the symmetric communication channels). In an example, the SMF may determine/select the CHF based on the PCC rule(s) (e.g., address of a CHF). For example, the SMF may send a message (e.g., Charging Data Request) to the selected CHF, the Charging Data Request message may comprise the network resources usage of the symmetric communication channels for the wireless device. For example, the Charging Data Request message may comprise at least one of: time usage of the network resources usage of the symmetric communication channels, volume usage of the network resources usage of the symmetric communication channels, events of the network resources usage of the symmetric communication channels. In an example, the Charging Data Request message may comprise the parameter/Channel Symmetry Request; the second parameter/Asymmetric End to End Latency; the third parameter/End to End Latency; the identity of the wireless device (e.g., UE 1); the identity of the second wireless device (e.g., UE 2); the identity of the first PDU session; and/or the identity of the second PDU session.

In response to the message received, the CHF may send a response message (e.g., Charging Data Response) to the SMF. In response to the message received, the SMF may send a response message (e.g., N4 Session Report Ack) to the UPF.

In an example action, in response to the message received from the UE, the SMF may send a NAS response message (e.g., PDU session establishment response) to the wireless device. In an example, the PDU session establishment response message (e.g., PDU Session Establishment Accept) may indicate accepting the requesting from the wireless device for the symmetric communication channels. In an example, the PDU session establishment response message may indicate accepting the request for the asymmetric End to End Latency. In an example, the PDU session establishment response message may indicate accepting the request for the End to End Latency. In an example, the PDU session establishment response message may comprise at least one of: the QoS policy/parameters determined by the SMF; the RQI; the second parameter/Asymmetric End to End Latency; the third parameter/End to End Latency; the fourth parameter/Channel Symmetry Accept; and/or the fifth parameter/Channel Symmetry Indication.

In an example, the SMF may send the NAS response message to the wireless device via the AMF and/or the base station. For example, the SMF may send a Namf_Communication_N1N2MessageTransfer message to the AMF. In an example, the Namf_Communication_N1N2MessageTransfer message may comprise at least one of: the QoS policy/parameters determined by the SMF; the RQI; the second parameter/Asymmetric End to End Latency; the third parameter/End to End Latency; the fourth parameter/Channel Symmetry Accept; and/or the fifth parameter/Channel Symmetry Indication. In an example, the Namf_Communication_N1N2MessageTransfer message may comprise at least one of: PDU Session ID (s) for the symmetric communication channels, N2 SM information and/or N1 SM container. In an example, the N2 SM information may comprise information sent to the base station. In an example, the N1 SM container may comprise information sent to the wireless device. In an example, the N2 SM information may comprise at least one of: the QoS policy/parameters determined by the SMF; the RQI; the second parameter/Asymmetric End to End Latency; the third parameter/End to End Latency; the fourth parameter/Channel Symmetry Accept; and/or the fifth parameter/Channel Symmetry Indication; PDU Session ID (s) for the symmetric communication channels, QFI(s) for the symmetric communication channels, QoS Profile(s) for the symmetric communication channels, CN Tunnel Info, S-NSSAI from the Allowed NSSAI, Session-AMBR, PDU Session Type, User Plane Security Enforcement information, UE Integrity Protection Maximum Data Rate, RSN, and/or PDU Session Pair ID. In an example, the N1 SM container may comprise a PDU Session Establishment Accept message/parameter, wherein the PDU Session Establishment Accept message/parameter may comprise at least one of: the QoS policy/parameters determined by the SMF; the RQI; the second parameter/Asymmetric End to End Latency; the third parameter/End to End Latency; the fourth parameter/Channel Symmetry Accept; and/or the fifth parameter/Channel Symmetry Indication; QoS Rule(s) and QoS Flow level QoS parameters if needed for the QoS Flow(s) associated with the QoS rule(s) for the symmetric communication channels, selected SSC mode, S-NSSAI(s), UE Requested DNN, allocated IPv4 address, interface identifier, Session-AMBR, selected PDU Session Type, Reflective QoS Timer (if available), P-CSCF address(es), Control Plane Only indicator, Header Compression Configuration, Always-on PDU Session Granted, Small Data Rate Control parameters, Small Data Rate Control Status, and/or Serving PLMN Rate Control.

In an example, the AMF may send the N2 SM information to the base station. In an example, the AMF may send the N1 SM container to the wireless device in a NAS message. In an example, in response to the message received from the AMF, based on the N2 SM information, the base station may take one or more actions. In an example action, the base station may send an RRC message (e.g., RRCReconfiguration) to the wireless device. The RRCReconfiguration message may indicate accepting the symmetric communication channels. In an example, the RRCReconfiguration message may comprise at least one of: the RC configuration information for the symmetric communication channels, the radio bearer configuration information for the symmetric communication channels, the logical channel configuration information for the symmetric communication channels, the second parameter/Asymmetric End to End Latency, the third parameter/End to End Latency, and/or the fourth parameter/Channel Symmetry Accept.

In an example action, the base station may associate/map the PDU session to the at least one QoS flow/service data flow for the symmetric communication channels. In an example, the base station may associate/map the at least one QoS flow/service data flow to the at least one DRB and/or at least one SRB for the symmetric communication channels. In an example, the base station may associate/map the at least one DRB and/or at least one SRB to the at least one logical channel and/or at least one physical channel for the symmetric communication channels. In an example, the base station may allocate resources for the symmetric communication channels. In an example action, the base station may schedule uplink and/or downlink data packet to support the symmetric communication channels. In an example action, the base station may schedule uplink and/or downlink data packet to support the asymmetric End to End Latency. In an example action, the base station may schedule uplink and/or downlink data packet to support the End to End Latency.

In response to the message received from the SMF, AMF and/or the base station, the wireless device may take one or more actions based on at least one of: the QoS policy/parameters determined by the SMF; the RQI; the second parameter/Asymmetric End to End Latency; the third parameter/End to End Latency; the fourth parameter/Channel Symmetry Accept; and/or the fifth parameter/Channel Symmetry Indication. In an example action, the wireless device may allocate radio bearer/QoS resource for the symmetric communication channels based on at least one of: the RRC configuration information for the symmetric communication channels, the radio bearer configuration information for the symmetric communication channels, the logical channel configuration information for the symmetric communication channels, the second parameter/Asymmetric End to End Latency, the third parameter/End to End Latency, and/or the fourth parameter/Channel Symmetry Accept.

In an example action, the wireless device may schedule uplink and/or downlink data packet to support the symmetric communication channels. In an example action, the wireless device may schedule uplink and/or downlink data packet to support the asymmetric End to End Latency. In an example action, the wireless device may schedule uplink and/or downlink data packet to support the End to End Latency.

In an example action, the wireless device may establish at least one RRC connection for the symmetric communication channels. In an example, the RRC connection for the symmetric communication channels may be between the wireless device and the base station. The wireless device and the base station may establish the RRC connection for the symmetric communication channels based on the procedure as shown in FIG. 15. In an example, the RRC connection for the symmetric communication channels may be between two wireless devices (e.g., UE 1 and UE 2). In an example, the at least one uplink communication channel and/or the at least one downlink communication channel may be associated with the RRC connection. In an example, the RRC connection for the symmetric communication channels may be associated with the PDU session for the symmetric communication channels.

In an example, the second wireless device (e.g., UE 2 as shown in the FIG. 27) may take the similar actions as UE 1 as described above. The UE 2 may establish a second PDU session via the (R)AN, the AMF, the SMF, and/or the UPF, where the second PDU session establishment procedure may be similar to the PDU session established by the UE 1. In an example, the UE 2 may establish the second PDU session via a (R)AN 2, a AMF 2, a SMF 2, and/or a UPF 2.

In an example action, UE 1 and UE 2 may perform/run applications and/or services over the symmetric communication channels. For example, the Relay_a/UE 1 and Relay_b/UE 2 may perform/run channel-based alignment method for Line Current Differential Protection between the Relay_a/UE 1 and Relay_b/UE 2 over the symmetric communication channels (e.g., PDU session 1 and/or PDU session 2, QoS flows/service data flows, RRC connections, radio bearers). In an example, UE 1 and UE 2 may play games over the symmetric communication channels (e.g., PDU session 1 and/or PDU session 2, QoS flows/service data flows, RRC connections, radio bearers).

In an example embodiment, a base station may receive a radio resource control (RRC) request message from a wireless device. The RRC request message may comprising a parameter indicating requesting symmetric communication channels. In an example, based on the parameter, the base station may determine radio bearer configuration information for the symmetric communication channels. In an example, the base station may send to the wireless device an RRC response message indicating the radio bearer configuration information. In an example, the RRC response may indicate accepting the symmetric communication channels. In an example, the symmetric communication channels may be applied for a service and/or an application of the wireless device. In an example, the parameter may indicate requesting a radio bearer for the symmetric communication channels, wherein the radio bearer may comprise a data radio bearer (DRB) and/or a signaling radio bearer (SRB). In an example, the parameter may indicate requesting a PDU session for the symmetric communication channels, wherein the PDU session may be associated with at least one radio bearer, wherein the at least one radio bearer comprises at least one data radio bearer and/or at least one signaling radio bearer. In an example, based on the parameter, the base station may determine radio bearer configuration information of a data radio bearer. In an example, the symmetric communication channels may comprise symmetric uplink communication channel and/or downlink communication channel. In an example, the symmetric uplink communication channel and/or downlink communication channel may indicate end to end latency of the uplink communication channel equals to end to end latency of the downlink communication channel. In an example, the symmetric uplink communication channel and/or downlink communication channel may indicate a difference between [end to end latency of the uplink communication channel] and [end to end latency of the downlink communication channel] is less than a configured value, wherein the configured value is 2 ms. In an example, the uplink communication channel may indicate a communication path from a first network element to a second network element, and the downlink communication channel may indicate a communication path from the second network element to the first network element. In an example, the first network element may comprise at least one of: a first wireless device; a first base station; a first access and mobility management function (AMF); a first session management function (SMF); a first user plane function (UPF); a first network exposure function (NEF); and/or a first router. In an example, the second network element may comprise at least one of: a second wireless device; a second base station; a second AMF; a second SMF; a second UPF; a second NEF; and/or a second router.

In an example, the communication path may comprise at least one of: at least one physical uplink control channel (PUCCH); at least one physical downlink control channel (PDCCH); at least one physical uplink shared channel (PUSCH); at least one physical downlink shared channel (PDSCH); at least one signaling radio bearer (SRB); at least one data radio bearer (DRB); at least one RRC connection; at least one service data flow; at least one QoS flow; and/or at least one protocol data unit (PDU) session. In an example, the communication path may comprise a path of communication over at least one of: an air interface; an ethernet cable; a fiber cable; and/or a communication network. In an example, the parameter may indicate that a max latency asymmetry between uplink channel and downlink channel is less than and/or equal a configured value. In an example, the parameter may indicate a max latency asymmetry between uplink channel and downlink channel is less than 2 ms. In an example, the parameter may indicate end-to-end latency between two network element is less than 5 ms or 10 ms. In an example, the RRC request message may comprise a second parameter indicating end-to-end latency between two network element is less than 5 ms or 10 ms. In an example, the RRC request message may comprise an identity of the wireless device, wherein the identity of the wireless device comprises at least one of: a Generic Public Subscription Identifier (GPSI), wherein the GPSI may comprise a Mobile Station Integrated Services Digital Network (MSISDN) and/or an external identifier; a Subscription Permanent Identifier (SUPI), wherein the SUPI may comprise an International Mobile Subscriber Identity (IMSI) and/or Network Access Identifier (NAI); a Subscription Concealed Identifier (SUCI); a 5G Globally unique Temporary Identity (5G-GUTI); a permanent equipment identifier (PEI), wherein the PEI may comprise an International Mobile Equipment Identity (IMEI); an IP address, wherein the IP address may comprise an IPv4 address and/or an IPv6 prefix; and/or an application level identifier to identify the wireless device. In an example, the RRC request message may comprise an identity of a second wireless device, wherein the symmetry communication channels is between the wireless device and the second wireless device. In an example, identity of the second wireless device may comprises at least one of: a Generic Public Subscription Identifier (GPSI), wherein the GPSI may comprise a Mobile Station Integrated Services Digital Network (MSISDN) and/or an external identifier; a Subscription Permanent Identifier (SUPI), wherein the SUPI may comprise an International Mobile Subscriber Identity (IMSI) and/or Network Access Identifier (NAI); a Subscription Concealed Identifier (SUCI); a 5G Globally unique Temporary Identity (5G-GUTI); a permanent equipment identifier (PEI), wherein the PEI may comprise an International Mobile Equipment Identity (IMEI); an IP address, wherein the IP address may comprise an IPv4 address and/or an IPv6 prefix; and/or an application level identifier to identify the wireless device. In an example, the radio bearer configuration information may comprise parameters for a data radio bearer. In an example, the radio bearer configuration information may comprise parameters for a signal radio bearer. In an example, the radio bearer configuration information may comprise QoS parameters for a signal radio bearer and/or a data radio bearer. In an example, the QoS parameters may comprise at least one of: Resource type; priority level; Packet Delay Budget (PDB); Packet Error Rate (PER); Averaging window; and/or Maximum Data Burst Volume. In an example, the RRC request message may comprises at least one of the messages: an MSG 3; an MSG 5; a RRCSetupRequest; a RRCSetupComplete; a RRCResumeRequest; a RRCResumeComplete; UEAssistanceInformation; UEInformationResponse; and/or UECapabilityInformation. The method of claim 1, wherein the RRC response message comprises at least one of the messages: RRCReconfiguration; an MSG 4; a RRCSetup; a RRCResume; UEReconfiguration; UEInformationRequest; and/or UECapabilityEnquiry.

In an example, the wireless device may establish a RRC connection with a base station for the symmetry communication channels. In an example, the wireless device may establish a protocol data unit (PDU) session with a core network for the symmetry communication channels, wherein the core network may comprise: an AMF; an SMF; and/or a UPF. In an example, the RRC request message may comprise a second parameter/Asymmetric End to End Latency indicating requested maximum end to end latency asymmetry/difference between at least one uplink communication channel and at least one downlink communication channel. In an example, the RRC request message may comprise a third parameter/End to End Latency indicating requesting end to end latency between two network elements is less than and/or equal a value. In an example, the third parameter/End to End Latency may indicate requesting end to end latency of the at least one uplink communication channel is less than and/or equal a value. In an example, the third parameter/End to End Latency may indicate requesting end to end latency of the at least one downlink communication channel is less than and/or equal a value. In an example, the base station may determine whether to accept the RRC request and/or requesting symmetric communication channels, based on at least one of: the RRC request message; resource of the base station; local policy; and/or subscription information of the wireless device. In an example, the base station may determine a Channel Symmetry Accept indicating accepting the RRC request; and/or accepting requesting the symmetric communication channels. In an example, the base station may send the Channel Symmetry Accept to the wireless device.

In an example, the base station may determine radio bearer and/or QoS resource for the symmetric communication channels, based on at least one of: determining that whether to accept the RRC request; the RRC request message; resource of the base station; local policy; and/or subscription information of the wireless device. In an example, the base station may determine at least one data radio bearer (DRB) and/or the at least one signal radio bearer (SRB) for the symmetric communication channels. In an example, the radio bearer configuration information may comprise a second parameter/Asymmetric End to End Latency indicating allowed (maximum) end to end latency asymmetry/difference between at least one uplink communication channel and at least one downlink communication channel. In an example, the base station may determine RRC configuration information for the symmetric communication channels, based on at least one of: determining that whether to accept the RRC request; the RRC request message; resource of the base station; local policy; and/or subscription information of the wireless device. In an example, the RRC configuration information for the symmetric communication channels may comprise radio bearer configuration information and/or logical channel configuration information for the symmetric communication channels. In an example, the RRC configuration information for the symmetric communication channels may comprise a second parameter/Asymmetric End to End Latency indicating allowed maximum end to end latency asymmetry/difference between at least one uplink communication channel and at least one downlink communication channel. In an example, the base station may determine at least one logical channel for the symmetric communication channels, based on at least one of: determining that whether to accept the RRC request; the RRC request message; resource of the base station; local policy; and/or subscription information of the wireless device. In an example, the base station may send a second message to the wireless device, wherein the second message may comprise the radio bearer configuration information. In an example, the second message may further comprise at least one of: RRC configuration information for the symmetric communication channels; logical channel configuration information for the symmetric communication channels; a second parameter/Asymmetric End to End Latency; a third parameter/End to End Latency; and/or the fourth parameter/Channel Symmetry Accept.

In an example embodiment, a wireless device may send a RRC request message to a base station, the RRC request message may comprise a parameter indicating requesting symmetry communication channels for an application of the wireless device. In an example, the wireless device may receive a RRC response message from the base station, the RRC response message may indicate radio bearer configuration information; and/or accepting the symmetry communication channels. In an example, the wireless device may establish a RRC connection for the symmetry communication channels based on the radio bearer configuration information. In an example, the wireless device may establish a PDU session for the symmetry communication channels based on the radio bearer configuration information. In an example, the wireless device may allocate radio bearer and/or QoS resource for the symmetric communication channels based on the radio bearer configuration information. In an example, the wireless device may allocate radio bearer and/or QoS resource for the symmetric communication channels based on at least one of: RRC configuration information for the symmetric communication channels; logical channel configuration information for the symmetric communication channels; a second parameter/Asymmetric End to End Latency; a third parameter/End to End Latency; and/or the fourth parameter/Channel Symmetry Accept.

In an example embodiment, a base station may send a first message to a wireless device, the first message may comprise Sounding Reference Signal (SRS) configuration information requesting SRS report from the wireless device. In an example, the base station may receive SRS report from the wireless device. In an example, the base station may receive a RRC request message from the wireless device. The RRC request message may comprise a parameter indicating requesting symmetry communication channels for an application of the wireless device. In an example, based on the parameter, the base station may determine time and frequency resource for the symmetry communication channels. In an example, base station may send a physical layer message to the wireless device. The physical layer message may be sent to the wireless device via a Physical Downlink Control Channel (PDCCH). The physical layer message may comprise at least one of: a Downlink Control Information (DCI), wherein the DCI indicates time and/or frequency resource for the symmetry communication channels; and/or a Cell Radio Network Temporary Identifier (C-RNTI), wherein the C-RNTI indicates a RRC Connection and scheduling that is dedicated to the wireless device. In an example, the first message may further comprise Channel Status Information Reference Signal (CSI-RS) requesting channel condition report from the wireless device. In an example, the base station may receive Channel Status Information (CSI) from the wireless device. In an example, based on the CSI, the base station may determine time and frequency resource for the symmetry communication channels. In an example, the DCI may indicate an allowed end to end latency asymmetry/difference between the at least one uplink communication channel (e.g., PUSCH) and the at least one downlink communication channel (e.g., PDSCH) is less than and/or equal to a value (e.g., 2 ms). In an example, the DCI may indicate an allowed end to end latency between two network elements (e.g., between the UE 1 and the UE2, between the UE 1 and the (R)AN 1) is less than and/or equal to a value (e.g., 5 ms, 10 ms).

In an example embodiment, a base station may send a first message to a wireless device. The first message may comprise a parameter indicating priority random access for symmetry communication channels for an application of the wireless device. In an example, the base station may receive a second message from the wireless device. The second message may comprise an identity of the wireless device, wherein the identity of the wireless device indicating requesting symmetry communication channels for an application of the wireless device. In an example, based on the parameter and the identity of the wireless device, the base station may determine time and frequency resource for the symmetry communication channels; and/or radio bearer configuration information for the symmetry communication channels. In an example, the base station may send a third message to the wireless device. The third message may indicate radio bearer configuration information; and/or accepting the symmetry communication channels. In an example, the base station may from the wireless device, a Random Access Preamble message for the symmetry communication channels. In an example, the base station may send to the wireless device, a Random Access Response message in response to the Random Access Preamble message.

In an example embodiment, an access and mobility management function (AMF) may receive a first message from a wireless device, the first message may comprise a parameter indicating requesting symmetric communication channels. In an example, the AMF may send a second message to a base station, the second message may comprise the parameter; and/or PDU session configuration information associated with the symmetric communication channels. In an example, the second message may comprise a third message to a wireless device, the third message may indicate accepting the symmetric communication channels. In an example, the AMF may receive a response message from the base station, the response message may indicate accepting the symmetric communication channels. In an example, the AMF may send a third message to the wireless device, the third message may indicate accepting the symmetric communication channels. In an example, the AMF may determine accepting the symmetry communication channels based on at least one of: the parameter; local configuration; information from the base station; and/or subscription information of the wireless device.

In an example embodiment, a session management function (SMF) may receive a first message from a wireless device, the first message may comprise a parameter indicating requesting symmetric communication channels. determining, by the SMF, QoS parameters for the symmetric communication channels. In an example, the SMF may send a second message to the wireless device, the second message may indicate the QoS parameters; and/or accepting the symmetric communication channels. In an example, the determining may be based on at least one of: the parameter; resource of core network; local operator policy; information from a policy control function; and/or subscription information of the wireless device. In an example, the first message may further comprise at least one of: a second parameter (e.g., Asymmetric End to End Latency) indicating requesting maximum end to end latency asymmetry/difference between [at least one uplink communication channel] and [at least one downlink communication channel] is less than and/or equal to a value (e.g., 2 ms); a third parameter (e.g., End to End Latency) indicating requesting end to end latency between two network elements is less than and/or equal to a value (e.g., 5 ms, 10 ms); an identity of the wireless device; an identity of the second wireless device; an identity of a first PDU session; and/or an identity of a second PDU session. In an example, the SMF may determine whether to accept the requesting of symmetric communication channels, based on at least one of: PDU session establishment request message; resource of the core network; local operator policy; and/or subscription information of the wireless device. In an example, the second message may further comprise at least one of: QoS policy/parameters determined by the SMF; the RQI; the second parameter/Asymmetric End to End Latency; third parameter/End to End Latency; fourth parameter/Channel Symmetry Accept; and/or fifth parameter/Channel Symmetry Indication. In an example, the second message may further comprise a PDU session establishment response message, wherein the PDU session establishment response message indicates accepting the requesting from the wireless device for the symmetric communication channels. In an example, the PDU session establishment response message may indicate accepting the request for the asymmetric End to End Latency. In an example, the PDU session establishment response message may indicate accepting the request for the End to End Latency.

In an example embodiment, a wireless device may send a first message to a session management function (SMF), the first message may comprise a parameter indicating requesting symmetric communication channels. In an example, the wireless device may receive a second message from the SMF, the second message may indicate: QoS parameters for the symmetric communication channels; and/or accepting the symmetric communication channels.

In an example embodiment, a policy control function (PCF) may receive a first message from a session management function (SMF), the first message may comprise a parameter indicating requesting symmetry communication channels for an application of the wireless device. In an example, based on the parameter, the PCF may determine PCC rule for the symmetry communication channels. In an example, the PCF may send a second message to the SMF, the second message may indicate the PCC rule; and/or accepting the symmetry communication channels. In an example, the first message may further comprise at least one of: a second parameter (e.g., Asymmetric End to End Latency) indicating requesting maximum end to end latency asymmetry/difference between [at least one uplink communication channel] and [at least one downlink communication channel] is less than and/or equal to a value (e.g., 2 ms); a third parameter (e.g., End to End Latency) indicating requesting end to end latency between two network elements is less than and/or equal to a value (e.g., 5 ms, 10 ms); an identity of the wireless device; an identity of the second wireless device; an identity of a first PDU session; and/or an identity of a second PDU session.

There is a requirement to support symmetric communication channel/path between an application server (e.g., an application function, a 3rd party) and a wireless device. There is a requirement to support symmetric communication channel/path between a first wireless device and a second wireless device. However, the existing technology may have an issue to support symmetric communication channel/path for the application server. For example, the existing technology may have an issue to enable the application server to initiate symmetric communication channel/path between the application server and the wireless device. For example, the existing technology may have an issue to enable an application server to initiate symmetric communication channel/path between the first wireless devices and the second wireless device. Consequently, the application/service between the application server and the wireless device may not be performed (efficiently), and the application/service between the first wireless device and the second wireless device may not be performed (efficiently).

Example embodiments of the present disclosure implement an enhanced mechanism to enable an application server to initiate symmetric communication channel/path between an application server and a wireless device. Example embodiments of the present disclosure implement an enhanced mechanism to enable an application server to initiate symmetric communication channel/path between a first wireless device and a second wireless device. In an example embodiment of the present disclosure, a PCF may receive a first message from a network function. The first message may indicate symmetry communication channels for an application of a wireless device. In an example, based on the parameter, the PCF may determine a PCC rule for the symmetry communication channels. In an example, the PCF may send a second message to the SMF. The second message may indicate the PCC rule and accepting the symmetry communication channels.

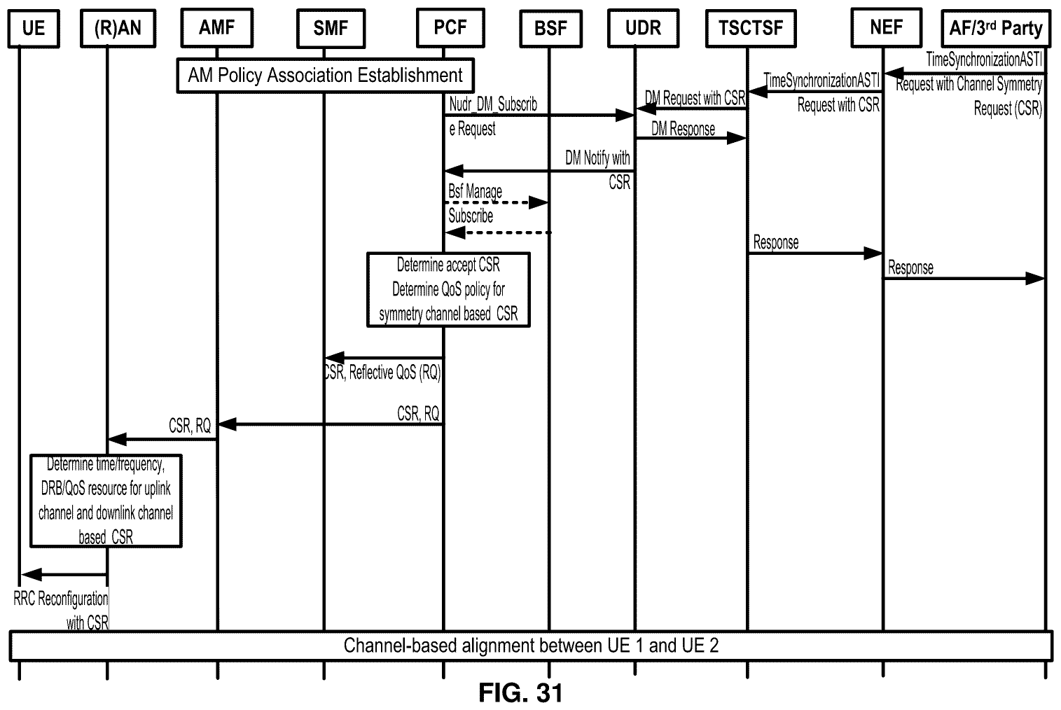

FIG. 31 is an example call flow which may comprise one or more actions. In an example, an AMF may establish an AM Policy Association with a PCF. In an example, based on local policies, the AMF may decide to establish AM Policy Association with the PCF. For example, if the AMF has not yet obtained Access and Mobility policy for the UE or if the Access and Mobility policy in the AMF are no longer valid, the AMF may request the PCF to apply operator policies for the UE from the PCF. The AMF may send a Npcf_AMPolicyControl_Create message to the PCF to establish an AM policy control association with the PCF. The Npcf_AMPolicyControl_Create message may comprise at least one of the following information: SUPI, Internal Group, subscription notification indication and, if available, Service Area Restrictions, RFSP index, Subscribed UE-Aggregate Maximum Bit Rate (AMBR), List of Subscribed UE-Slice-MBR, Allowed NSSAI, Target NSSAI, GPSI which are retrieved from the UDM during the update location procedure, Access Type and RAT Type, PEI, User Location Information (ULI), UE time zone, and/or Serving Network (e.g., PLMN ID, or PLMN ID and NID). The Npcf_AMPolicyControl_Create message may comprise NWDAF instance ID and/or Analytics ID(s). In response to the message received, the PCF may send a Npcf_AMPolicyControl_Create Response message to the AMF. In the Npcf_AMPolicyControl_Create Response message, the PCF may provide Access and mobility related policy information (e.g., Service Area Restrictions), and/or Policy Control Request Trigger of AM Policy Association to AMF. In the non-roaming case, the PCF may subscribe to Analytics from NWDAF. In an example, the AMF may be implicitly subscribed in the PCF to be notified of changes in the policies. In an example, the AMF may deploy the Access and mobility related policy information. In an example, deploying the Access and mobility related policy information may comprise storing the Service Area Restrictions and Policy Control Request Trigger of AM Policy Association. In an example, deploying the Access and mobility related policy information may comprise provisioning Service Area Restrictions to the UE. In an example, deploying the Access and mobility related policy information may comprise provisioning the RFSP index, the UE-AMBR, List of UE-Slice-MBR, and/or Service Area Restrictions to the NG-RAN. In an example, deploying the Access and mobility related policy information may comprise requesting for notification of SM Policy association establishment and termination to a list of (DNN, S-NSSAI) (s) together with PCF for the UE binding information.

In an example, the PCF may send a message (e.g., Nudr_DM_Subscribe Request) to a UDR to subscribe to policy data related to time synchronization (e.g., Data Set=Application Data; Data Subset=Time-Sync data, Data Key=S-NSSAI and DNN and/or Internal Group Identifier or SUPI). For example, the Nudr_DM_Subscribe Request message may indicate that the PCF may receive a notification (e.g., Nudr_DM_Notify) from the UDR when data stored, updated, or removed associated with the PCF.

In an example, a PCF may receive a first message from a network function. The first message may indicate requesting symmetry communication channels for an application of a wireless device. In an example, the network function may comprise an application server (e.g., AF), an NEF, a Time Sensitive Communication and Time Synchronization Function (TSCTSF), a UDR, a BSF, an OAM, and/or a NWDAF. For example, the PCF may receive the first message from the AF via an NEF, a TSCTSF and/or a UDR. The PCF

In an example, an application server (e.g., AF) may request to influence the 5G access stratum time distribution. In an example, the AF may send a first message to an NEF. The first message may comprise a Nnef_TimeSynchronization_ASTICreate message when the AF creates a new request. In an example, the first message may comprise an Nnef_TimeSynchronization_ASTIUpdate message and/or a Nnef_TimeSynchronization_ASTIDelete message when the AF to update and/or remove an existing request. In an example, the first message may comprise an AF identifier and/or identity(ies) of a target. In an example, the target may comprise a wireless device identified by a SUPI and/or a GPSI. In an example, the target may comprise a group of UEs identified by an External Group Identifier. In an example, the target may comprise all UEs identified by combination of DNN and/or S-NSSAI.

In an example, the first message may comprise a parameter (e.g., a Channel Symmetry Request (CSR)) indicating a request for symmetric communication channels between a first wireless device and a second wireless device. In an example, the parameter/Channel Symmetry Request may indicate a request for symmetric communication channels between a first wireless device and the AF. In an example, the symmetric communication channels may be applied for a service and/or an application of the wireless device and/or the application server (e.g., AF). In an example, the service of the wireless device/AF may comprise a video service, a URLLC service (e.g., as described in FIG. 6), an eMBB service (e.g., as described in FIG. 6), an mMTC service (e.g., as described in FIG. 6), a Massive Internet of things (MIoT) service, a High-Performance Machine-Type Communications (HMTC) service, and/or the like. In an example, the MIoT may indicate one or more physical objects that are embedded with sensors, processing ability, software, and other technologies that connect and exchange data with other devices and systems over the Internet or other communications networks. In an example, the HMTC service may indicate a type of low power wide area network (LPWAN) radio technology to enable a wide range of cellular devices, sensors, and services (e.g., for M2M and/or IoT applications). In an example, the application of the wireless device/AF may be an application for the smart energy (e.g., line current differential protection). In an example, the application of the wireless device/AF may be a game application.

In an example, the definition/content of the parameter/Channel Symmetry Request may be similar to the definition/content of the parameter/Channel Symmetry Request as described in FIG. 19. In an example, the definition/content of the symmetric communication channels may be similar to the definition/content of the symmetric communication channels as described in FIG. 19.

In an example, the at least one uplink communication channel may indicate a communication path from a first network element to a second network element. In an example, the at least one downlink communication channel may indicate a communication path from the second network element to the first network element. In an example, the first network element may comprise at least one of: a first wireless device; a first base station; a first access and mobility management function (AMF); a first session management function (SMF); a first user plane function (UPF); a first network exposure function (NEF); a first router; a first application server (e.g., AF), and/or the like. In an example, the second network element may comprise at least one of: a second wireless device; a second base station; a second AMF; a second SMF; a second UPF; a second NEF; a second router; a second application server (e.g., AF), and/or the like.

In an example, the first message may comprise a second parameter (e.g., Asymmetric End to End Latency) indicating requesting maximum end to end latency asymmetry/difference between [the at least one uplink communication channel] and [the at least one downlink communication channel] is less than and/or equal to a value. In an example, the definition/content of the second parameter/Asymmetric End to End Latency may be similar to the definition/content of the second parameter/Asymmetric End to End Latency as described in FIG. 19.

In an example, the first message may comprise a third parameter (e.g., End to End Latency) indicating requesting end to end latency between two network elements is less than and/or equal to a value (e.g., 5 ms, 10 ms). In an example, the third parameter/End to End Latency may indicate requesting end to end latency of the at least one uplink communication channel is less than and/or equal to a value. In an example, the third parameter/End to End Latency may indicate requesting end to end latency of the at least one downlink communication channel is less than and/or equal to a value. In an example, the definition/content of the third parameter/End to End Latency may be similar to the definition/content of the third parameter/End to End Latency as described in FIG. 19. In an example, the definition/content of the end to end latency may be similar to the definition/content of the end to end latency as described in FIG. 19.

In an example, the first message may comprise an identity of a first wireless device, and/or an identity of a second wireless device. The identity of the first wireless device/second wireless device may comprise at least one of: a Generic Public Subscription Identifier (GPSI); a Subscription Permanent Identifier (SUPI); a Subscription Concealed Identifier (SUCI); a 5G Globally unique Temporary Identity (5G-GUTI); a permanent equipment identifier (PEI); an IP address; an application level identifier to identify the wireless device; an external identifier of the wireless device; and/or the like to identify the wireless device. In an example, the GPSI may comprise a Mobile Station Integrated Services Digital Network (MSISDN) and/or an external identifier. In an example, the SUPI may comprise an International Mobile Subscriber Identity (IMSI) and/or Network Access Identifier (NAI). In an example, the PEI may comprise an International Mobile Equipment Identity (IMEI). In an example, the IP address may comprise an IPv4 address and/or an IPv6 prefix. In an example, in order to avoid disclosing the information of the wireless device, the external identifier of the wireless device may be used by an application (e.g., a 3rd party).

In an example, the parameter/Channel Symmetry Request, the identity of the (first) wireless device and/or the AF identifier may indicate that the AF requesting symmetric communication channels between the AF and the (first) wireless device (e.g., UE). For example, from the perspective of the UE, the UE may send a user data packet to the AF via an uplink communication channel of the symmetric communication channels, where the uplink communication channel may comprise at least one of: the UE, a base station (e.g., (R)AN), a UPF, a router, the AF. The UE may receive a user data packet from the AF via a downlink communication channel of the symmetric communication channels, where the downlink communication channel may comprise at least one of: the AF, the router, the UPF, the (R)AN, the UE.

In an example, the parameter/Channel Symmetry Request, the identity of the first wireless device, the identity of the second wireless device, and/or the AF identifier may indicate that the AF requesting symmetric communication channels between the first wireless device (e.g., UE 1) and the second wireless device (e.g., UE 2). For example, the first wireless device may communicate with the second wireless device via the AF. For example, from a perspective of the UE 1, the UE 1 may send a user data packet to the UE 2 via an uplink communication channel of the symmetric communication channels, where the uplink communication channel may comprise at least one of: the UE 1, a first base station (e.g., (R)AN 1), a first UPF, a first router, the AF, a second router, a second UPF, a (R)AN 2, the UE 2. The UE 1 may receive a user data packet from the UE 2 via a downlink communication channel of the symmetric communication channels, where the downlink communication channel may comprise at least one of: the UE 2, the (R)AN 2, the second UPF, the second router, the AF, the first router, the first UPF, the (R)AN 1, the UE 1.

In an example, in response to the message received, the NEF may take one or more actions. In an example action, the NEF may map the External Group Identifier to an Internal Group Identifier and any GPSI to a SUPI. In an example action, the NEF may authorize the request. After successful authorization, the NEF may send a message (e.g., Ntsctsf_TimeSynchronization_ASTICreate) to a corresponding TSCTSF. In an example, the Ntsctsf_TimeSynchronization_ASTICreate may comprise one or more parameters of the first message. For example, the Ntsctsf_TimeSynchronization_ASTICreate message may comprise at least one of: the parameter/Channel Symmetry Request, the second parameter/Asymmetric End to End Latency, the third parameter/End to End Latency, the identity of the first wireless device, the identity of the second wireless device, the DNN and/or the S-NSSAI.

In response to the message received, the TSCTSF may take one or more actions. In an example action, based on the identity(ies) of a target (e.g., the identity of the first wireless device, the identity of the second wireless device), the TSCTSF may determine whether the targeted UE is part of a PTP instance in 5GS. In an example, the TSCTSF may reject the request from the AF/NEF. In an example, the TSCTSF may accept the request from the AF/NEF. In an example, the TSCTSF may associates the 5G access stratum time distribution parameters with a SUPI without DNN, S-NSSAI when storing them to the UDR. In an example, if time synchronization error budget is provided by the AF/NEF, the TSCTSF may use the PTP port state of each DS-TT to determine an Uu time synchronization error budget for corresponding SUPIs that are part of the PTP instance. In an example action, the TSCTSF may store the 5G access stratum time distribution parameters in the UDR by sending a message (e.g., Nudr_DM_Request) to the UDR. The Nudr_DM_Request may comprise at least one of: Data Set=Application Data, Data Subset=Time-Sync data, and/or Data Key=Internal Group Identifier or SUPI. In an example, the Nudr_DM_Request message may comprise at least one of: the parameter/Channel Symmetry Request, the second parameter/Asymmetric End to End Latency, the third parameter/End to End Latency, the identity of the first wireless device, the identity of the second wireless device, the DNN and/or the S-NSSAI. In an example, the Time-Sync data may comprise 5G access stratum time distribution indication (enable, disable) and optionally the calculated Uu time synchronization error budget.

In response to the message received, the UDR may take one or more actions. In an example action, the UDR may send a response message (e.g., Nudr_DM_Request) to the TSCTSF indicating result of the request. In an example action, the UDR may identify at least one PCF associated with the symmetric communication channel based on the message received from the TSCTSF (e.g., the identity(ies) of a target, the identity of the first wireless device, the identity of the second wireless device, the DNN and/or the S-NSSAI). In an example action, the UDR may send at least one message (e.g., Nudr_DM_Notify) to at least one PCF, where the at least one PCF has subscribed to the UDR that the at least one PCF may receive a notification (e.g., Nudr_DM_Notify) from the UDR when data stored, updated, or removed associated with the at least one PCF. In an example, if the 5G access stratum time distribution parameters in UDR are associated with a DNN/S-NSSAI for the SUPI e.g., the parameters are valid only for a DNN/S-NSSAI), the UDR may discover the at least one PCF for the PDU Session using Nbsf_Management_Subscribe with SUPI and (DNN, S-NSSAI) as parameters.

In an example, the Nudr_DM_Notify message may comprise at least one of: identity(ies) of a target, the parameter/Channel Symmetry Request, the second parameter/Asymmetric End to End Latency, the third parameter/End to End Latency, the identity of the first wireless device, the identity of the second wireless device, the DNN and/or the S-NSSAI.

In an example, in response to the message received, the at least one PCF may take one or more actions. In an example, the PCF may take one or more actions as described in FIG. 30. In an example action, the at least one PCF may take a policy decision and then it may initiate an AM Policy Association Modification procedure initiated by the at least one PCF for the UE. As part of this, the at least one PCF may send the 5G access stratum time distribution indication and/or the Uu time synchronization error budget to the NG-RAN. Based on this, the NG-RAN may send the 5GS access stratum time to the UE according to the Uu time synchronization error budget as provided by the TSCTSF (if supported by UE and NG-RAN).

In an example action, the PCF may determine whether to accept the requesting of symmetric communication channels, based on at least one of: the Nudr_DM_Notify message; resource of the core network; local operator policy; and/or subscription information of the (first) wireless device. For example, the policy request message may comprise the parameter/Channel Symmetry Request, the second parameter/Asymmetric End to End Latency, the third parameter/End to End Latency, the identity of the first wireless device (e.g., UE 1), the identity of the second wireless device (e.g., UE 2); the resource of the network (e.g., AMF, SMF, and/or UPF) may support the symmetric communication channels; the local operator policy and/or subscription information of the wireless device may indicate that the symmetric communication channels is allowed to the wireless device; based on above information, the PCF may determine to accept the requesting of symmetric communication channels. In an example, based on the PCF determining whether to accept the requesting of symmetric communication channels, the PCF may determine a fourth parameter (e.g., Channel Symmetry Accept) indicating accepting the requesting of symmetric communication channels.

In an example action, the PCF may determine at least one Policy and Charging Control (PCC) rule/PCC policy for the symmetric communication channels based on at least one of: the determining whether to accept the requesting of symmetric communication channels; the Nudr_DM_Notify message; resource of the core network; local operator policy; and/or subscription information of the wireless device. In an example action, the PCF may make (PCC) policy decision for the symmetric communication channels based on at least one of: the determining whether to accept the requesting of symmetric communication channels; the Nudr_DM_Notify message; resource of the core network; local operator policy; and/or subscription information of the wireless device. For example, the PCF has determined the fourth parameter/Channel Symmetry Accept indicating accepting the requesting of symmetric communication channels; the Nudr_DM_Notify message may comprise the parameter/Channel Symmetry Request, the second parameter/Asymmetric End to End Latency, the third parameter/End to End Latency, the identity of the first wireless device (e.g., UE 1), the identity of the second wireless device (e.g., UE 2), the resource of the network (e.g., AMF, SMF, and/or UPF) may support the symmetric communication channels; the local operator policy and/or subscription information of the first wireless device may indicate that the symmetric communication channels is allowed to the wireless device; based on above information, the PCF may determine PCC rules for the symmetric communication channels for the wireless device.

In an example, the at least one PCC rule/PCC policy may comprise at least one of: the parameter/Channel Symmetry Request, the second parameter/Asymmetric End to End Latency, the third parameter/End to End Latency, the fourth parameter/Channel Symmetry Accept, the identity of the first wireless device, the identity of the second wireless device, the DNN and/or the S-NSSAI. In an example, the definition/content of the at least one PCC rule/PCC policy may be similar to the definition/content of the at least one PCC rule/PCC policy as described in FIG. 30.

In an example action, the PCF may identify at least one AMF/SMF associated with the symmetric channel based on the Nudr_DM_Notify message (e.g., the identity(ies) of a target, the identity of the first wireless device, the identity of the second wireless device, the DNN and/or the S-NSSAI). In an example action, the at least one PCF may send a policy message (e.g., Npcf_SMPolicyControl_Create service response) to the at least one AMF/SMF, the policy message may comprise the at least one PCC rule determined by the at least one PCF.

In an example action, the at least one PCF may send a response message to the network function (e.g., the UDR, the TSCTSF, the NEF, and/or the AF) indicating accepting the symmetric communication channel. For example, the response message may comprise the fourth parameter/Channel Symmetry Accept.

In an example, the at least one SMF may identify at least one AMF and/or at least one base station associated with the symmetric channel based on the policy message (e.g., the identity(ies) of a target, the identity of the first wireless device, the identity of the second wireless device, the DNN and/or the S-NSSAI).

In an example, the at least one AMF may identify at least one base station associated with the symmetric channel based on the policy message (e.g., the identity(ies) of a target, the identity of the first wireless device, the identity of the second wireless device, the DNN and/or the S-NSSAI).

In an example, the at least one SMF may take similar actions as the SMF as described in FIG. 30. In an example, the at least one AMF may take similar actions as the AMF as described in FIG. 30. In an example, the at least one base station may take similar actions as the base station as described in FIG. 30. In an example, the first wireless device and/or the second wireless device may take similar actions as the first wireless device and/or the second wireless device as described in FIG. 30.

In an example, the TSCTSF may respond to the AF with the Ntsctsf_TimeSynchronization_ASTI operation response, including a reference to the time synchronization service configuration, and/or the fourth parameter/Channel Symmetry Accept.

In an example, the NEF may inform the AF about the result of the Nnef_TimeSynchronization_ASTI operation, and/or the fourth parameter/Channel Symmetry Accept.

1. A method comprising:
sending, by a wireless device to a network function, a message comprising a parameter indicating a request for symmetric communication channels for an application of the wireless device, wherein the symmetric communication channels comprise an uplink communication channel and a downlink communication channel having equal end-to-end latencies; and
receiving, by the wireless device, an acceptance of the request for the symmetric communication channels.

2. The method of claim 1, wherein the network function comprises a base station.

3. The method of claim 2, wherein the message comprises a radio resource control (RRC) request message.

4. The method of claim 2, wherein the acceptance of the request for the symmetric communication channels is received by the wireless device in a radio resource control (RRC) response message.

5. The method of claim 4, wherein the RRC response message comprises radio bearer configuration information for the symmetric communication channels.

6. The method of claim 2, further comprising sending, by the wireless device to the base station, a second message comprise an identity of the wireless device, wherein the identity of the wireless device indicates the request for the symmetric communication channels for the application of the wireless device.

7. The method of claim 2, further comprising receiving, by the wireless device from the base station, a physical layer message via a physical downlink control channel (PDCCH), the physical layer message comprising a downlink control information (DCI) indicating time and/or frequency resources for the symmetric communication channels.

8. A wireless device comprising one or more processors and memory storing instructions that, when executed by the one or more processors, cause the wireless device to:
send, to a network function, a message comprising a parameter indicating a request for symmetric communication channels for an application of the wireless device, wherein the symmetric communication channels comprise an uplink communication channel and a downlink communication channel having equal end-to-end latencies; and
receive an acceptance of the request for the symmetric communication channels.

9. The wireless device of claim 8, wherein the network function comprises a base station.

10. The wireless device of claim 9, wherein the message comprises a radio resource control (RRC) request message.

11. The wireless device of claim 9, wherein the acceptance of the request for the symmetric communication channels is received by the wireless device in a radio resource control (RRC) response message.

12. The wireless device of claim 11, wherein the RRC response message comprises radio bearer configuration information for the symmetric communication channels.

13. The wireless device of claim 9, further comprising sending, by the wireless device to the base station, a second message comprise an identity of the wireless device, wherein the identity of the wireless device indicates the request for the symmetric communication channels for the application of the wireless device.

14. The wireless device of claim 9, further comprising receiving, by the wireless device from the base station, a physical layer message via a physical downlink control channel (PDCCH), the physical layer message comprising a downlink control information (DCI) indicating time and/or frequency resources for the symmetric communication channels.

15. A non-transitory computer-readable medium comprising instructions that, when executed by one or more processors, cause a wireless device to:
send, to a network function, a message comprising a parameter indicating a request for symmetric communication channels for an application of the wireless device, wherein the symmetric communication channels comprise an uplink communication channel and a downlink communication channel having equal end-to-end latencies; and
receive an acceptance of the request for the symmetric communication channels.

16. The non-transitory computer-readable medium of claim 15, wherein the network function comprises a base station.

17. The non-transitory computer-readable medium of claim 16, wherein the message comprises a radio resource control (RRC) request message.

18. The non-transitory computer-readable medium of claim 16, wherein the acceptance of the request for the symmetric communication channels is received by the wireless device in a radio resource control (RRC) response message.

19. The non-transitory computer-readable medium of claim 18, wherein the RRC response message comprises radio bearer configuration information for the symmetric communication channels.

20. The non-transitory computer-readable medium of claim 16, further comprising sending, by the wireless device to the base station, a second message comprise an identity of the wireless device, wherein the identity of the wireless device indicates the request for the symmetric communication channels for the application of the wireless device.
